(19) United States
(12) Patent Application Publication
(10) Pub. No.: US 2026/0193408 A1
(43) Pub. Date: Jul. 9, 2026

(54) METHODS OF MAKING COMPOSITIONS FROM OLEFIN METATHESIS PHOTOPOLYMERS

(71) Applicant: polySpectra, Inc., Berkeley, CA (US)

(72) Inventors: Raymond A. Weitekamp, Berkeley, CA (US); Charles Friesen, Berkeley, CA (US)

(21) Appl. No.: 19/132,976

(22) PCT Filed: Nov. 28, 2023
(86) PCT No.: PCT/US2023/081288

§ 371 Date: May 27, 2025

Related U.S. Application Data
(60) Provisional application No. 63/428,323, filed on Nov. 28, 2022.

(51) Int. Cl. C08G 61/08; C08F 2/46; C08J 3/24; C08J 3/28

(52) U.S. Cl. CPC C08G 61/08; C08F 2/46; C08J 3/243; C08J 3/28; C08G 2261/332; C08G 2261/418

(57) ABSTRACT

Described herein, in part, are compositions and methods for processing and curing photopolymer compositions based on olefin metathesis.

### CROSS-REFERENCE

This application claims priority to and the benefit of U.S. Provisional Application No. 63/428,323 filed Nov. 28, 2022, the contents of which are incorporated herein by reference.

### BACKGROUND

Printing three-dimensional (3D) objects such as dental products or orthodontic products that are, for example, strong, durable, and functional, remains difficult. For example, 3D printing techniques may be limited to, for example, slow print speeds, high material costs, high processing costs, high printing temperatures, and complex post-processing techniques. Therefore, there is a need for improved 3D printing techniques for producing products.

### SUMMARY

Provided herein, in part, are olefin-metathesis based photopolymerization reactions, which can include, for example, ring opening metathesis polymerization (ROMP), e.g., a photoinitiated ROMP (P-ROMP) or Photolithographic Olefin Metathesis Polymerization (PLOMP), to produce cyclic olefin photopolymer resins. The application of photo-initiated olefin metathesis to the additive manufacturing of three dimensional (3D) objects (e.g., oral products such as dental products or orthodontic products) enables significant improvements, for example, to the methods and objects, over other printing techniques. Objects (e.g., oral products, such as dental products or orthodontic products) provided herein may have better characteristics or features, such as, for example, improved working temperature, toughness, impact strength, chemical resistance, biocompatibility, photomodulus coefficient, higher green strength, longer pot life, and longer shelf life than objects printed with other printing techniques. Methods provided herein are typically more efficient and cost-effective than other (e.g., metathesis-based) printing techniques, such as for, example, providing higher printing accuracy, lower critical exposure, increased print speed, and printability at lower temperatures.

In an embodiment of the present disclosure, photopolymers prepared by methods based on olefin metathesis as described herein can be cured using electromagnetic radiation such as microwave or infrared radiation while the photopolymers are submerged in a heat-transfer medium. This method of curing photopolymers in a heat-transfer medium has been found, for example, to mitigate oxidative decomposition reactions during curing at elevated temperatures (e.g., up to the glass transition temperature of the photopolymers before curing) caused by the microwave or infrared radiation. In some embodiments, the mitigation of oxidative decomposition can be facilitated by at least one antioxidant present in the heat-transfer medium.

In one aspect, provided herein is a method for preparing a cured composition, comprising: (a) providing a mixture comprising: (i) a latent ruthenium (Ru) complex; (ii) an initiator; and (iii) at least one polymer precursor; (b) exposing the mixture to electromagnetic radiation above a threshold energy to activate the initiator, wherein upon activation by the electromagnetic radiation above the threshold energy, the initiator reacts with the latent Ru complex to generate an activated Ru complex, and wherein the activated Ru complex reacts with the at least one polymer precursor to induce polymerization of the at least one polymer precursor to generate a plurality of curable photopolymers; (c) placing the plurality of curable photopolymers in a heat-transfer medium; and (d) exposing the plurality of curable photopolymers placed in the heat-transfer medium to electromagnetic radiation below the threshold energy, thereby preparing the cured composition.

In another aspect, provided herein is a method of reducing oxidative decomposition of a plurality of curable photopolymers while curing the plurality of curable photopolymers with electromagnetic below a threshold energy, comprising: (a) providing a mixture comprising: (i) a latent ruthenium (Ru) complex; (ii) an initiator; and (iii) at least one polymer precursor; (b) exposing the mixture to electromagnetic radiation above the threshold energy to activate the initiator, wherein upon activation by the electromagnetic radiation above the threshold energy, the initiator reacts with the latent Ru complex to generate an activated Ru complex, and wherein the activated Ru complex reacts with the at least one polymer precursor to induce polymerization of the at least one polymer precursor to generate the plurality of curable photopolymers; and (c) placing the plurality of curable photopolymers in a heat-transfer medium comprising a solvent and at least one antioxidant; and (d) exposing the plurality of curable photopolymers placed in the heat-transfer mixture to the electromagnetic below the threshold energy.

In another aspect, provided herein is a method for preparing a cured composition, comprising: (a) providing a mixture comprising: (i) a latent ruthenium (Ru) complex; (ii) an initiator; and (iii) at least one polymer precursor; (b) exposing the mixture to electromagnetic radiation above a threshold energy to activate the initiator, wherein upon activation by the electromagnetic radiation above the threshold energy, the initiator reacts with the latent Ru complex to generate an activated Ru complex, and wherein the activated Ru complex reacts with the at least one polymer precursor to induce polymerization of the at least one polymer precursor to generate a plurality of curable photopolymers; and (c) reducing oxidative decomposition of a plurality of curable photopolymers while curing the plurality of curable photopolymers with electromagnetic radiation below the threshold energy, thereby preparing the cured composition.

The methods and compositions provided herein can produce a cured cyclic olefin photopolymer with improved features or characteristics over radical- and acid-based photopolymers. The methods and compositions provided herein may produce a (e.g., cured cyclic olefin) photopolymer with improved characteristics than other techniques, such as, for example: improved ductility, improved clarity (e.g., low chroma, low staining), improved biocompatibility, improved chemical resistance, improved processability (e.g., glass transition temperature (T_{g}), high dimensional accuracy, low photopolymer shrinkage, low viscosity, low leaching), improved tear strength, improved impact strength, improved strain at yield, improved strain at break, improved water absorption (e.g., low water absorption), improved organoleptics, improved heat-deflection temperature, or any combination thereof.

The methods and compositions provided herein can provide a photochemical approach that produces a product or body that achieves material properties similar to or better than, for example, a thermoformed (e.g., dental) material, including, for example, an acrylic or polyolefin thermoplastic, a cyclic olefin polymer, or a cyclic olefin copolymer (e.g., Zendura, Biocryl, Essix, or Invisacryl).

The compositions and methods provided herein can provide an approach for using direct additive manufacturing to produce oral products (e.g., dental products or orthodontic products). Such products or bodies may be ductile. Such compositions and methods may not comprise tooling, molding (e.g., thermoforming), computer numerical (CNC) milling, or CNC cutting. Such features may reduce the production cost and time for producing an oral product (e.g., a dental product or an orthodontic product) provided herein. Such features may increase or enhance customization, personalization, or design freedom for producing a product or a body described herein.

The compositions and methods provided herein can provide an approach for incorporating additives into the product or body (e.g., the photopolymer material). Such additives (e.g., pigments, dyes, optical brighteners, fluorescent whitening agents, bluing agents, decorative particles, nanoparticles, dielectric mirrors, photonic crystals, non-linear optical media, white pigments, impact modifiers, or plasticizers) provided herein may modify the features, characteristics, or properties (e.g., optical properties, mechanical properties, chemical properties, or biological properties) provided herein of the, for example, oral product.

The compositions and methods provided herein can provide an approach for manufacturing oral products (e.g., dental products or orthodontic products) with sub-components, component geometries, or a combination thereof. Such sub-components, component geometries, or a combination thereof may be difficult, impractical, or impossible to achieve with other techniques (e.g., molding techniques).

The compositions and methods provided herein can provide an approach to manufacture (e.g., using additive manufacturing) production-grade products or bodies (e.g., dental products, orthodontic products, or components thereof) in a physically-distributed manner, such as, for example, at a point-of-sale, a medical office (e.g., a dental office), a retail store, a hospital, or a clinic.

### BRIEF DESCRIPTION OF THE DRAWINGS

FIG. 1 depicts, from left to right respectively, examples for a latent ruthenium (Ru) complex, an initiator, and a polymer precursor.

FIG. 2 shows a computer system that is programmed or otherwise configured to implement methods provided herein.

FIG. 3A illustrates a chemical structure of an exemplary ruthenium catalyst.

FIG. 3B illustrates a chemical structure of an exemplary ruthenium catalyst.

FIG. 3C illustrates a chemical structure of an exemplary ruthenium catalyst.

FIG. 3D illustrates a chemical structure of an exemplary ruthenium catalyst.

FIG. 4 illustrates exemplary samples of photopolymer compositions cured by infrared radiation.

FIG. 5 illustrates exemplary samples of photopolymer compositions cured by microwave radiation.

FIG. 6 illustrates a differential scanning calorimetry (DSC) output of an exemplary photopolymer composition cured by microwave radiation while submerged in water.

FIG. 7 illustrates tensile testing results of an exemplary cured photopolymer composition cured by microwave radiation while submerged in a mixture of glycerol and water.

FIG. 8 illustrates a differential scanning calorimetry (DSC) output of an exemplary cured photopolymer composition cured by microwave radiation while submerged in a mixture of glycerol and water.

FIG. 9 illustrates tensile testing results of an exemplary cured photopolymer composition cured by microwave radiation while submerged in a mixture of glycerol and water containing ascorbic acid (vitamin C).

FIG. 10 illustrates a differential scanning calorimetry (DSC) output of an exemplary cured photopolymer composition cured by microwave radiation while submerged in a mixture of glycerol and water containing ascorbic acid (vitamin C).

### DETAILED DESCRIPTION

The features and other details of the disclosure will now be more particularly described. Certain terms employed in the specification, examples and appended claims are collected here. These definitions should be read in light of the remainder of the disclosure and as understood by a person of skill in the art. Unless defined otherwise, all technical and scientific terms used herein have the same meaning as commonly understood by a person of ordinary skill in the art.

### Definitions

As used herein, the singular forms “a,” “and,” and “the” include plural referents unless the context clearly dictates otherwise. Thus, for example, reference to “an agent” includes a plurality of such agents, and reference to “the cell” includes reference to one or more cells (or to a plurality of cells) and equivalents thereof known to those skilled in the art, and so forth. When ranges are used herein for physical properties, such as molecular weight, or chemical properties, such as chemical formulae, all combinations and sub-combinations of ranges and specific embodiments therein are intended to be included. Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the present specification and attached claims are approximations that can vary depending upon the desired properties sought to be obtained by the present application. Generally the term “about,” as used herein when referring to a measurable value such as an amount of weight, time, dose, etc. is meant to encompass in one example variations of ±15% or ±10%, in another example ±5%, in another example ±3%, in another example ±2%, in another example ±1%, and in yet another example ±0.1% from the specified amount, as such variations are appropriate to perform the disclosed method. The term “comprising” (and related terms such as “comprise” or “comprises” or “having” or “including”) is not intended to exclude that in other certain embodiments, for example, an embodiment of any composition of matter, composition, method, or process, or the like, described herein, may “consist of” or “consist essentially of” the described features.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “latent,” as used herein, generally refers to a molecule, or a derivative thereof, that has an active state, but is in a less active or inactive state. For example, a latent catalyst, a latent complex, or a latent Ru complex may be a molecule in a less active than its active form. A latent catalyst, a latent complex, or a latent Ru complex may be in an inactive state. A latent catalyst may be a pre-catalyst.

The term “active” or “activated,” as used herein, generally refers to a molecule, or a derivative thereof, that is in an active state. For example, an active catalyst, an active complex, or an active Ru complex may react or configured to react with another molecule, such as, for example, a polymer precursor.

The term “initiator,” as used herein, generally refers to a molecule, or a derivative thereof, that interacts with the latent Ru complex, thereby producing the activated Ru complex. The initiator may be, for example, activated by light. The initiator may be a photoacid (PAH), a photoacid generator (PAG), or a combination thereof. The initiator may be, for example, a sulfonium salt, an iodonium salt, a triazine, a triflate, a dicarboximide, a thioxanthone, or an oxime. The initiator may be a sulfonium salt, an iodonium salt, a triazine, a triflate, or an oxime sulfonate. The initiator may be bis(4-tert-butylphenyl)iodonium hexafluorophosphate.

The term “sensitizer,” as used herein, generally refers to a molecule, or a derivative thereof, that transfers, disperses or converts the energy of electromagnetic radiation. The sensitizer may transfer, disperse, or convert the energy of electromagnetic radiation towards the initiator. The sensitizer may transfer or disperse the energy of electromagnetic radiation in a way that activates the initiator, for example, in the presence of the electromagnetic radiation. The sensitizer may be configured to disperse, transfer, or convert the energy of electromagnetic radiation such that the initiator is activated at a particular wavelength range, such as, for example, from about 350 nanometers (nm) to about 465 nm.

The term “polymer,” as used herein, generally refers to a molecule comprising at least two repeating units. The repeating units may comprise monomers, oligomers, polymers, or any combination thereof. The polymer may be a cyclic polymer, graft polymer, network polymer or branched polymer.

The term “polymerize,” “polymerizing,” or “polymerization,” as used herein, generally refers to the process of reacting at least two polymer sub-units (e.g., monomers) to form a polymer chain or three-dimensional network.

The term “polymer precursor,” as used herein, generally refers to a monomer, oligomer, or polymer that can polymerize into a larger polymer than the polymer precursor itself. The polymer precursor may comprise at least one olefin. In some embodiments, a polymer precursor is one or more molecular compound or oligomer, or combination thereof, each comprising at least one olefinic (alkene) or one acetylenic (alkyne) bond per molecule or oligomeric unit. The polymer precursor may comprise cyclic or alicyclic cis- or trans-olefins or cyclic or alicyclic acetylenes, or a structure having both types of bonds (including alicyclic or cyclic enynes).

“Alkyl” generally refers to a straight or branched hydrocarbon chain radical consisting solely of carbon and hydrogen atoms, such as having from one to fifteen carbon atoms (e.g., C₁-C₁₅ alkyl). Unless otherwise stated, alkyl is saturated or unsaturated (e.g., an alkenyl, which comprises at least one carbon-carbon double bond). Disclosures provided herein of an “alkyl” are intended to include independent recitations of a saturated “alkyl,” unless otherwise stated. Alkyl groups described herein are generally monovalent, but may also be divalent (which may also be described herein as “alkylene” or “alkylenyl” groups). In certain embodiments, an alkyl comprises one to eighteen carbon atoms (e.g., C₁-C₁₈ alkyl). In certain embodiments, an alkyl comprises one to thirteen carbon atoms (e.g., C₁-C₁₃ alkyl). In certain embodiments, an alkyl comprises one to eight carbon atoms (e.g., C₁-C₈ alkyl). In other embodiments, an alkyl comprises one to five carbon atoms (e.g., C₁-C₅ alkyl). In other embodiments, an alkyl comprises one to four carbon atoms (e.g., C₁-C₄ alkyl). In other embodiments, an alkyl comprises one to three carbon atoms (e.g., C₁-C₃ alkyl). In other embodiments, an alkyl comprises one to two carbon atoms (e.g., C₁-C₂ alkyl). In other embodiments, an alkyl comprises one carbon atom (e.g., C₁ alkyl). In other embodiments, an alkyl comprises five to fifteen carbon atoms (e.g., C₅-C₁₅ alkyl). In other embodiments, an alkyl comprises five to eight carbon atoms (e.g., C₅-C₈ alkyl). In other embodiments, an alkyl comprises two to five carbon atoms (e.g., C₂-C₅ alkyl). In other embodiments, an alkyl comprises three to five carbon atoms (e.g., C₃-C₅ alkyl). In other embodiments, the alkyl group is selected from methyl, ethyl, 1-propyl (n-propyl), 1-methylethyl (iso-propyl), 1-butyl (n-butyl), 1-methylpropyl (sec-butyl), 2-methylpropyl (iso-butyl), 1,1-dimethylethyl (tert-butyl), 1-pentyl (n-pentyl). The alkyl is attached to the rest of the molecule by a single bond. In general, alkyl groups are each independently substituted or unsubstituted. Each recitation of “alkyl” provided herein, unless otherwise stated, includes a specific and explicit recitation of an unsaturated “alkyl” group. Similarly, unless stated otherwise specifically in the specification, an alkyl group is optionally substituted by one or more of the following substituents: halo, cyano, nitro, oxo, thioxo, imino, oximo, trimethylsilanyl, —OR^{a}, —SR^{a}, —OC(O)—R^{a}, —N(R^{a})₂, —C(O)R^{a}, —C(O)OR^{a}, —C(O)N(R^{a})₂, —N(R^{a})C(O)OR^{a}, —OC(O)—N(R^{a})₂, —N(R^{a})C(O)R^{a}, —N(R^{a})S(O)ₜR^{a} (where t is 1 or 2), —S(O)ₜOR^{a} (where t is 1 or 2), —S(O)ₜR^{a} (where t is 1 or 2) and —S(O)ₜN(R^{a})₂ (where t is 1 or 2) where each R^{a} is independently hydrogen, alkyl (optionally substituted with halogen, hydroxy, methoxy, or trifluoromethyl), fluoroalkyl, carbocyclyl (optionally substituted with halogen, hydroxy, methoxy, or trifluoromethyl), carbocyclylalkyl (optionally substituted with halogen, hydroxy, methoxy, or trifluoromethyl), aryl (optionally substituted with halogen, hydroxy, methoxy, or trifluoromethyl), aralkyl (optionally substituted with halogen, hydroxy, methoxy, or trifluoromethyl), heterocyclyl (optionally substituted with halogen, hydroxy, methoxy, or trifluoromethyl), heterocyclylalkyl (optionally substituted with halogen, hydroxy, methoxy, or trifluoromethyl), heteroaryl (optionally substituted with halogen, hydroxy, methoxy, or trifluoromethyl), or heteroarylalkyl (optionally substituted with halogen, hydroxy, methoxy, or trifluoromethyl).

“Alkoxy” refers to a radical bonded through an oxygen atom of the formula —O-alkyl, where alkyl is an alkyl chain as defined above.

“Alkenyl” refers to a straight or branched hydrocarbon chain radical group consisting solely of carbon and hydrogen atoms, containing at least one carbon-carbon double bond, and having from two to twelve carbon atoms. In certain embodiments, an alkenyl comprises two to eight carbon atoms. In other embodiments, an alkenyl comprises two to four carbon atoms. The alkenyl is optionally substituted as described for “alkyl” groups.

“Alkylene” or “alkylene chain” generally refers to a straight or branched divalent alkyl group linking the rest of the molecule to a radical group, such as having from one to twelve carbon atoms, for example, methylene, ethylene, propylene, i-propylene, n-butylene, and the like. Unless stated otherwise specifically in the specification, an alkylene chain is optionally substituted as described for alkyl groups herein.

“Aryl” refers to a radical derived from an aromatic monocyclic or multicyclic hydrocarbon ring system by removing a hydrogen atom from a ring carbon atom. The aromatic monocyclic or multicyclic hydrocarbon ring system contains only hydrogen and carbon from five to eighteen carbon atoms, where at least one of the rings in the ring system is fully unsaturated, i.e., it contains a cyclic, delocalized (4n+2) π-electron system in accordance with the Hückel theory. The ring system from which aryl groups are derived include, but are not limited to, groups such as benzene, fluorene, indane, indene, tetralin and naphthalene. Unless stated otherwise specifically in the specification, the term “aryl” or the prefix “ar-” (such as in “aralkyl”) is meant to include aryl radicals optionally substituted by one or more substituents independently selected from alkyl, alkenyl, alkynyl, halo, fluoroalkyl, cyano, nitro, optionally substituted aryl, optionally substituted aralkyl, optionally substituted aralkenyl, optionally substituted aralkynyl, optionally substituted carbocyclyl, optionally substituted carbocyclylalkyl, optionally substituted heterocyclyl, optionally substituted heterocyclylalkyl, optionally substituted heteroaryl, optionally substituted heteroarylalkyl, —R^{b}—OR^{a}, —R^{b}—OC(O)—R^{a}, —R^{b}—OC(O)—OR^{a}, —R^{b}—OC(O)—N(R^{a})₂, —R^{b}—N(R^{a})₂, —R^{b}—C(O)R^{a}, —R^{b}—C(O)OR^{a}, —R^{b}—C(O)N(R^{a})₂, —R^{b}—O—R^{c}—C(O)N(R^{a})₂, —R^{b}—N(R^{a})C(O)OR^{a}, —R^{b}—N(R^{a})C(O)R^{a}, —R^{b}—N(R^{a})S(O)ₜR^{a} (where t is 1 or 2), —R^{b}—S(O)ₜR^{a} (where t is 1 or 2), —R^{b}—S(O)ₜOR^{a} (where t is 1 or 2) and —R^{b}—S(O)ₜN(R^{a})₂ (where t is 1 or 2), where each R^{a} is independently hydrogen, alkyl (optionally substituted with halogen, hydroxy, methoxy, or trifluoromethyl), fluoroalkyl, cycloalkyl (optionally substituted with halogen, hydroxy, methoxy, or trifluoromethyl), cycloalkylalkyl (optionally substituted with halogen, hydroxy, methoxy, or trifluoromethyl), aryl (optionally substituted with halogen, hydroxy, methoxy, or trifluoromethyl), aralkyl (optionally substituted with halogen, hydroxy, methoxy, or trifluoromethyl), heterocyclyl (optionally substituted with halogen, hydroxy, methoxy, or trifluoromethyl), heterocyclylalkyl (optionally substituted with halogen, hydroxy, methoxy, or trifluoromethyl), heteroaryl (optionally substituted with halogen, hydroxy, methoxy, or trifluoromethyl), or heteroarylalkyl (optionally substituted with halogen, hydroxy, methoxy, or trifluoromethyl), each R^{b} is independently a direct bond or a straight or branched alkylene or alkenylene chain, and R^{c} is a straight or branched alkylene or alkenylene chain, and where each of the above substituents is unsubstituted unless otherwise indicated.

“Aralkyl” or “aryl-alkyl” refers to a radical of the formula —R^{c}-aryl where R^{c} is an alkylene chain as defined above, for example, methylene, ethylene, and the like. The alkylene chain part of the aralkyl radical is optionally substituted as described above for an alkylene chain. The aryl part of the aralkyl radical is optionally substituted as described above for an aryl group.

“Carbocyclyl” or “cycloalkyl” refers to a stable non-aromatic monocyclic or polycyclic hydrocarbon radical consisting solely of carbon and hydrogen atoms, which includes fused or bridged ring systems, having from three to fifteen carbon atoms. In certain embodiments, a carbocyclyl comprises three to ten carbon atoms. In other embodiments, a carbocyclyl comprises five to seven carbon atoms. The carbocyclyl is attached to the rest of the molecule by a single bond. Carbocyclyl or cycloalkyl is saturated (i.e., containing single C—C bonds only) or unsaturated (i.e., containing one or more double bonds or triple bonds). Examples of saturated cycloalkyls include, e.g., cyclopropyl, cyclobutyl, cyclopentyl, cyclohexyl, cycloheptyl, and cyclooctyl. An unsaturated carbocyclyl is also referred to as “cycloalkenyl.” Examples of monocyclic cycloalkenyls include, e.g., cyclopentenyl, cyclohexenyl, cycloheptenyl, and cyclooctenyl. Polycyclic carbocyclyl radicals include, for example, adamantyl, norbornyl (i.e., bicyclo[2.2.1]heptanyl), norbornenyl, decalinyl, 7,7-dimethyl-bicyclo[2.2.1]heptanyl, and the like. Unless otherwise stated specifically in the specification, the term “carbocyclyl” is meant to include carbocyclyl radicals that are optionally substituted by one or more substituents independently selected from alkyl, alkenyl, alkynyl, halo, fluoroalkyl, oxo, thioxo, cyano, nitro, optionally substituted aryl, optionally substituted aralkyl, optionally substituted aralkenyl, optionally substituted aralkynyl, optionally substituted carbocyclyl, optionally substituted carbocyclylalkyl, optionally substituted heterocyclyl, optionally substituted heterocyclylalkyl, optionally substituted heteroaryl, optionally substituted heteroarylalkyl, —R^{b}—OR^{a}, —R^{b}—OC(O)—R^{a}, —R^{b}—OC(O)—OR^{a}, —R^{b}—OC(O)—N(R^{a})₂, —R^{b}—N(R^{a})₂, —R^{b}—C(O)R^{a}, —R^{b}—C(O)OR^{a}, —R^{b}—C(O)N(R^{a})₂, —R^{b}—O—R^{c}—C(O)N(R^{a})₂, —R^{b}—N(R^{a})C(O)OR^{a}, —R^{b}—N(R^{a})C(O)R^{a}, —R^{b}—N(R^{a})S(O)ₜR^{a} (where t is 1 or 2), —R^{b}—S(O)ₜR^{a} (where t is 1 or 2), —R^{b}—S(O)ₜOR^{a} (where t is 1 or 2) and —R^{b}—S(O)ₜN(R^{a})₂ (where t is 1 or 2), where each R^{a} is independently hydrogen, alkyl (optionally substituted with halogen, hydroxy, methoxy, or trifluoromethyl), fluoroalkyl, cycloalkyl (optionally substituted with halogen, hydroxy, methoxy, or trifluoromethyl), cycloalkylalkyl (optionally substituted with halogen, hydroxy, methoxy, or trifluoromethyl), aryl (optionally substituted with halogen, hydroxy, methoxy, or trifluoromethyl), aralkyl (optionally substituted with halogen, hydroxy, methoxy, or trifluoromethyl), heterocyclyl (optionally substituted with halogen, hydroxy, methoxy, or trifluoromethyl), heterocyclylalkyl (optionally substituted with halogen, hydroxy, methoxy, or trifluoromethyl), heteroaryl (optionally substituted with halogen, hydroxy, methoxy, or trifluoromethyl), or heteroarylalkyl (optionally substituted with halogen, hydroxy, methoxy, or trifluoromethyl), each R^{b} is independently a direct bond or a straight or branched alkylene or alkenylene chain, and R is a straight or branched alkylene or alkenylene chain, and where each of the above substituents is unsubstituted unless otherwise indicated.

“Carbocyclylalkyl” refers to a radical of the formula —R^{c}-carbocyclyl where R^{c} is an alkylene chain as defined above. The alkylene chain and the carbocyclyl radical is optionally substituted as defined above.

“Halo” or “halogen” refers to fluoro, bromo, chloro, or iodo substituents.

“Fluoroalkyl” refers to an alkyl radical, as defined above, that is substituted by one or more fluoro radicals, as defined above, for example, trifluoromethyl, difluoromethyl, fluoromethyl, 2,2,2-trifluoroethyl, 1-fluoromethyl-2-fluoroethyl, and the like. In some embodiments, the alkyl part of the fluoroalkyl radical is optionally substituted as defined above for an alkyl group.

The term “heteroalkyl” refers to an alkyl group as defined above in which one or more skeletal carbon atoms of the alkyl are substituted with a heteroatom (with the appropriate number of substituents or valencies—for example, —CH₂— may be replaced with —NH— or —O—). For example, each substituted carbon atom is independently substituted with a heteroatom, such as wherein the carbon is substituted with a nitrogen, oxygen, selenium, or other suitable heteroatom. In some instances, each substituted carbon atom is independently substituted for an oxygen, nitrogen (e.g. —NH—, —N(alkyl)-, or —N(aryl)- or having another substituent contemplated herein), or sulfur (e.g. —S—, —S(═O)—, or —S(═O)₂—). In some embodiments, a heteroalkyl is attached to the rest of the molecule at a carbon atom of the heteroalkyl. In some embodiments, a heteroalkyl is attached to the rest of the molecule at a heteroatom of the heteroalkyl. In some embodiments, a heteroalkyl is a C₁-C₁₈ heteroalkyl. In some embodiments, a heteroalkyl is a C₁-C₁₂ heteroalkyl. In some embodiments, a heteroalkyl is a C₁-C₆ heteroalkyl. In some embodiments, a heteroalkyl is a C₁-C₄ heteroalkyl. Representative heteroalkyl groups include, but are not limited to —OCH₂OMe, or —CH₂CH₂OMe. In some embodiments, heteroalkyl includes alkoxy, alkoxyalkyl, alkylamino, alkylaminoalkyl, aminoalkyl, heterocycloalkyl, heterocycloalkyl, and heterocycloalkylalkyl, as defined herein. Unless stated otherwise specifically in the specification, a heteroalkyl group is optionally substituted as defined above for an alkyl group.

“Heteroalkylene” refers to a divalent heteroalkyl group defined above which links one part of the molecule to another part of the molecule. Unless stated specifically otherwise, a heteroalkylene is optionally substituted, as defined above for an alkyl group.

“Heterocyclyl” refers to a stable 3- to 18-membered non-aromatic ring radical that comprises two to twelve carbon atoms and from one to six heteroatoms selected from nitrogen, oxygen and sulfur. Unless stated otherwise specifically in the specification, the heterocyclyl radical is a monocyclic, bicyclic, tricyclic or tetracyclic ring system, which optionally includes fused or bridged ring systems. The heteroatoms in the heterocyclyl radical are optionally oxidized. One or more nitrogen atoms, if present, are optionally quaternized. The heterocyclyl radical is partially or fully saturated. The heterocyclyl is attached to the rest of the molecule through any atom of the ring(s). Examples of such heterocyclyl radicals include, but are not limited to, dioxolanyl, thienyl[1,3]dithianyl, decahydroisoquinolyl, imidazolinyl, imidazolidinyl, isothiazolidinyl, isoxazolidinyl, morpholinyl, octahydroindolyl, octahydroisoindolyl, 2-oxopiperazinyl, 2-oxopiperidinyl, 2-oxopyrrolidinyl, oxazolidinyl, piperidinyl, piperazinyl, 4-piperidonyl, pyrrolidinyl, pyrazolidinyl, quinuclidinyl, thiazolidinyl, tetrahydrofuryl, trithianyl, tetrahydropyranyl, thiomorpholinyl, thiamorpholinyl, 1-oxo-thiomorpholinyl, and 1,1-dioxo-thiomorpholinyl. Unless stated otherwise specifically in the specification, the term “heterocyclyl” is meant to include heterocyclyl radicals as defined above that are optionally substituted by one or more substituents selected from alkyl, alkenyl, alkynyl, halo, fluoroalkyl, oxo, thioxo, cyano, nitro, optionally substituted aryl, optionally substituted aralkyl, optionally substituted aralkenyl, optionally substituted aralkynyl, optionally substituted carbocyclyl, optionally substituted carbocyclylalkyl, optionally substituted heterocyclyl, optionally substituted heterocyclylalkyl, optionally substituted heteroaryl, optionally substituted heteroarylalkyl, —R^{b}—OR^{a}, —R^{b}—OC(O)—R^{a}, —R^{b}—OC(O)—OR^{a}, —R^{b}—OC(O)—N(R^{a})₂, —R^{b}—N(R^{a})₂, —R^{b}—C(O)R^{a}, —R^{b}—C(O)OR^{a}, —R^{b}—C(O)N(R^{a})₂, —R^{b}—O—R^{c}—C(O)N(R^{a})₂, —R^{b}—N(R^{a})C(O)OR^{a}, —R^{b}—N(R^{a})C(O)R^{a}, —R^{b}—N(R^{a})S(O)ₜR^{a} (where t is 1 or 2), —R^{b}—S(O)ₜR^{a} (where t is 1 or 2), —R^{b}—S(O)ₜOR^{a} (where t is 1 or 2) and —R^{b}—S(O)ₜN(R^{a})₂ (where t is 1 or 2), where each R^{a} is independently hydrogen, alkyl (optionally substituted with halogen, hydroxy, methoxy, or trifluoromethyl), fluoroalkyl, cycloalkyl (optionally substituted with halogen, hydroxy, methoxy, or trifluoromethyl), cycloalkylalkyl (optionally substituted with halogen, hydroxy, methoxy, or trifluoromethyl), aryl (optionally substituted with halogen, hydroxy, methoxy, or trifluoromethyl), aralkyl (optionally substituted with halogen, hydroxy, methoxy, or trifluoromethyl), heterocyclyl (optionally substituted with halogen, hydroxy, methoxy, or trifluoromethyl), heterocyclylalkyl (optionally substituted with halogen, hydroxy, methoxy, or trifluoromethyl), heteroaryl (optionally substituted with halogen, hydroxy, methoxy, or trifluoromethyl), or heteroarylalkyl (optionally substituted with halogen, hydroxy, methoxy, or trifluoromethyl), each R^{b} is independently a direct bond or a straight or branched alkylene or alkenylene chain, and R^{c} is a straight or branched alkylene or alkenylene chain, and where each of the above substituents is unsubstituted unless otherwise indicated.

“Heterocyclylalkyl” refers to a radical of the formula —R^{c}-heterocyclyl where R^{c} is an alkylene chain as defined above. If the heterocyclyl is a nitrogen-containing heterocyclyl, the heterocyclyl is optionally attached to the alkyl radical at the nitrogen atom. The alkylene chain of the heterocyclylalkyl radical is optionally substituted as defined above for an alkylene chain. The heterocyclyl part of the heterocyclylalkyl radical is optionally substituted as defined above for a heterocyclyl group.

“Heteroaryl” refers to a radical derived from a 3- to 18-membered aromatic ring radical that comprises two to seventeen carbon atoms and from one to six heteroatoms selected from nitrogen, oxygen and sulfur. As used herein, the heteroaryl radical is a monocyclic, bicyclic, tricyclic or tetracyclic ring system, wherein at least one of the rings in the ring system is fully unsaturated, i.e., it contains a cyclic, delocalized (4n+2) π-electron system in accordance with the Hückel theory. Heteroaryl includes fused or bridged ring systems. The heteroatom(s) in the heteroaryl radical is optionally oxidized. One or more nitrogen atoms, if present, are optionally quaternized. The heteroaryl is attached to the rest of the molecule through any atom of the ring(s). Examples of heteroaryls include, but are not limited to, azepinyl, acridinyl, benzimidazolyl, benzindolyl, 1,3-benzodioxolyl, benzofuranyl, benzooxazolyl, benzo[d]thiazolyl, benzothiadiazolyl, benzo[b][1,4]dioxepinyl, benzo[b][1,4]oxazinyl, 1,4-benzodioxanyl, benzonaphthofuranyl, benzoxazolyl, benzodioxolyl, benzodioxinyl, benzopyranyl, benzopyranonyl, benzofuranyl, benzofuranonyl, benzothienyl (benzothiophenyl), benzothieno[3,2-d]pyrimidinyl, benzotriazolyl, benzo[4,6]imidazo[1,2-a]pyridinyl, carbazolyl, cinnolinyl, cyclopenta[d]pyrimidinyl, 6,7-dihydro-5H-cyclopenta[4,5]thieno[2,3-d]pyrimidinyl, 5,6-dihydrobenzo[h]quinazolinyl, 5,6-dihydrobenzo[h]cinnolinyl, 6,7-dihydro-5H-benzo[6,7]cyclohepta[1,2-c]pyridazinyl, dibenzofuranyl, dibenzothiophenyl, furanyl, furanonyl, furo[3,2-c]pyridinyl, 5,6,7,8,9,10-hexahydrocycloocta[d]pyrimidinyl, 5,6,7,8,9,10-hexahydrocycloocta[d]pyridazinyl, 5,6,7,8,9,10-hexahydrocycloocta[d]pyridinyl, isothiazolyl, imidazolyl, indazolyl, indolyl, indazolyl, isoindolyl, indolinyl, isoindolinyl, isoquinolyl, indolizinyl, isoxazolyl, 5,8-methano-5,6,7,8-tetrahydroquinazolinyl, naphthyridinyl, 1,6-naphthyridinonyl, oxadiazolyl, 2-oxoazepinyl, oxazolyl, oxiranyl, 5,6,6a,7,8,9,10,10a-octahydrobenzo[h]quinazolinyl, 1-phenyl-1H-pyrrolyl, phenazinyl, phenothiazinyl, phenoxazinyl, phthalazinyl, pteridinyl, purinyl, pyrrolyl, pyrazolyl, pyrazolo[3,4-d]pyrimidinyl, pyridinyl, pyrido[3,2-d]pyrimidinyl, pyrido[3,4-d]pyrimidinyl, pyrazinyl, pyrimidinyl, pyridazinyl, pyrrolyl, quinazolinyl, quinoxalinyl, quinolinyl, isoquinolinyl, tetrahydroquinolinyl, 5,6,7,8-tetrahydroquinazolinyl, 5,6,7,8-tetrahydrobenzo[4,5]thieno[2,3-d]pyrimidinyl, 6,7,8,9-tetrahydro-5H-cyclohepta[4,5]thieno[2,3-d]pyrimidinyl, 5,6,7,8-tetrahydropyrido[4,5-c]pyridazinyl, thiazolyl, thiadiazolyl, triazolyl, tetrazolyl, triazinyl, thieno[2,3-d]pyrimidinyl, thieno[3,2-d]pyrimidinyl, thieno[2,3-c]pridinyl, and thiophenyl (i.e. thienyl). Unless stated otherwise specifically in the specification, the term “heteroaryl” is meant to include heteroaryl radicals as defined above which are optionally substituted by one or more substituents selected from alkyl, alkenyl, alkynyl, halo, fluoroalkyl, haloalkenyl, haloalkynyl, oxo, thioxo, cyano, nitro, optionally substituted aryl, optionally substituted aralkyl, optionally substituted aralkenyl, optionally substituted aralkynyl, optionally substituted carbocyclyl, optionally substituted carbocyclylalkyl, optionally substituted heterocyclyl, optionally substituted heterocyclylalkyl, optionally substituted heteroaryl, optionally substituted heteroarylalkyl, —R^{b}—OR^{a}, —R^{b}—OC(O)—R^{a}, —R^{b}—OC(O)—OR^{a}, —R^{b}—OC(O)—N(R^{a})₂, —R^{b}—N(R^{a})₂, —R^{b}—C(O)R^{a}, —R^{b}—C(O)OR^{a}, —R^{b}—C(O)N(R^{a})₂, —R^{b}—O—R^{c}—C(O)N(R^{a})₂, —R^{b}—N(R^{a})C(O)OR^{a}, —R^{b}—N(R^{a})C(O)R^{a}, —R^{b}—N(R^{a})S(O)ₜR^{a} (where t is 1 or 2), —R^{b}—S(O)ₜR^{a} (where t is 1 or 2), —R^{b}—S(O)ₜOR^{a} (where t is 1 or 2) and —R^{b}—S(O)ₜN(R^{a})₂ (where t is 1 or 2), where each R^{a} is independently hydrogen, alkyl (optionally substituted with halogen, hydroxy, methoxy, or trifluoromethyl), fluoroalkyl, cycloalkyl (optionally substituted with halogen, hydroxy, methoxy, or trifluoromethyl), cycloalkylalkyl (optionally substituted with halogen, hydroxy, methoxy, or trifluoromethyl), aryl (optionally substituted with halogen, hydroxy, methoxy, or trifluoromethyl), aralkyl (optionally substituted with halogen, hydroxy, methoxy, or trifluoromethyl), heterocyclyl (optionally substituted with halogen, hydroxy, methoxy, or trifluoromethyl), heterocyclylalkyl (optionally substituted with halogen, hydroxy, methoxy, or trifluoromethyl), heteroaryl (optionally substituted with halogen, hydroxy, methoxy, or trifluoromethyl), or heteroarylalkyl (optionally substituted with halogen, hydroxy, methoxy, or trifluoromethyl), each R^{b} is independently a direct bond or a straight or branched alkylene or alkenylene chain, and R^{c} is a straight or branched alkylene or alkenylene chain, and where each of the above substituents is unsubstituted unless otherwise indicated.

“Heteroarylalkyl” refers to a radical of the formula —R^{c}-heteroaryl, where R^{c} is an alkylene chain as defined above. If the heteroaryl is a nitrogen-containing heteroaryl, the heteroaryl is optionally attached to the alkyl radical at the nitrogen atom. The alkylene chain of the heteroarylalkyl radical is optionally substituted as defined above for an alkylene chain. The heteroaryl part of the heteroarylalkyl radical is optionally substituted as defined above for a heteroaryl group.

The compounds disclosed herein, in some embodiments, contain one or more asymmetric centers and thus give rise to enantiomers, diastereomers, and other stereoisomeric forms that are defined, in terms of absolute stereochemistry, as (R)- or (S)-. Unless stated otherwise, it is intended that all stereoisomeric forms of the compounds disclosed herein are contemplated by this disclosure. When the compounds described herein contain alkene double bonds, and unless specified otherwise, it is intended that this disclosure includes both E and Z geometric isomers (e.g., cis or trans.) Likewise, all possible isomers, as well as their racemic and optically pure forms, and all tautomeric forms are also intended to be included. The term “geometric isomer” refers to E or Z geometric isomers (e.g., cis or trans) of an alkene double bond. The term “positional isomer” refers to structural isomers around a central ring, such as ortho-, meta-, and para- isomers around a benzene ring.

In general, optionally substituted groups are each independently substituted or unsubstituted. Each recitation of an optionally substituted group provided herein, unless otherwise stated, includes an independent and explicit recitation of both an unsubstituted group and a substituted group (e.g., substituted in certain embodiments, and unsubstituted in certain other embodiments). Unless otherwise stated, substituted groups may be substituted by one or more of the following substituents: halo, cyano, nitro, oxo, thioxo, imino, oximo, trimethylsilanyl, —OR^{a}, —SR^{a}, —OC(O)—R^{a}, —N(R^{a})₂, —C(O)R^{a}, —C(O)OR^{a}, —C(O)N(R^{a})₂, —N(R^{a})C(O)OR^{a}, —OC(O)—N(R^{a})₂, —N(R^{a})C(O)R^{a}, —N(R^{a})S(O)ₜR^{a} (where t is 1 or 2), —S(O)ₜOR^{a} (where t is 1 or 2), —S(O)ₜR^{a} (where t is 1 or 2) and —S(O)ₜN(R^{a})₂ (where t is 1 or 2) where each R^{a} is independently hydrogen, alkyl (optionally substituted with halogen, hydroxy, methoxy, or trifluoromethyl), fluoroalkyl, carbocyclyl (optionally substituted with halogen, hydroxy, methoxy, or trifluoromethyl), carbocyclylalkyl (optionally substituted with halogen, hydroxy, methoxy, or trifluoromethyl), aryl (optionally substituted with halogen, hydroxy, methoxy, or trifluoromethyl), aralkyl (optionally substituted with halogen, hydroxy, methoxy, or trifluoromethyl), heterocyclyl (optionally substituted with halogen, hydroxy, methoxy, or trifluoromethyl), heterocyclylalkyl (optionally substituted with halogen, hydroxy, methoxy, or trifluoromethyl), heteroaryl (optionally substituted with halogen, hydroxy, methoxy, or trifluoromethyl), or heteroarylalkyl (optionally substituted with halogen, hydroxy, methoxy, or trifluoromethyl).

### Methods for Making Compositions

The present methods described herein may comprise exposing a mixture or composition (e.g., a plurality of photopolymers) described herein with electromagnetic radiation above or below a certain threshold energy needed to activate an initiator for inducing polymerization of at least one polymer precursor, such as those described herein.

In one aspect, provided herein is a method for preparing a cured composition, comprising: (a) providing a mixture comprising: (i) a latent ruthenium (Ru) complex; (ii) an initiator; and (iii) at least one polymer precursor; (b) exposing the mixture to electromagnetic radiation above a threshold energy to activate the initiator, wherein upon activation by the electromagnetic radiation above the threshold energy, the initiator reacts with the latent Ru complex to generate an activated Ru complex, and wherein the activated Ru complex reacts with the at least one polymer precursor to induce polymerization of the at least one polymer precursor to generate a plurality of curable photopolymers; (c) placing the plurality of curable photopolymers in a heat-transfer medium; and (d) exposing the plurality of curable photopolymers placed in the heat-transfer medium to electromagnetic radiation below the threshold energy, thereby preparing the cured composition.

In some embodiments, the electromagnetic radiation below the threshold energy is microwave radiation. In some embodiments, the electromagnetic radiation below the threshold energy is infrared radiation. In some embodiments, the heat-transfer medium is a liquid medium. In some embodiments, the heat-transfer medium comprises a liquid component selected from the group consisting of water, an alcohol (e.g., methanol, ethanol, or isopropanol), a glycol, a polyglycol, (e.g., PEG, PPG polyether), glycerol (e.g., vegetable glycerol), and combinations thereof. In some embodiments, the heat-transfer medium is a solution comprising glycerol and water. In some embodiments, the heat-transfer medium is a solution comprising about 50 to 80 percent by volume of a first liquid component, based on a total volume of the solution, and about 20 to about 50 percent by volume of a second liquid component, based on a total volume of the solution. In some embodiments, the heat-transfer medium is a solution comprising about 80 percent by volume of glycerol based on a total volume of the solution, and about 20 percent by volume of water, based on a total volume of the solution. In some embodiments, the heat-transfer medium comprises one or more additives. In some embodiments, the one or more additives is selected from the group consisting of a colorant, a dye, a pigment, a brightener, a stabilizer, a plasticizer, and a surface modifier. In some embodiments, the heat-transfer medium comprises at least one antioxidant. In some embodiments, the heat-transfer medium comprises about 1 weight percent to about 5 percent of the at least one antioxidant based on the total weight of the heat-transfer medium (e.g., about 1 weight percent, about 2 weight percent, about 3 weight precent, about 4 weight percent, or about 5 weight percent of the at least one antioxidant based on the total weight of the heat-transfer medium). In some embodiments, the at least one antioxidant is at least one naturally occurring antioxidant. In some embodiments, the at least one antioxidant is at least one food-grade antioxidant. In some embodiments, the at least one antioxidant is ascorbic acid. In some embodiments, the heat-transfer medium comprises about 1 weight percent to about 5 percent of ascorbic acid based on the total weight of the heat-transfer medium (e.g., about 1 weight percent, about 2 weight percent, about 3 weight precent, about 4 weight percent, or about 5 weight percent of ascorbic acid based on the total weight of the heat-transfer medium). In some embodiments, the heat-transfer medium comprises about 3 weight percent ascorbic acid based on the total weight of the heat-transfer medium. In some embodiments, the electromagnetic radiation below the threshold energy raises the temperature of the heat-transfer medium to about 50° C. to about 250° C. In some embodiments, the electromagnetic radiation below the threshold energy raises the temperature of the heat-transfer medium to about 95° C. to about 210° C. In some embodiments, the electromagnetic radiation below the threshold energy raises the temperature of the heat-transfer medium to the glass transition temperature (T_{g}) of the plurality of curable photopolymers at the time the plurality of curable photopolymers is placed in the heat-transfer medium. In some embodiments, the electromagnetic radiation above the threshold energy is visible light or ultraviolet light. In some embodiments, the wavelength of the electromagnetic radiation above the threshold energy is from 200-800 nm. In some embodiments, the mixture further comprises a sensitizer that sensitizes the initiator upon exposing the mixture to the electromagnetic radiation above the threshold energy, thereby activating the initiator. In some embodiments, the at least one polymer precursor comprises at least one olefin. In some embodiments, the plurality of curable photopolymers comprises a cyclic olefin polymer. In some embodiments, the plurality of curable photopolymers placed in the heat-transfer medium is exposed to the electromagnetic radiation below the threshold energy for about 1 week, about 5 days, about 4 days, about 3 days, about 2 days, about 1 day, about 20 hours, about 15 hours, about 10 hours, about 5 hours, about 4 hours, about 3 hours, about 2 hours, or about 1 hour. In some embodiments, the microwave radiation has a frequency of about 2-3 GHz (e.g., 2.45 GHz).

In another aspect, provided herein is a method of reducing oxidative decomposition of a plurality of curable photopolymers while curing the plurality of curable photopolymers with electromagnetic below a threshold energy, comprising: (a) providing a mixture comprising: (i) a latent ruthenium (Ru) complex; (ii) an initiator; and (iii) at least one polymer precursor; (b) exposing the mixture to electromagnetic radiation above the threshold energy to activate the initiator, wherein upon activation by the electromagnetic radiation above the threshold energy, the initiator reacts with the latent Ru complex to generate an activated Ru complex, and wherein the activated Ru complex reacts with the at least one polymer precursor to induce polymerization of the at least one polymer precursor to generate the plurality of curable photopolymers; and (c) placing the plurality of curable photopolymers in a heat-transfer medium comprising a solvent and at least one antioxidant; and (d) exposing the plurality of curable photopolymers placed in the heat-transfer mixture to the electromagnetic below the threshold energy.

In some embodiments, the electromagnetic radiation below the threshold energy is microwave radiation. In some embodiments, the electromagnetic radiation below the threshold energy is infrared radiation. In some embodiments, the heat-transfer medium is a liquid medium. In some embodiments, the heat-transfer medium comprises a liquid component selected from the group consisting of water, an alcohol (e.g., methanol, ethanol, or isopropanol), a glycol, a polyglycol, (e.g., PEG, PPG polyether), glycerol (e.g., vegetable glycerol), and combinations thereof. In some embodiments, the heat-transfer medium is a solution comprising glycerol and water. In some embodiments, the heat-transfer medium is a solution comprising about 50 to 80 percent by volume of a first liquid component, based on a total volume of the solution, and about 20 to about 50 percent by volume of a second liquid component, based on a total volume of the solution. In some embodiments, the heat-transfer medium is a solution comprising about 80 percent by volume of glycerol based on a total volume of the solution, and about 20 percent by volume of water, based on a total volume of the solution. In some embodiments, the heat-transfer medium comprises one or more additives. In some embodiments, the one or more additives is selected from the group consisting of a colorant, a dye, a pigment, a brightener, a stabilizer, a plasticizer, and a surface modifier. In some embodiments, the heat-transfer medium comprises about 1 weight percent to about 5 percent of the at least one antioxidant based on the total weight of the heat-transfer medium (e.g., about 1 weight percent, about 2 weight percent, about 3 weight precent, about 4 weight percent, or about 5 weight percent of the at least one antioxidant based on the total weight of the heat-transfer medium). In some embodiments, the at least one antioxidant is at least one naturally occurring antioxidant. In some embodiments, the at least one antioxidant is at least one food-grade antioxidant. In some embodiments, the at least one antioxidant is ascorbic acid. In some embodiments, the heat-transfer medium comprises about 1 weight percent to about 5 percent of ascorbic acid based on the total weight of the heat-transfer medium (e.g., about 1 weight percent, about 2 weight percent, about 3 weight precent, about 4 weight percent, or about 5 weight percent of ascorbic acid based on the total weight of the heat-transfer medium). In some embodiments, the heat-transfer medium comprises about 3 weight percent ascorbic acid based on the total weight of the heat-transfer medium. In some embodiments, the electromagnetic radiation below the threshold energy raises the temperature of the heat-transfer medium to about 50° C. to about 250° C. In some embodiments, the electromagnetic radiation below the threshold energy raises the temperature of the heat-transfer medium to about 95° C. to about 210° C. In some embodiments, the electromagnetic radiation below the threshold energy raises the temperature of the heat-transfer medium to the glass transition temperature (T_{g}) of the plurality of curable photopolymers at the time the plurality of curable photopolymers is placed in the heat-transfer medium. In some embodiments, the electromagnetic radiation above the threshold energy is visible light or ultraviolet light. In some embodiments, the wavelength of the electromagnetic radiation above the threshold energy is from 200-800 nm. In some embodiments, the mixture further comprises a sensitizer that sensitizes the initiator upon exposing the mixture to the electromagnetic radiation above the threshold energy, thereby activating the initiator. In some embodiments, the at least one polymer precursor comprises at least one olefin. In some embodiments, the plurality of curable photopolymers comprises a cyclic olefin polymer. In some embodiments, the plurality of curable photopolymers placed in the heat-transfer medium is exposed to the electromagnetic radiation below the threshold energy for about 1 week, about 5 days, about 4 days, about 3 days, about 2 days, about 1 day, about 20 hours, about 15 hours, about 10 hours, about 5 hours, about 4 hours, about 3 hours, about 2 hours, or about 1 hour. In some embodiments, the microwave radiation has a frequency of about 2-3 GHz (e.g., 2.45 GHz).

In another aspect, provided herein is a method for preparing a cured composition, comprising: (a) providing a mixture comprising: (i) a latent ruthenium (Ru) complex; (ii) an initiator; and (iii) at least one polymer precursor; (b) exposing the mixture to electromagnetic radiation above a threshold energy to activate the initiator, wherein upon activation by the electromagnetic radiation above the threshold energy, the initiator reacts with the latent Ru complex to generate an activated Ru complex, and wherein the activated Ru complex reacts with the at least one polymer precursor to induce polymerization of the at least one polymer precursor to generate a plurality of curable photopolymers; and (c) means for reducing oxidative decomposition of a plurality of curable photopolymers while curing the plurality of curable photopolymers with electromagnetic radiation below the threshold energy, thereby preparing the cured composition.

In some embodiments, the electromagnetic radiation above the threshold energy is visible light or ultraviolet light. In some embodiments, the electromagnetic radiation below the threshold energy is infrared radiation (e.g., near-infrared, mid-infrared, or far-infrared radiation). In some embodiments, the electromagnetic radiation below the threshold energy is microwave radiation. In some embodiments, the microwave radiation has a frequency of about 2-3 GHz (e.g., 2.45 GHz).

In some embodiments, a heat-transfer medium described herein may comprise about 5 volume percent, about 10 volume percent, about 15 volume percent, about 20 volume percent, about 25 volume percent, about 30 volume percent, about 35 volume percent, about 40 volume percent, about 45 volume percent, about 50 volume percent, about 55 volume percent, about 60 volume percent, about 65 volume percent, about 70 volume percent, about 75 volume percent, about 80 volume percent, about 85 volume percent, about 90 volume percent, about 95 volume percent, or about 100 volume percent of a liquid component (e.g., a liquid component described herein), based on a total volume of the heat-transfer medium.

In some embodiments, a heat-transfer medium described herein may comprise about 50 volume percent to about 90 volume percent, about 60 volume percent to about 80 volume percent, about 65 volume percent to about 85 volume percent, about 75 volume percent to about 85 volume percent, or about 85 volume percent to about 95 volume percent of a first liquid component (e.g., a liquid component described herein), based on a total volume of the heat-transfer medium.

In some embodiments, a heat-transfer medium described herein may comprise about 1 volume percent to about 50 volume percent, 10 volume percent to about 50 volume percent, about 20 volume percent to about 40 volume percent, about 20 volume percent to about 30 volume percent, or about 15 volume percent to about 25 volume percent of a second liquid component (e.g., a liquid component described herein), based on a total volume of the heat-transfer medium.

An antioxidant of the present disclosure (e.g., an antioxidant in a heat-transfer medium described herein) includes, but is not limited to, ascorbic acid, butylated hydroxytoluene (BHT), butylated hydroxyanisole (BHA), vitamin E, vitamin E TPGS, isoascorbic acid, citric acid, or propyl gallate.

Exemplary electromagnetic radiation above the threshold energy has, in certain embodiments, a wavelength of at most about 1 nanometer (nm), at most about 10 nm, at most about 50 nm, at most about 100 nm, at most about 110 nm, at most about 120 nm, at most about 130 nm, at most about 140 nm, at most about 150 nm, at most about 160 nm, at most about 170 nm, at most about 180 nm, at most about 190 nm, at most about 200 nm, at most about 200 nm, at most about 210 nm, at most about 230 nm, at most about 240 nm, at most about 250 nm, at most about 260 nm, at most about 270 nm, at most about 280 nm, at most about 290 nm, at most about 300 nm, at most about 310 nm, at most about 320 nm, at most about 330 nm, at most about 340 nm, at most about 350 nm, at most about 360 nm, at most about 370 nm, at most about 380 nm, at most about 390 nm, at most about 400 nm, at most about 410 nm, at most about 420 nm, at most about 430 nm, at most about 440 nm, at most about 450 nm, at most about 460 nm, at most about 470 nm, at most about 480 nm, at most about 490 nm, at most about 500 nm, at most about 510 nm, at most about 520 nm, at most about 530 nm, at most about 540 nm, at most about 550 nm, at most about 560 nm, at most about 570 nm, at most about 580 nm, at most about 590 nm, at most about 600 nm, at most about 610 nm, at most about 620 nm, at most about 630 nm, at most about 640 nm, at most about 650 nm, at most about 660 nm, at most about 670 nm, at most about 680 nm, at most about 690 nm, at most about 700 nm, at most about 710 nm, at most about 720 nm, at most about 730 nm, at most about 740 nm, at most about 750 nm, at most about 760 nm, at most about 770 nm, at most about 780 nm, at most about 790 nm, at most about 800 nm, at most about 810 nm, at most about 820 nm, at most about 830 nm, at most about 840 nm, at most about 850 nm, at most about 860 nm, at most about 870 nm, at most about 880 nm, at most about 890 nm, or at most about 900 nm. In some embodiments, the wavelength of the electromagnetic radiation above the threshold energy is from 200-800 nm (e.g., 350 nm to 465 nm). In some embodiments, electromagnetic radiation above the threshold energy is light having a wavelength from 350 nm to 465 nm.

Exemplary electromagnetic radiation below the threshold energy has, in certain embodiments, a wavelength of at least about 700 nm, at least about 710 nm, at least about 720 nm, at least about 730 nm, at least about 740 nm, at least about 750 nm, at least about 760 nm, at least about 770 nm, at least about 780 nm, at least about 790 nm, at least about 800 nm, at least about 810 nm, at least about 820 nm, at least about 830 nm, at least about 840 nm, at least about 850 nm, at least about 860 nm, at least about 870 nm, at least about 880 nm, at least about 890 nm, or at least about 900 nm, at least about 950 nm, at least about 1 micrometer (μm), at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, at least about 900 μm, or at least about 1 millimeter (mm). Other exemplary electromagnetic radiation below the threshold energy has, in certain embodiments, a wavelength of at least about 1 mm, a wavelength of at least about 2 mm, a wavelength of at least about 3 mm, a wavelength of at least about 4 mm, a wavelength of at least about 5 mm, a wavelength of at least about 6 mm, a wavelength of at least about 7 mm, a wavelength of at least about 8 mm, a wavelength of at least about 9 mm, a wavelength of at least about 10 mm, a wavelength of at least about 20 mm, a wavelength of at least about 30 mm, a wavelength of at least about 40 mm, a wavelength of at least about 50 mm, a wavelength of at least about 60 mm, a wavelength of at least about 70 mm, a wavelength of at least about 80 mm, a wavelength of at least about 90 mm, or a wavelength of at least about 100 mm.

In some embodiments, the mixtures provided herein are exposed to electromagnetic radiation above the threshold energy at temperatures of about −30° C., −20° C., −10° C., 0° C., 10° C., 20° C., 30° C., 40° C., 50° C., 60° C., 70° C., 80° C., 90° C., 100° C., 110° C., 120° C., 130° C., 140° C., 150° C., 160° C., 170° C., 180° C., 190° C., 200° C., 220° C., 250° C., 270° C., 300° C., or more. In some embodiments, the mixtures provided herein are exposed to electromagnetic radiation above the threshold energy at temperatures of about 300° C., 270° C., 250° C., 220° C., 200° C., 190° C., 180° C., 170° C., 160° C., 150° C., 140° C., 130° C., 120° C., 110° C., 100° C., 90° C., 80° C., 70° C., 60° C., 50° C., 40° C., 30° C., 20° C., 10° C., 0° C., −10° C., −20° C., −30° C., or less.

In some embodiments, the compositions (e.g., a plurality of photopolymers) provided herein may be exposed to electromagnetic radiation below the threshold energy at temperatures of about −30° C., −20° C., −10° C., 0° C., 10° C., 20° C., 30° C., 40° C., 50° C., 60° C., 70° C., 80° C., 90° C., 100° C., 110° C., 120° C., 130° C., 140° C., 150° C., 160° C., 170° C., 180° C., 190° C., 200° C., 220° C., 250° C., 270° C., 300° C., or more. In some embodiments, the compositions (e.g., a plurality of photopolymers) provided herein may be exposed to electromagnetic radiation below the threshold energy at temperatures of about 300° C., 270° C., 250° C., 220° C., 200° C., 190° C., 180° C., 170° C., 160° C., 150° C., 140° C., 130° C., 120° C., 110° C., 100° C., 90° C., 80° C., 70° C., 60° C., 50° C., 40° C., 30° C., 20° C., 10° C., 0° C., −10° C., −20° C., −30° C., or less.

In some embodiments, the mixtures provided herein may be exposed to electromagnetic radiation above the threshold energy for about 1 week, about 5 days, about 4 days, about 3 days, about 2 days, about 1 day, about 20 hours, about 15 hours, about 10 hours, about 5 hours, about 4 hours, about 3 hours, about 2 hours, or about 1 hour.

In some embodiments, the compositions (e.g., a plurality of photopolymers) provided herein are exposed to electromagnetic radiation below the threshold energy for about 1 week, about 5 days, about 4 days, about 3 days, about 2 days, about 1 day, about 20 hours, about 15 hours, about 10 hours, about 5 hours, about 4 hours, about 3 hours, about 2 hours, or about 1 hour.

In other embodiments, electromagnetic radiation described herein has a wavelength of at least about 1 nanometers (nm), 10 nm, at least about 50 nm, at least about 100 nm, at least about 200 nm, at least about 300 nm, at least about 400 nm, at least about 500 nm, at least about 600 nm, at least about 700 nm, at least about 800 nm, at least about 900 nm, at least about 1 micrometer (μm), at least about 10 μm, at least about 50 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 millimeter (mm), at least about 10 mm, at least about 50 mm, at least about 100 mm, at least about 200 mm, at least about 300 mm, at least about 400 mm, at least about 500 mm, at least about 600 mm, at least about 700 mm, at least about 800 mm, at least about 900 mm, at least about 1 meter (m), at least about 10 m, at least about 100 m, at least about 200 m, at least about 300 m, at least about 400 m, at least about 500 m, at least about 600 m, at least about 700 m, at least about 800 m, at least about 900 m, at least about 1 kilometer (km), at least about 2 km, at least about 3 km, at least about 4 km, at least about 5 km, at least about 6 km, at least about 7 km, at least about 8 km, at least about 9 km, or more. The electromagnetic radiation may have a wavelength of at most about 10 km, at most about 9 km, at most about 8 km, at most about 7 km, at most about 6 km, at most about 5 km, at most about 4 km, at most about 3 km, at most about 2 km, at most about 1 km, at most about 900 m, at most about 800 m, at most about 700 m, at most about 600 m, at most about 500 m, at most about 400 m, at most about 300 m, at most about 200 m, at most about 100 m, at most about 10 m, at most about 1 m, at most about 900 mm, at most about 800 mm, at most about 700 mm, at most about 600 mm, at most about 500 mm, at most about 400 mm, at most about 300 mm, at most about 200 mm, at most about 100 mm, at most about 50 mm, at most about 10 mm, at most about 1 mm, at most about 900 μm, at most about 800 μm, at most about 700 μm, at most about 600 μm, at most about 500 μm, at most about 400 μm, at most about 300 μm, at most about 200 μm, at most about 100 μm, at most about 50 μm, at most about 10 μm, at most about 1 μm, at most about 900 nm, at most about 800 nm, at most about 700 nm, at most about 600 nm, at most about 500 nm, at most about 400 nm, at most about 300 nm, at most about 200 nm, at most about 100 nm, at most about 50 nm, at most about 10 nm, at most about 1 nm, or less. The electromagnetic radiation may have a wavelength from about 1 nanometers (nm) to about 10 kilometers (km). The electromagnetic radiation may have a wavelength from about 150 nm to about 2000 nm.

The source of the electromagnetic radiation may be, for example, a laser beam, an incandescent light source, a fluorescent light source, an ultraviolet light source, which may derive from, for example, lamps, lasers, light emitting diodes (LEDs), sunlight and other photon sources. The electromagnetic radiation may be emitted from a laser, a digital light processing (DLP) projector, a lamp, a LED, a mercury arc lamp, a fiber optic, or liquid crystal display (LCD).

A mixture or composition (e.g., a plurality of photopolymers) described herein may be exposed to electromagnetic radiation of an amount of at least 1 milliJoules/centimeters² (mJ/cm²), 10 (mJ/cm²), 50 mJ/cm², 100 mJ/cm², 200 mJ/cm², 300 mJ/cm², 400 mJ/cm², 500 mJ/cm², 1,000 mJ/cm², 2,500 mJ/cm², 5,000 mJ/cm², 7,500 mJ/cm², 10,000 mJ/cm², 15,000 mJ/cm², 20,000 mJ/cm², 30,000 mJ/cm², 40,000 mJ/cm², 50,000 mJ/cm², 60,000 mJ/cm², 70,000 mJ/cm², 80,000 mJ/cm², 90,000 mJ/cm², 100,000 mJ/cm², or more. The mixture may be exposed to electromagnetic radiation of an amount of at most 100,000 mJ/cm², 90,000 mJ/cm², 80,000 mJ/cm², 70,000 mJ/cm², 60,000 mJ/cm², 50,000 mJ/cm², 40,000 mJ/cm², 30,000 mJ/cm², 20,000 mJ/cm², 15,000 mJ/cm², 10,000 mJ/cm², 7,500 mJ/cm², 5,000 mJ/cm², 2,500 mJ/cm², 1,000 mJ/cm², 500 mJ/cm², 400 mJ/cm², 300 mJ/cm², 200 mJ/cm², 100 mJ/cm², 50 mJ/cm², 10 mJ/cm², 1 mJ/cm², or less. The mixture may be exposed to electromagnetic radiation from 1 milliJoules/centimeters² mJ/cm² to about 100,000 mJ/cm². The mixture may be exposed to electromagnetic radiation from 100 milliJoules/centimeters² mJ/cm² to about 1,000 mJ/cm².

The compositions (e.g., a plurality of photopolymers or cured composition) and methods described herein may vary depending on the application, material properties, and processing mechanism. Examples include: viscosities from about 5 centipoise (cP) to about 50,000 cP, latent catalyst loadings from about 0.5 ppm to about 1 wt %, PAG or PAH loadings from about 1 ppm to about 2 wt %, sensitizer loadings from about 0 (not present in mixture) to about 3 wt %, stabilizers from about 0 (not present in mixture) to about 5 wt % (e.g., 0.1 ppm to about 5 wt %), antioxidants from about 0 (not present in mixture) to about 5 wt % (e.g., 0.1 ppm to about 5 wt %), solvents from about 0 to about 90%, impact modifiers from about 0 (not present in mixture) to about 20 wt % (e.g., 10 ppm to about 20 wt %), and plasticizers from about 0 (not present in mixture) to about 3 wt % (e.g., 1 ppm to about 3 wt %), process temperatures from about −10° C. to about 220° C., oxygen concentrations from about 1 ppb to about 50%, exposure doses from about 1 milliJoules per centimeter² mJ/cm² to about 1 kiloJoules per centimeter² kJ/cm², irradiances from about 1 milliWatt per centimeter² mW/cm² to about 1 kiloWatt per centimeter² kW/cm², final Young's modulus from about 1 MegaPascals (MPa) to about 20 GigaPascals (GPa).

The photopolymers and compositions (e.g., a plurality of photopolymers or cured composition) described herein may be relevant to many industrial processes, such as, for example, photolithography, stereolithography, inkjet printing, ultraviolet (UV) light-cured materials and adhesives, visible light-cured materials and adhesives, electron beam curing and lithography, multiphoton lithography, computed axial lithography, vat photopolymerization, nanoimprint lithography, additive manufacturing, direct write lithography, and other processes where directed energy is used to trigger polymerization. The photopolymerization may occur in a mold, on a substrate, in contact with another liquid, in a rotating container, on an actuated build platform, via an extrusion nozzle, or in any of the other myriad forms of controlling photopolymerizations. Heat or other forms of electromagnetic radiation may be used before, during or after curing to modify the kinetics of reactivity, tune the materials properties, or otherwise improve the photopolymerization process. The atmosphere of the curing or post-curing environment may be modified as well, including using, for example, nitrogen, argon or vacuum to eliminate oxygen and other unwanted reactive species.

Applications of the photopolymers and cured compositions described herein may include, for example, the manufacturing, processing, printing, lithography, molding, additive manufacturing, deposition, or production of an oral product (e.g., a dental product or an orthodontic product), including, for example, thermosets, thermoplastics, elastomers, resists, resins, waxes, rubbers, aerogels, glasses, composites and metamaterials. Possible use cases include, for example, the manufacturing of products, components, parts, tools, molds, bulk materials and intermediates for an oral product (e.g., a dental product or an orthodontic product), including, for example, an orthodontic aligner, a mouth guard, a surgical guide, a night guard, a splint, a denture, a prosthodontic, a dental prosthetic, an extra-oral appliance, a crown, a grill, dental jewelry, a brace, a surgical stent, a bruxism device (e.g., a bruxism guard), a sleep apnea device, a provisional or temporary restoration product (e.g., a temporary crown or a temporary bridge).

### Mixtures and Compositions

The present methods for preparing a cured composition provided herein comprise providing a mixture.

A mixture or composition (e.g., a plurality of photopolymers or cured composition) provided herein may have a viscosity of at least 1 centipoise (cP), 50 cP, 100 cP, 500 cP, 1,000 cP, 5,000 cP, 10,000 cP, 50,000 cP, 100,000 cP, 500,000 cP, or more. The mixture provided herein may have a viscosity of at most 500,000 centipoise (cP), 100,000 cP, 50,000 cP, 10,000 cP, 5,000 cP, 1,000 cP, 500 cP, 100 cP, 50 cP, 1 cP, or less. The mixture provided herein may have a viscosity within a range defined by any two of the preceding values. The mixture provided herein may have a viscosity from 1 cP to 500,000 cP. The mixture provided herein may have a viscosity from 2 cP to 10,000 cP.

The photosensitive, polymerizable compositions provided herein may be dissolved or admixed within polymerizable material matrix. Such matrices can include polymers, polymer precursors, or a combination thereof. The matrix may contain at least one olefinic (alkene) or one acetylenic (alkyne) bond per molecule, oligomeric unit, or polymeric unit. Such compositions may include crosslinking polymers. The mixture of polymerized and non-polymerized materials may result from the incomplete polymerization of the polymer precursor. The polymerized and non-polymerized materials may be chemically unrelated.

The mixtures provided herein comprise, in certain embodiments, a catalyst, e.g., a latent ruthenium (Ru) complex, an initiator, and at least one polymer precursor. In certain embodiments, the mixture comprises a sensitizer. In certain embodiments, the mixture comprises an additive.

The mixtures provided herein may be activated at a wavelength from 100-1000 nanometers (nm) (e.g., 350 nm to 465 nm) at a temperature from −30° C. to 300° C. (e.g., 20° C. to 50° C.) for 1 nanosecond (ns) to 1 week (e.g., 1 millisecond (ms) to 1 hour).

Exemplary catalysts, initiators, polymer precursors, sensitizers, and additives that may be used in mixtures described herein are provided below.

### Catalyst:

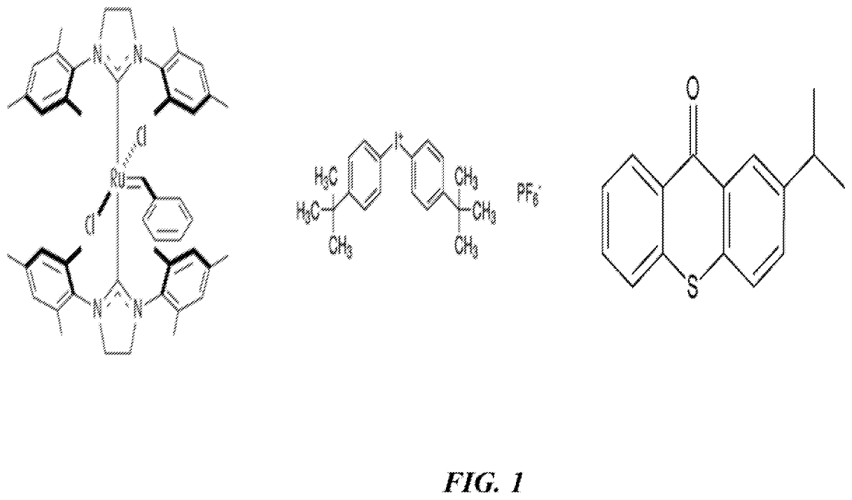

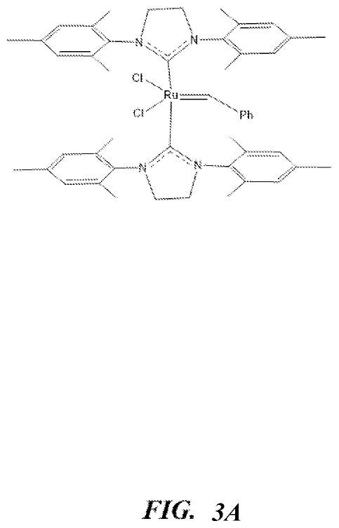

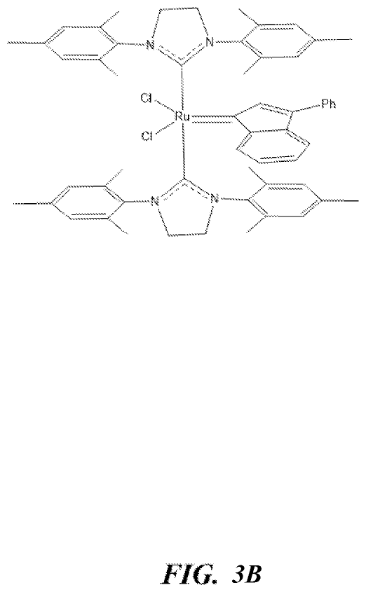

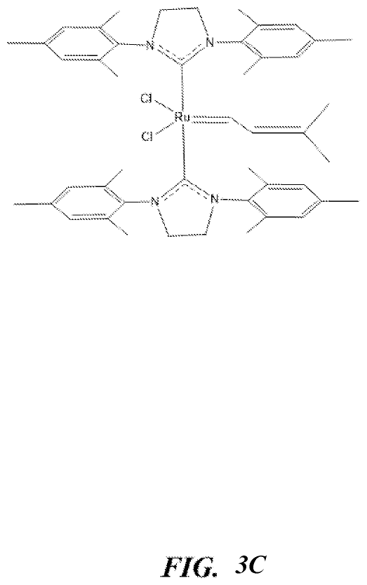

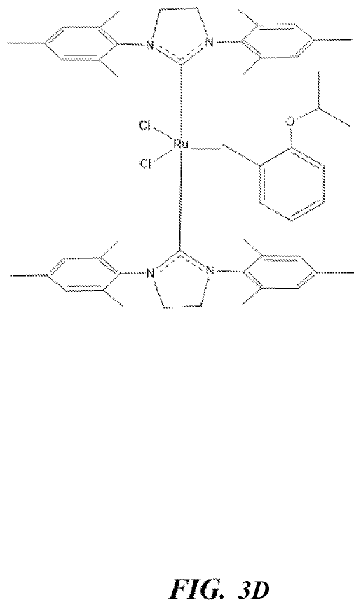

The catalyst may be a latent catalyst. The catalyst may be a ruthenium (Ru) catalyst or a Ru complex. The Ru complex may be a latent Ru complex. The latent Ru complex can be a Grubb's catalyst or a Grubb's-type catalyst. The Grubb's catalyst may be a first-generation catalyst, a second-generation catalyst, a Hoveyda-Grubb's catalyst, or a third-generation Grubb's catalyst (e.g., see FIG. 1, FIG. 3A, FIG. 3B, FIG. 3C, and FIG. 3D). The Grubb's-type catalyst may comprise at least one N-heterocyclic carbene (NHC) ligand. The Ru complex may be a 16-electron species.

In some embodiments, the latent Ru complex is selected from the group consisting of.

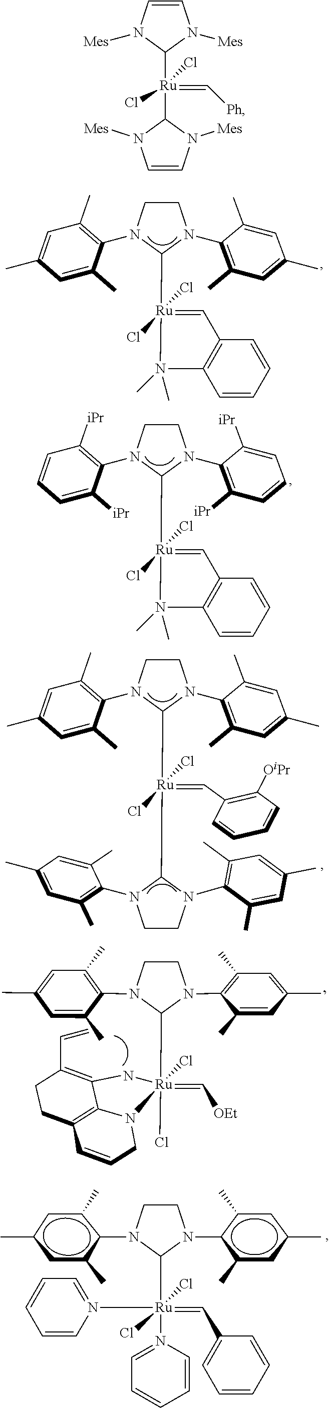

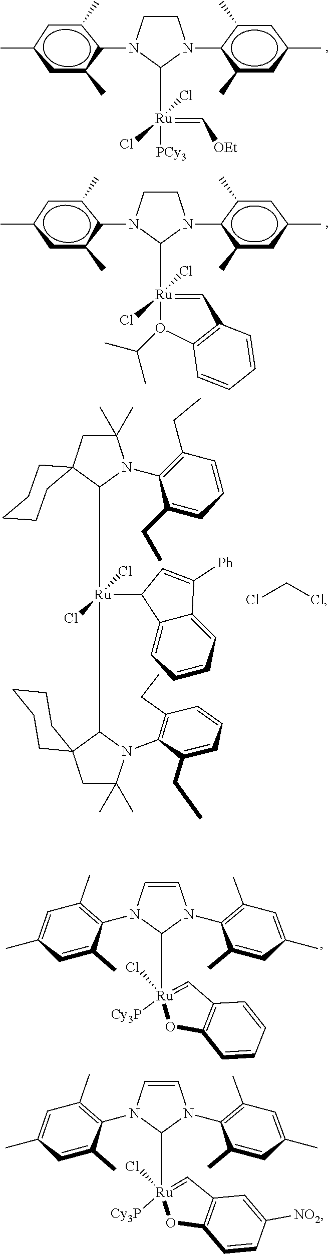

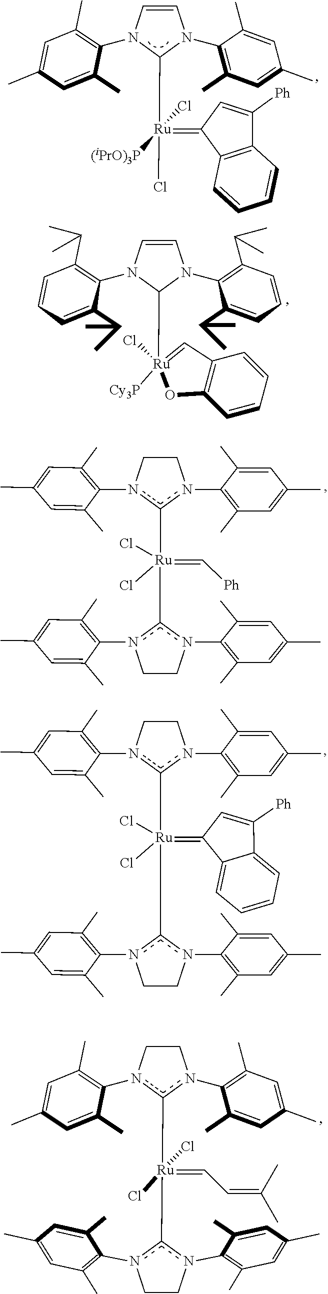

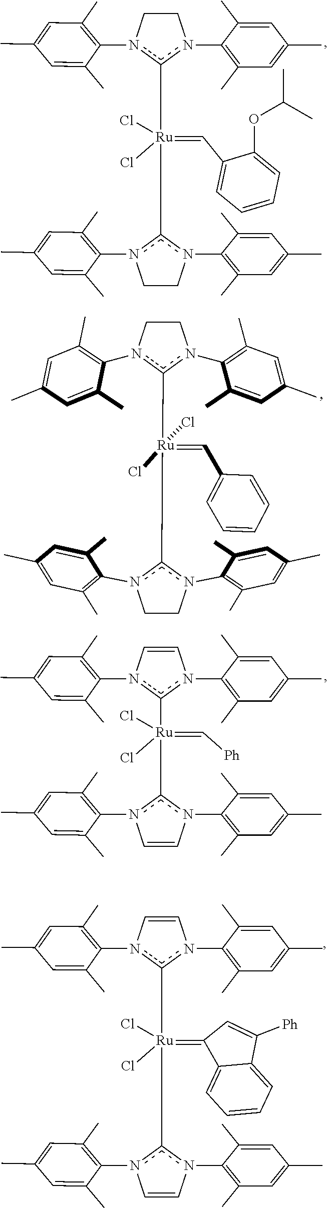

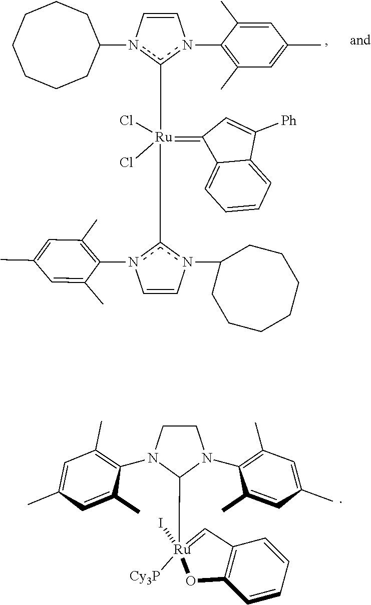

In some embodiments, the latent Ru complex is selected from the group consisting of:

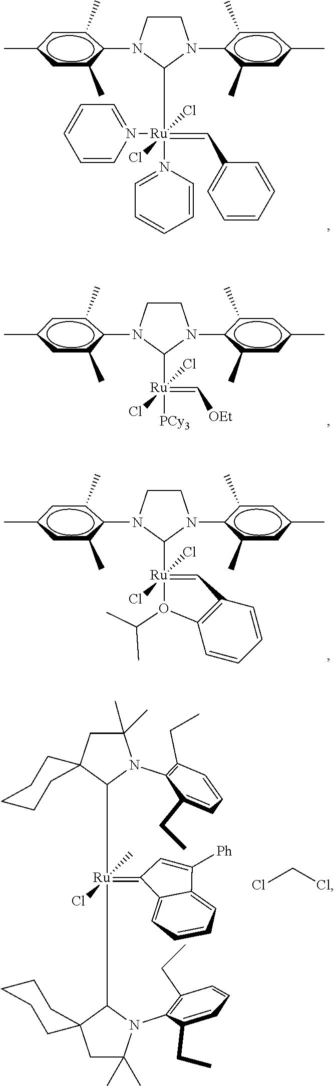

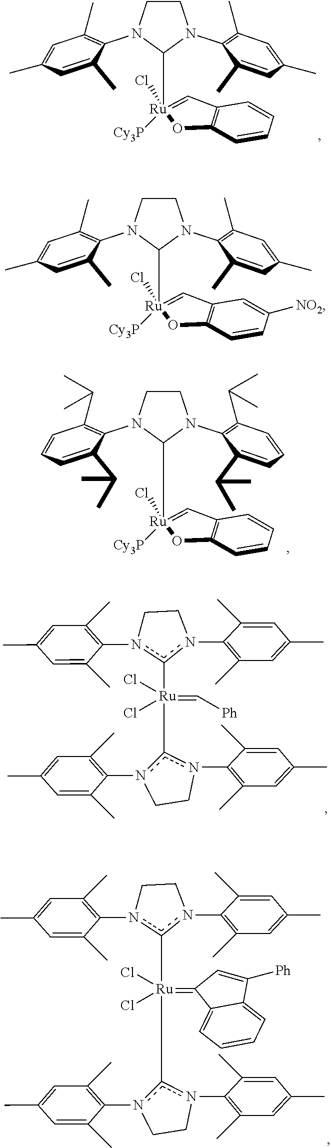

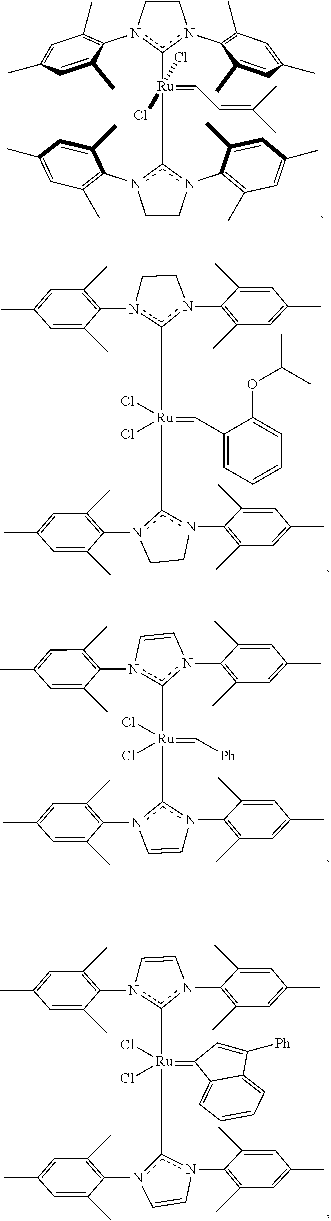

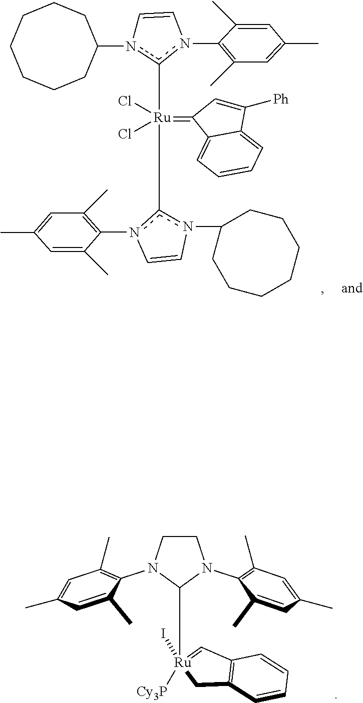

In some embodiments, a mixture described herein comprises any catalyst described in any of International Publication Number WO 2014/055720, U.S. Pat. No. 9,207,532, European Patent Number 2,903,996, International Publication Number WO 2015/065649, U.S. Patent Publication Number 2015/118188, European Patent Publication Number 3,063,592, International Publication Number WO 2018/045132, U.S. Patent Publication Number 2018/067393, U.S. Patent Publication Number 2020/183276, European Patent Publication Number 3,507,007, International Publication Number WO 2020/006345, Photolithographic Olefin Metathesis Polymerization, J. Am. Chem. Soc. 2013, 135, 16817-16820, Visible-Light-Controlled Ruthenium-Catalyzed Olefin Metathesis, J. Am. Chem. Soc. 2019, 141, 17, 6791-6796, A Tandem Approach to Photoactivated Olefin Metathesis: Combining a Photoacid Generator with an Acid Activated Catalyst, J. Am. Chem. Soc. 2009, 131, 6, 2038-2039, Metal-Free Ring-Opening Metathesis Polymerization, J. Am. Chem. Soc. 2015, 137, 1400-1403, JOURNAL OF POLYMER SCIENCE, PART A: POLYMER CHEMISTRY 2019, 57, 1791-17, each of which is incorporated herein by reference, in their entirety, in particular for the compounds provided therein.

The example of a Grubbs-type catalyst containing two N-heterocyclic carbene (NHC) ligands is presented in FIG. 1 since these ligands are typically the strongest to bind to Ru. Other strong ligands may include, for example, phosphines, phosphites, amines, ethers, thiols, and alcohols. As a result, the 16-electron complexes containing two NHC ligands may be very slow to participate in olefin metathesis. The catalyst may become active upon liberation of one NHC ligand to the 14-electron complex. The activated Ru complex may comprise at least one N-heterocyclic carbene (NHC) ligand. The activated Ru complex may comprise one N-heterocyclic carbene (NHC) ligand. The activated Ru complex may comprise a 14-electron species. Example 1 described herein provides a type of latent catalyst that is embodied by the disclosure.

The catalyst (e.g., latent Ru complex) can be present (e.g., combined) in a mixture provided herein at a concentration of at least 0.1 parts per million (ppm) (e.g., 0.00001% by weight), 1 ppm (e.g., 0.0001% by weight), 10 ppm (e.g., 0.001% by weight), 100 ppm (e.g., 0.01% by weight), 1,000 ppm (e.g., 0.1% by weight), 10,000 ppm (e.g., 1% by weight), or more. The catalyst (e.g., latent Ru complex) can be present (e.g., combined) in a mixture provided herein at a concentration of at most 10,000 ppm (e.g., 1% by weight), 1,000 ppm (e.g., 0.1% by weight), 100 ppm (e.g., 0.01% by weight), 10 ppm (e.g., 0.001% by weight), 1 ppm (e.g., 0.0001% by weight), 0.1 ppm (e.g., 0.00001% by weight), or less. The catalyst (e.g., latent Ru complex) can be present (e.g., combined) in a mixture provided herein at a concentration within a range defined by any two of the preceding values. The catalyst (e.g., latent Ru complex) can be present (e.g., combined) in a mixture provided herein at a concentration from about 0.1 ppm (e.g., 0.00001% by weight) to about 10,000 ppm (e.g., 1% by weight). The catalyst (e.g., latent Ru complex) can be present (e.g., combined) in a mixture provided herein at a concentration from about 1 ppm (e.g., 0.00001% by weight) to about 10,000 ppm (e.g., 1% by weight).

The catalyst (e.g., latent Ru complex) and the initiator can be present (e.g., combined) in a mixture provided herein at a ratio of the Ru complex to the initiator at a ratio by moles of at least 0.01:1.0, 0.025:1.0, 0.05:1.0, 0.075:1.0, 0.1:1.0, 0.5:1.0, 1.0:1.0, 1.5:1.0, 2.0:1.0, 3.0:1.0, 4.0:1.0, 5.0:1.0, 6.0:1.0, 7.0:1.0, 8.0:1.0, 9.0:1.0, 10:1.0, or more of the Ru complex. The catalyst (e.g., latent Ru complex) and the initiator can be present (e.g., combined) in a mixture provided herein at a ratio of the Ru complex to the initiator at a ratio by moles of at most 10:1.0, 9.0:1.0, 8.0:1.0, 7.0:1.0, 6.0:1.0, 5.0:1.0, 6.0:1.0, 4.0:1.0, 3.0:1.0, 2.0:1.0, 1.0:1.0, 0.5:1.0, 0.1:1.0, 0.075:1.0, 0.05:1.0, 0.025:1.0, 0.01:1.0, or less of the Ru complex. The catalyst (e.g., latent Ru complex) and the initiator can be present (e.g., combined) in a mixture provided herein at a ratio of the Ru complex to the initiator at a ratio by moles within a range defined by any two of the preceding values. The catalyst (e.g., latent Ru complex) and the initiator can be present (e.g., combined) in a mixture provided herein at a ratio of the Ru complex to the initiator at a ratio by moles from 0.01:1.0 to 10:1.0. The latent Ru complex and the initiator may be present in the mixture at a ratio by moles of the Ru complex to the initiator at a ratio by moles from 0.02:1.0 to 1.0:1.0.

The catalyst (e.g., latent Ru complex) and the sensitizer can be present (e.g., combined) in a mixture provided herein at a ratio of the Ru complex to the sensitizer at a ratio by moles of at least 0.001:1.0, 0.01:1.0, 0.025:1.0, 0.05:1.0, 0.075:1.0, 0.1:1.0, 0.5:1.0, 1.0:1.0, 1.5:1.0, 2.0:1.0, 3.0:1.0, 4.0:1.0, 5.0:1.0, 6.0:1.0, 7.0:1.0, 8.0:1.0, 9.0:1.0, 10:1.0, 100:1.0, 1000:1.0, or more of the Ru complex. The catalyst (e.g., latent Ru complex) and the sensitizer can be present (e.g., combined) in a mixture provided herein at a ratio of the Ru complex the sensitizer at a ratio by moles of at most 1000:1.0, 100:1.0, 10:1.0, 9.0:1.0, 8.0:1.0, 7.0:1.0, 6.0:1.0, 5.0:1.0, 6.0:1.0, 4.0:1.0, 3.0:1.0, 2.0:1.0, 1.0:1.0, 0.5:1.0, 0.1:1.0, 0.075:1.0, 0.05:1.0, 0.025:1.0, 0.01:1.0, 0.001:1.0, or less of the Ru complex. The catalyst (e.g., latent Ru complex) and the sensitizer can be present (e.g., combined) in a mixture provided herein at a ratio of the Ru complex to the sensitizer at a ratio by moles within a range defined by any two of the preceding values. The catalyst (e.g., latent Ru complex) and the sensitizer can be present (e.g., combined) in a mixture provided herein at a ratio of the Ru complex to the sensitizer at a ratio by moles from 001:1.0 to 1000:1.0. The latent Ru complex and the sensitizer may be present in the mixture at a ratio by moles of the Ru complex to the sensitizer at a ratio by moles from 0.02:1.0 to 1.0:1.0.

The catalyst (e.g., latent Ru complex) and the polymer precursor may be present (e.g., combined) in a mixture provided herein at a weight ratio of at least 0.1 parts per million (ppm) (e.g., 0.00001% by weight), 1 ppm (e.g., 0.0001% by weight), 10 ppm (e.g., 0.001% by weight), 100 ppm (e.g., 0.01% by weight), 1,000 ppm (e.g., 0.1% by weight), 10,000 ppm (e.g., 1% by weight), or more. The catalyst (e.g., latent Ru complex) and the polymer precursor may be present (e.g., combined) in a mixture provided herein at a weight ratio of at most 10,000 ppm (e.g., 1% by weight), 1,000 ppm (e.g., 0.1% by weight), 100 ppm (e.g., 0.01% by weight), 10 ppm (e.g., 0.001% by weight), 1 ppm (e.g., 0.0001% by weight), 0.1 ppm (e.g., 0.00001% by weight), or less. or more. The catalyst (e.g., latent Ru complex) and the polymer precursor may be present (e.g., combined) in a mixture provided herein at a weight ratio within a range defined by any two of the preceding values. The catalyst (e.g., latent Ru complex) and the polymer precursor may be present (e.g., combined) in a mixture provided herein at a weight ratio of at most 10% (e.g., 10,000 ppm) or less. The catalyst (e.g., latent Ru complex) and the polymer precursor may be present (e.g., combined) in a mixture provided herein at a weight ratio from 0.1 ppm to 10% (e.g., 10,000 ppm).

The catalyst may be an activated catalyst. The catalyst may be a ruthenium (Ru) catalyst or a Ru complex. The Ru complex may be an activated Ru complex. The activated Ru complex may undergo a ring opening metathesis polymerization (ROMP) reaction with the at least one polymer precursor, for example, to generate at least a portion of the polymer. The ROMP reaction may be a photoinitiated ROMP (P-ROMP) or photolithographic olefin metathesis polymerization (PLOMP)).

### Initiators:

The initiator may be a photoacid (PAH), a photoacid generator (PAG), or a combination thereof. The initiator may be a PAH or a PAG. The initiator may be a PAH. The initiator may be a PAG. The PAH, PAG, or the combination thereof may be selected from the group consisting of sulfonium salts, iodonium salts, triazines, triflates, and oxime sulfonates. The initiator may be an iodonium salt. The initiator may be (4-tert-butylphenyl)iodonium hexafluorophosphate.

The initiator may activate the latent catalyst by displacing a first bound ligand or a first coordinated ligand (e.g., of the latent Ru complex). the first bound ligand or the first coordinated ligand (e.g., of the latent Ru complex) may be displaced with a second ligand. The second ligand may derive from the initiator. The second ligand may be the initiator. A ratio of coordination or bond strength of the first ligand and the second ligand may be less than 1, or more than 1.

The initiator may be present in the mixture at a concentration of at least 1 parts per billion (ppb) (e.g. 0.0000001% by weight), 0.1 parts per million (ppm) (e.g., 0.00001% by weight), 1 ppm (e.g., 0.0001% by weight), 10 ppm (e.g., 0.001% by weight), 100 ppm (e.g., 0.01% by weight), 1,000 ppm (e.g., 0.1% by weight), 10,000 ppm (e.g., 1% by weight), 100,000 ppm (e.g., 10% by weight), 150,000 ppm (e.g., 15% by weight), 200,000 ppm (e.g., 20% by weight), or more. The initiator may be present in the mixture at a concentration of at most 200,000 ppm (e.g., 25% by weight), 150,000 ppm (e.g., 15% by weight), 100,000 ppm (e.g., 10% by weight), 10,000 ppm (e.g., 1% by weight), 1,000 ppm (e.g., 0.1% by weight), 100 ppm (e.g., 0.010% by weight), 10 ppm (e.g., 0.0010% by weight), 1 ppm (e.g., 0.00010% by weight), 0.1 ppm (e.g., 0.00001% by weight), 1 ppb (0.0000001% by weight), or less. The initiator may be present in the mixture at a concentration from about 0.1 ppm (e.g., 0.00001% by weight) to about 100,000 ppm (e.g., 10% by weight). The initiator may be present in the mixture at a concentration from about 1 ppm (e.g., 0.0001% by weight) to about 50,000 ppm (e.g., 5% by weight). The initiator may be present in the mixture at a concentration from about 1 ppm (e.g. 0.001% by weight) to about 25,000 ppm (e.g. 2.5% by weight). The initiator may be present in the mixture at a concentration within a range defined by any of the two preceding values.

The latent Ru complex and the initiator may be present in the mixture at a ratio of the Ru complex to the initiator at a ratio by moles of at least 0.00001:1.0, 0.0001:1.0, 0.001:1.0, 0.01:1.0, 0.025:1.0, 0.05:1.0, 0.075:1.0, 0.1:1.0, 0.5:1.0, 1.0:1.0, 1.5:1.0, 2.0:1.0, 3.0:1.0, 4.0:1.0, 5.0:1.0, 6.0:1.0, 7.0:1.0, 8.0:1.0, 9.0:1.0, 10:1.0, 15:1.0, 20:1.0, 25:1.0, or more of the Ru complex. The latent Ru complex and the initiator may be present in the mixture at a ratio of the Ru complex to the initiator at a ratio by moles of at most 25:1.0, 15:1.0, 10:1.0, 9.0:1.0, 8.0:1.0, 7.0:1.0, 6.0:1.0, 5.0:1.0, 6.0:1.0, 4.0:1.0, 3.0:1.0, 2.0:1.0, 1.0:1.0, 0.5:1.0, 0.1:1.0, 0.075:1.0, 0.05:1.0, 0.025:1.0, 0.01:1.0, 0.001:1.0, 0.0001:1.0, 0.00001:1.0, or less of the Ru complex. The latent Ru complex and the initiator may be present in the mixture at a ratio of the Ru complex to the initiator at a ratio by moles from 0.00001:1.0 to 10:1.0. The latent Ru complex and the initiator may be present in the mixture at a ratio of the Ru complex to the initiator at a ratio by moles from 0.02:1.0 to 1.0:1.0.

The activity of PAGs or PAHs to specific wavelengths of light may be modified by other light scattering moieties, such as, for example, sensitizers, such as 2-Isopropylthioxanthone (ITX), 1-chloro-4-propoxythioxanthone, 2,5-Bis(5-tert-butyl-benzoxazol-2-yl)thiophene, and aromatic organics such as naphthalene and perylene. Sensitizers, up-converters, down-converters, quantum dots, dyes, fluorophores or other light scattering moieties may be used to modulate the absorbance and activity of the photo-polymers described herein.

The initiator may comprise one or more iodonium ion, a sulfonium ion, a dicarboximide, a thioxanthone, or an oxime. The initiator may comprise an iodonium ion, a sulfonium ion, a dicarboximide, a thioxanthone, or an oxime. The initiator may be an iodonium salt, a sulfonium salt, a dicarboximide, a thioxanthone, or an oxime. The initiator may be an iodonium salt, a sulfonium salt, or a dicarboximide. The initiator may be an iodonium salt. The initiator may be an sulfonium salt. The initiator may be dicarboximide.

The initiator may be a salt. The initiator may be a salt comprising one or more counterion. The initiator may be a sulfonium salt comprising one or more counterion. The initiator may be an iodonium salt comprising one or more counterion. The counter ion may be selected from the group consisting of a sulfate, sulfonate, antimonate, triflate, nonaflate, borate, carboxylate, phosphate, fluoride, chloride, bromide, iodide, antimonide, and boride. The counter ion may be selected from the group consisting of a sulfate, a phosphate, a fluoride, a chloride, a bromide, an iodide, an antimonate, a boride, a carboxide, a triflate, and a nonaflate.

The initiator may be a compound having a structure of Formula (I):

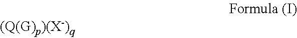

wherein:
   Q is sulfur (S), S*, or iodine (I′);
   each G is independently optionally substituted alkyl, optionally substituted cycloalkyl, optionally substituted heterocycloalkyl, optionally substituted aryl, or optionally substituted heteroaryl;
   each X is independently a counter ion;
   p is 2 or 3; and
   q is 1 or 2.

In some embodiments, Q is S⁺.

In some embodiments, p is 3 and q is 1.

In some embodiments, each G is independently optionally substituted alkyl or optionally substituted aryl. In some embodiments, each G is independently optionally substituted aryl. In some embodiments, each G is independently substituted phenyl. In some embodiments, each G is independently substituted phenyl, wherein each phenyl is independently substituted with one or more substituent, wherein the one or more substituent is independently C₁-C₆ alkyl. In some embodiments, each G is independently phenyl or C₁-C₆ alkyl In some embodiments, C₁-C₆ alkyl is selected from the group consisting of methyl, ethyl, propyl, isopropyl, butyl, tert-butyl, and sec-butyl. In some embodiments, G is phenyl.

In some embodiments, Q is S.

In some embodiments, p is 2 and q is 2.

In some embodiments, each G is independently optionally substituted alkyl or optionally substituted aryl. In some embodiments, each G is independently substituted aryl with one or more substituent, wherein the one or more substituent is further optionally substituted. In some embodiments, one or more substituent is S⁺(G¹)(G²), wherein G¹ and G² are each independently optionally substituted alkyl or optionally substituted aryl. In some embodiments, G¹ and G² are each phenyl.

In some embodiments, Q is I⁺.

In some embodiments, p is 2 and q is 1.

In some embodiments, each G is independently optionally substituted heterocycloalkyl, optionally substituted aryl, or optionally substituted heteroaryl.

In some embodiments, each G is independently optionally substituted heterocycloalkyl or optionally substituted aryl. In some embodiments, each G is independently optionally substituted heteroaryl or optionally substituted aryl. In some embodiments, the optionally substituted heterocycloalkyl is a C₇-C₁₅ heterocycloalkyl. In some embodiments, the optionally substituted heterocycloalkyl is a substituted coumarin. In some embodiments, the substituted coumarin is substituted with one or more substituent, each substituent selected from the group consisting of halogen, C₁-C₆ alkyl, C₁-C₆ heteroalkyl, and C₁-C₆ alkoxy. In some embodiments, the substituted coumarin is substituted with one or more substituent, each substituent selected from the group consisting of C₁-C₆ alkyl and C₁-C₆ alkoxy. In some embodiments, the substituted coumarin is substituted with one or more substituent, each substituent selected from the group consisting of methyl, ethyl, propyl, isopropyl, tert-butyl, methoxy, ethoxy, propoxy, isopropoxy, and isobutoxy. In some embodiments, each G is independently substituted phenyl. In some embodiments, each G is phenyl. In some embodiments, each G is independently phenyl or a coumarin substituted with one or more substituent, each substituent selected from the group consisting of methyl, ethyl, propyl, isopropyl, tert-butyl, methoxy, ethoxy, propoxy, isopropoxy, and isobutoxy.

In some embodiments, the optionally substituted aryl is substituted with an optionally substituted dicarboxyimide. In some embodiments, the dicarboxyimide is attached to the optionally substituted aryl via the N atom of the optionally substituted dicarboxyimide. In some embodiments, the dicarboxyimide is substituted with one or more substituent. In some embodiments, the dicarboxyimide is a C₇-C₁₅ heterocycloalkyl. In some embodiments, the C₇-C₁₅ heterocycloalkyl is substituted with one or more substituent, each substituent selected from the group consisting of halogen, C₁-C₆ alkyl, C₁-C₆ heteroalkyl, and C₁-C₆ alkoxy. In some embodiments, the C₇-C₁₅ heterocycloalkyl is substituted with a halogen. In some embodiments, each G is independently phenyl or a dicarboxyimide substituted with a halogen.

In some embodiments, each G is independently phenyl or a C₇-C₁₅ heterocycloalkyl is substituted with one or more substituent, each substituent selected from the group consisting of halogen, C₁-C₆ alkyl, C₁-C₆ heteroalkyl, and C₁-C₆ alkoxy.

In some embodiments, each G is independently optionally substituted aryl. In some embodiments, each G is independently substituted phenyl. In some embodiments, each G is independently substituted phenyl. In some embodiments, each phenyl is independently substituted with one or more substituent. In some embodiments, the one or more substituent is independently C₁-C₁₅ alkyl. In some embodiments, the one or more substituent is independently C₁-C₆ alkyl. In some embodiments, each G is phenyl.

In some embodiments, each X is independently selected from the group consisting of a sulfate, sulfonate, antimonate, triflate, nonaflate, borate, carboxylate, phosphate, fluoride, chloride, bromide, iodide, antimonide, and boride.

In some embodiments, each X is independently selected from the group consisting of:

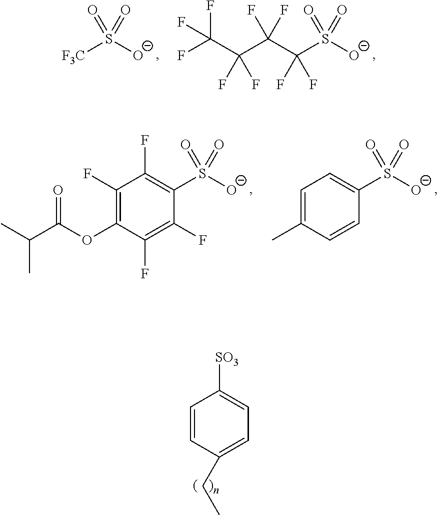

(wherein n is 0-20),

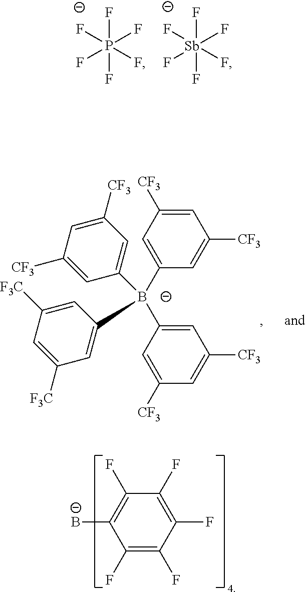

In some embodiments, the initiator is a compound selected from the group consisting of:

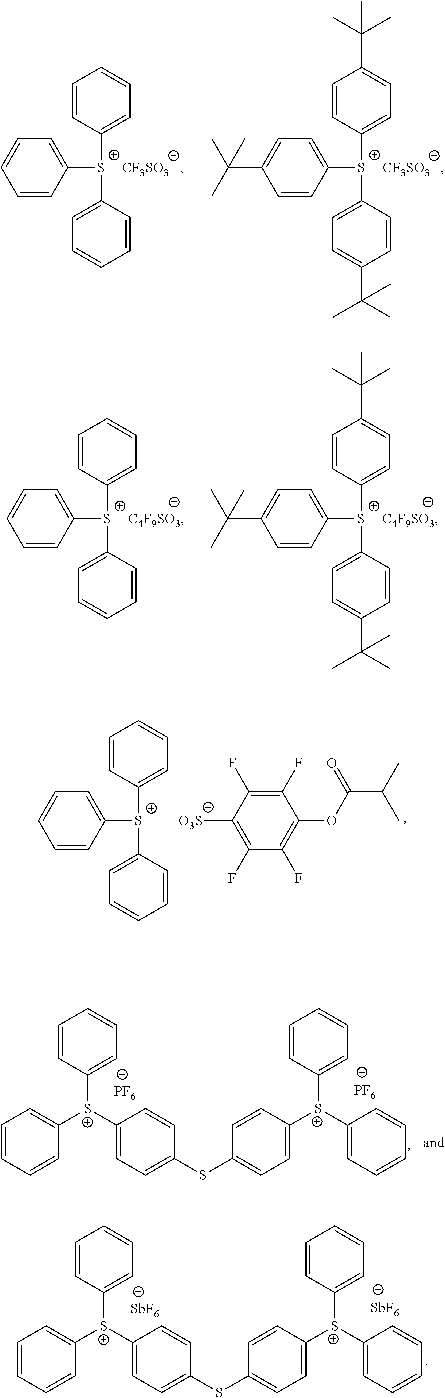

In some embodiments, the initiator is a compound selected from the group consisting of:

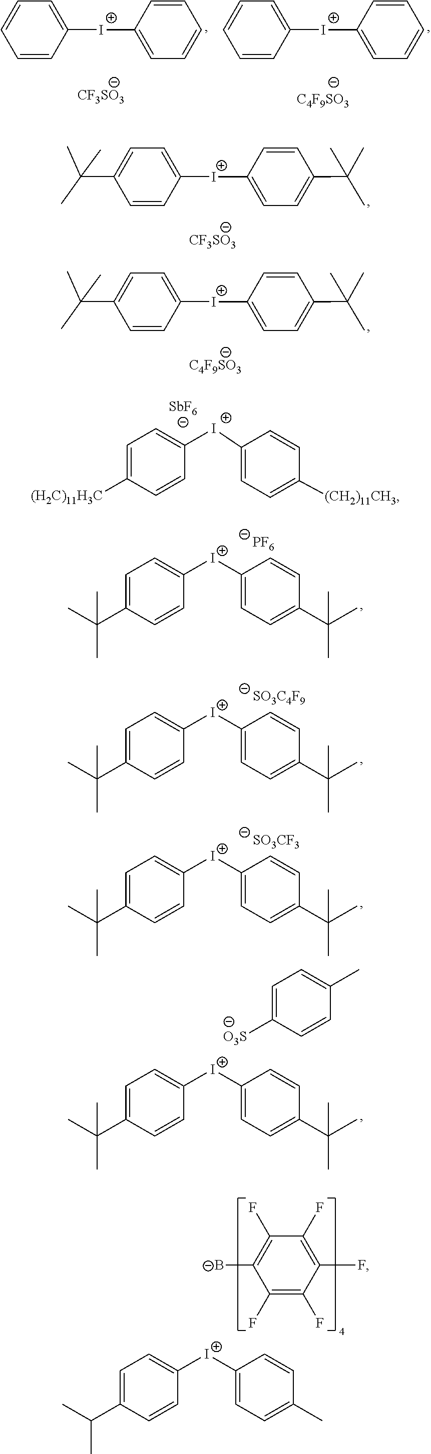

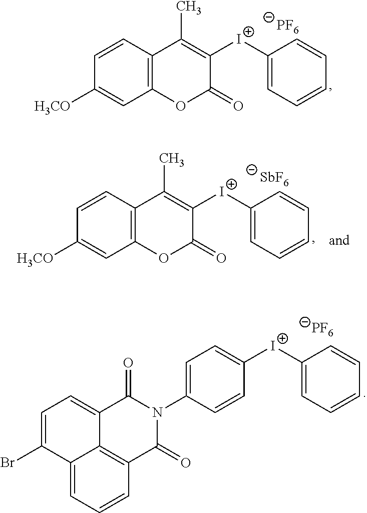

In some embodiments, the initiator is a substituted dicarboxyimide. In some embodiments, the initiator comprises one or more substituted dicarboxyimides. In some embodiments, the initiator comprises two substituted dicarboxyimides. In some embodiments, the two dicarboxyimides are commonly coupled to an optionally substituted phenyl.

In some embodiments, the dicarboxyamide is a C₇-C₁₅ heterocycloalkyl. In some embodiments, the substituted dicarboxyimide is substituted (e.g., N-substituted) with one or more substituted sulfonate. In some embodiments, the one or more substituted sulfonate is substituted with optionally substituted phenyl or C₁-C₆ haloalkyl. In some embodiments, the one or more substituted sulfonate is substituted with phenyl substituted with one or more substituent, each substituent independently selected from the group consisting of C₁-C₆ alkyl and C₁-C₆ fluoroalkyl. In some embodiments, the one or more substituted sulfonate is substituted with toluenyl. In some embodiments, the C₁-C₆ haloalkyl is a C₁-C₆ fluoroalkyl. In some embodiments, the C₁-C₆ fluoroalkyl is —CF₃ or —C₄F₉.

In some embodiments, the substituted dicarboxyimide is selected from the group consisting of a substituted 3a,4,7,7a-tetrahydro-1H-4,7-methanoisoindole-1,3(2H)-dione, a substituted 1H-benzo[de]isoquinoline-1,3(2H)-dione, and a thiochromeno[2,3-e]isoindole-1,3,6(2H)-trione.

In some embodiments, the initiator is a compound selected from the group consisting of:

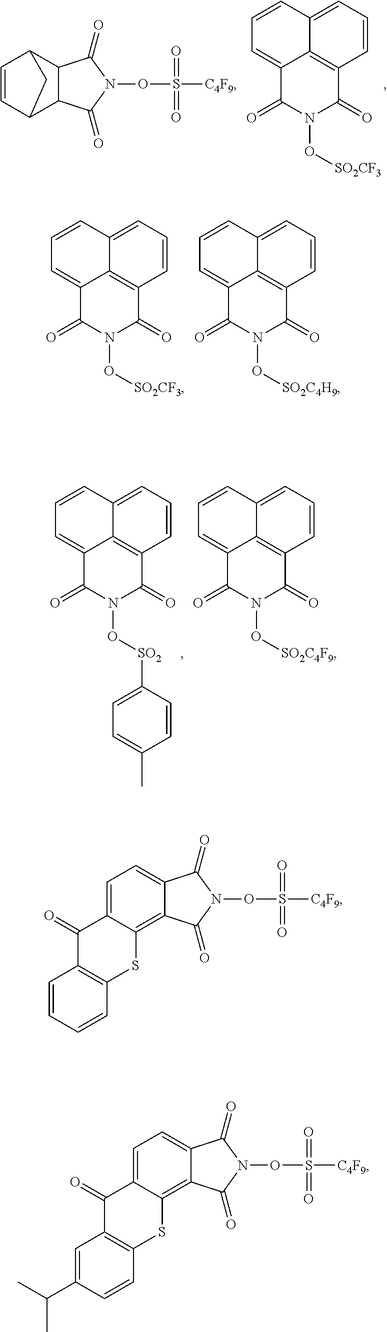

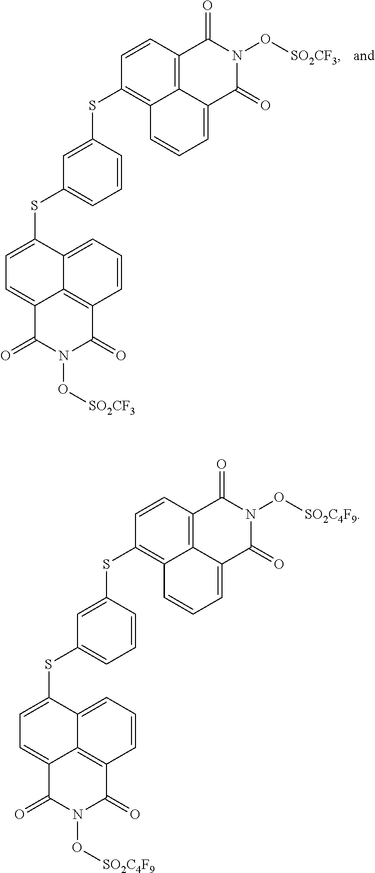

In some embodiments, the initiator is a substituted thioxanthone. In some embodiments, the substituted thioxanthone is a C₇-C₁₅ heterocycloalkyl. In some embodiments, the substituted thioxanthone is substituted with one or more substituted sulfonate. In some embodiments, the one or more substituted sulfonate is substituted with optionally substituted phenyl or C₁-C₆ haloalkyl. In some embodiments, the one or more substituted sulfonate is substituted with phenyl substituted with one or more substituent, each substituent independently selected from the group consisting of C₁-C₆ alkyl and C₁-C₆ fluoroalkyl. In some embodiments, the one or more substituted sulfonate is substituted with toluenyl. In some embodiments, the C₁-C₆ haloalkyl is a C₁-C₆ fluoroalkyl. In some embodiments, the C₁-C₆ fluoroalkyl is —CF₃, —C₄F₉, or —C₈F₁₇.

In some embodiments, the initiator is a substituted oxime. In some embodiments, the substituted oxime is a C₇-C₁₅ heteroaryl. In some embodiments, the substituted oxime is substituted with one or more substituted sulfonate. In some embodiments, the one or more substituted sulfonate is substituted with optionally substituted phenyl or C₁-C₆ haloalkyl. In some embodiments, the one or more substituted sulfonate is substituted with phenyl substituted with one or more substituent, each substituent independently selected from the group consisting of halogen, C₁-C₆ alkyl, and C₁-C₆ fluoroalkyl. In some embodiments, the one or more substituted sulfonate is substituted with toluenyl. In some embodiments, the C₁-C₆ haloalkyl is a C₁-C₆ fluoroalkyl. In some embodiments, the C₁-C₆ fluoroalkyl is —CF₃, —C₄F₉, or —C₈F₁₇.

In some embodiments, the substituted oxime is selected from the group consisting of an optionally substituted fluoren-9-one oxime, an optionally substituted thioxanthen-9-one oxime, and an optionally substituted thiophenylidene.

In some embodiments, the initiator is a compound selected from the group consisting of.

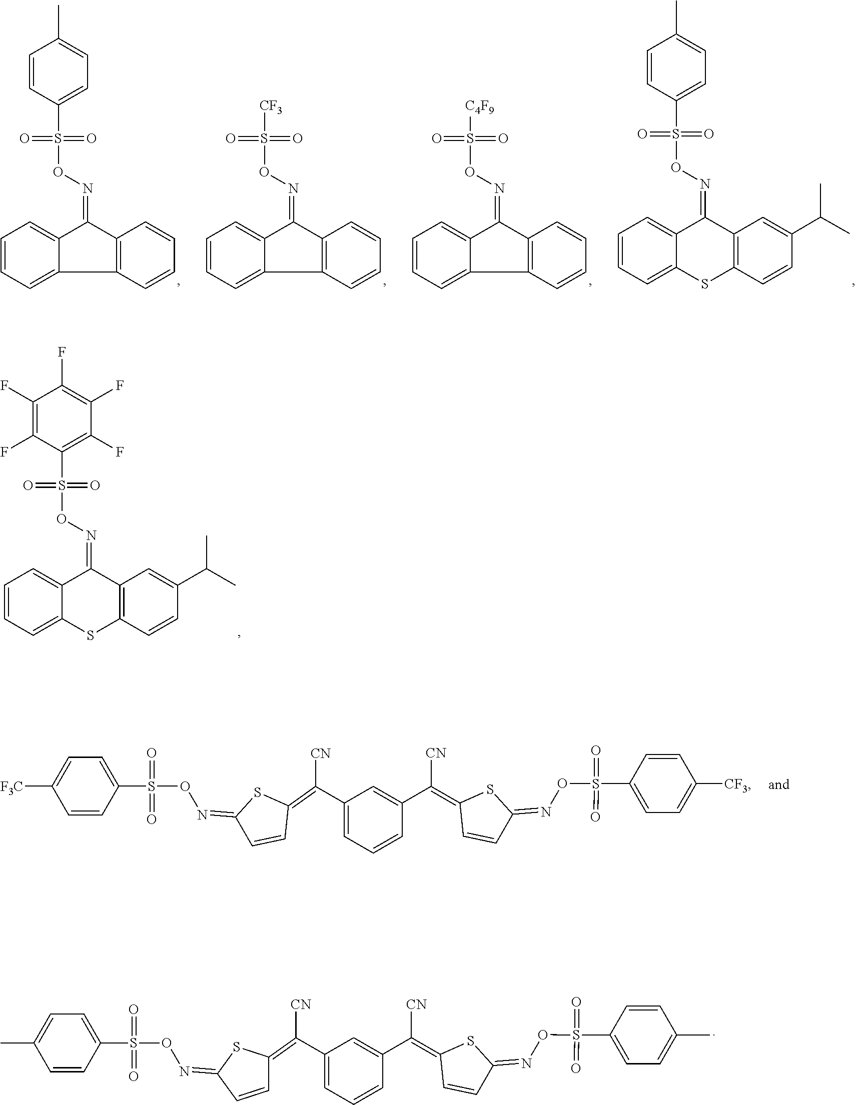

In some embodiments, a mixture described herein comprises any initiator described in any of International Publication Number WO 2014/055720, U.S. Pat. No. 9,207,532, European Patent Number 2,903,996, International Publication Number WO 2015/065649, U.S. Patent Publication Number 2015/118188, European Patent Publication Number 3,063,592, International Publication Number WO 2018/045132, U.S. Patent Publication Number 2018/067393, U.S. Patent Publication Number 2020/183276, European Patent Publication Number 3,507,007, International Publication Number WO 2020/006345, Photolithographic Olefin Metathesis Polymerization, J. Am. Chem. Soc. 2013, 135, 16817-16820, Visible-Light-Controlled Ruthenium-Catalyzed Olefin Metathesis, J. Am. Chem. Soc. 2019, 141, 17, 6791-6796, A Tandem Approach to Photoactivated Olefin Metathesis: Combining a Photoacid Generator with an Acid Activated Catalyst, J. Am. Chem. Soc. 2009, 131, 6, 2038-2039, Metal-Free Ring-Opening Metathesis Polymerization, J. Am. Chem. Soc. 2015, 137, 1400-1403, JOURNAL OF POLYMER SCIENCE, PART A: POLYMER CHEMISTRY 2019, 57, 1791-17, each of which is incorporated herein by reference, in their entirety, in particular for the compounds provided therein.

The initiator can be present (e.g., combined) in a mixture provided herein at a concentration of at least 0.1 parts per million (ppm) (e.g., 0.00001% by weight), 1 ppm (e.g., 0.0001% by weight), 10 ppm (e.g., 0.001% by weight), 100 ppm (e.g., 0.01% by weight), 1,000 ppm (e.g., 0.1% by weight), 10,000 ppm (e.g., 1% by weight), 100,000 ppm (e.g., 10% by weight), or more. The initiator can be present (e.g., combined) in a mixture provided herein at a concentration of at most 100,000 ppm (e.g., 10% by weight), 10,000 ppm (e.g., 1% by weight), 1,000 ppm (e.g., 0.1% by weight), 100 ppm (e.g., 0.01% by weight), 10 ppm (e.g., 0.001% by weight), 1 ppm (e.g., 0.0001% by weight), 0.1 ppm (e.g., 0.00001% by weight), or less. The initiator can be present (e.g., combined) in a mixture provided herein at a concentration within a range defined by any two of the preceding values. The initiator can be present (e.g., combined) in a mixture provided herein at a concentration from about 0.1 ppm (e.g., 0.000010% by weight) to about 100,000 ppm (e.g., 10% by weight). The initiator may be present in the mixture at a concentration from about 1 ppm (e.g., 0.0001% by weight) to about 50,000 ppm (e.g., 5% by weight).

The initiator and the sensitizer can be present (e.g., combined) in a mixture provided herein at a molar ratio of at least 1:1000, 1:500, 1:100, 1:50, 1:40, 1:30, 1:20, 1:10, 1:5, 1:1, 5:1, 10:1, 20:1, 30:1, 40:1, 50:1, 100:1, 500:1, 1000:1, or more of the initiator to the sensitizer. The initiator and the sensitizer can be present (e.g., combined) in a mixture provided herein at a molar ratio of at most 1000:1, 500:1, 100:1, 50:1, 40:1, 30:1, 20:1, 10:1, 5:1, 1:1, 1:5, 1:10, 1:20, 1:30, 1:40, 1:50, 1:100, 1:500, 1:1000, or less of the initiator to the sensitizer. The initiator and the sensitizer can be present (e.g., combined) in a mixture provided herein at a molar ratio within a range defined by any two of the preceding values. The initiator and the sensitizer can be present (e.g., combined) in a mixture provided herein at a molar ratio from 1000:1 initiator to sensitizer to 1:1000 initiator to sensitizer. The initiator and the sensitizer can be present (e.g., combined) in a mixture provided herein at a molar ratio from 10:1 initiator to sensitizer to 1:10 initiator to sensitizer.

The initiator and the polymer precursor can be present (e.g., combined) in a mixture provided herein at a molar ratio of at least 1:10,000,000, 1:1,000,000, 1:500,000, 1:100,000, 1:50,000, 1:10,000, 1:5,000, 1:1,000, 1:500, 1:100, 1:50, 1:30, 1:20, 1:10, 1:1, or more of the initiator to the polymer precursor. The initiator and the polymer precursor can be present (e.g., combined) in a mixture provided herein at a molar ratio of at most 1:1, 1:10, 1:20, 1:30, 1:50, 1:100, 1:500, 1:1,000, 1:5,000, 1:10,000, 1:50,000, 1:100,000, 1:500,000, 1:1,000,000, 1:10,000,000, or less of the initiator to the polymer precursor. The initiator and the polymer precursor can be present (e.g., combined) in a mixture provided herein at a molar ratio within a range defined by any two of the preceding values. The initiator and the polymer precursor can be present (e.g., combined) in a mixture provided herein at a molar ratio from 1:1 initiator to the polymer precursor to 1:10,000,000 initiator to the polymer precursor. The initiator and the polymer precursor can be present (e.g., combined) in a mixture provided herein at a molar ratio from 1:20 initiator to polymer precursor to 1:100,000 initiator to the polymer precursor.

### Sensitizers:

The mixtures described herein may comprise a sensitizer. The sensitizer may be configured to transfer or disperse the energy of electromagnetic radiation. The sensitizer may stabilize or sensitize the initiator. In some embodiments, the sensitizer is configured to scatter electromagnetic radiation, thereby sensitizing the initiator. In some embodiments, the sensitizer is configured to scatter ambient electromagnetic radiation, thereby sensitizing the initiator. In some embodiments, the sensitizer is configured to scatter electromagnetic radiation having a wavelength from 200 to 2000 nanometers, thereby sensitizing the initiator. The sensitizer may be configured to disperse, transfer, or convert the energy of electromagnetic radiation such that the initiator is activated at a particular wavelength range, such as, for example, from about 350 nanometers (nm) to about 465 nm.

The electromagnetic radiation may have a wavelength of at least 1 nanometer (nm) 10 nm, 50 nm, 100 nm, 500 nm, 1,000 nm, 2,000 nm, 3,000 nm, 4,000 nm, 5,000 nm, 10,000 nm, 15,000 nm, 25,000 nm, 50,000 nm, 75,000 nm, 100,000 nm, 200,000 nm, 300,000 nm, 400,000 nm, 500,000 nm, 600,000 nm, 700,000 nm, 800,000 nm, 900,000 nm, 1,000,000 nm, 2,000,000 nm, 3,000,000 nm, 4,000,000 nm, 5,000,000 nm, 10,000,000 nm, or more. The electromagnetic radiation may have a wavelength of at most 10,000,000 nm, 5,000,000 nm, 4,000,000 nm, 3,000,000 nm, 2,000,000 nm, 1,000,000 nm, 900,000 nm, 800,000 nm, 700,000 nm, 600,000 nm, 500,000 nm, 400,000 nm, 300,000 nm, 200,000 nm, 100,000 nm, 75,000 nm, 50,000 nm, 25,000 nm, 15,000 nm, 10,000 nm, 5,000 nm, 4,000 nm, 3,000 nm, 2,000 nm, 1,000 nm, 500 nm, 100 nm, 50 nm, 10 nm, 1 nm, or less. The electromagnetic radiation may have a wavelength within a range defined by any two of the preceding values. The electromagnetic radiation may have a wavelength from 300 nm to 3,000 nm. The electromagnetic radiation may have a wavelength from about 350 nm to about 465 nm.

The sensitizer may be a conjugated aromatic molecule (e.g. a naphthalene, an anthracene, a perylene, or an acene), a phenothiazine (e.g., or a derivative thereof), a thioxanthone (e.g., or a derivative thereof), a camphorquinone, an aminoketone, a benzophenone, a metal complex (e.g., Titanium), an aminobenzoate, a coumarin (e.g., a derivative thereof), an indoline, a porphyrin, a rhodamine, a pyrylium, a phenazine, a phenoxazine, an alpha hydroxy ketone, or a phosphine oxide. The sensitizer may be a conjugated aromatic molecule (e.g. a naphthalene, a perylene, or an acene), a phenothiazine (e.g., or a derivative thereof), a thioxanthone (e.g., or a derivative thereof), a coumarin (e.g., a derivative thereof), an indoline, a porphyrin, a rhodamine, a pyrylium, a phenazine, a phenoxazine, an alpha hydroxy ketone, or a phosphine oxide. The sensitizer may be a phenothiazine, a thioxanthone, a coumarin (e.g., a derivative thereof, an alpha hydroxy ketone, or a phosphine oxide. The sensitizer may be a thioxanthone.

In some embodiments, the sensitizer is selected from the group consisting of:

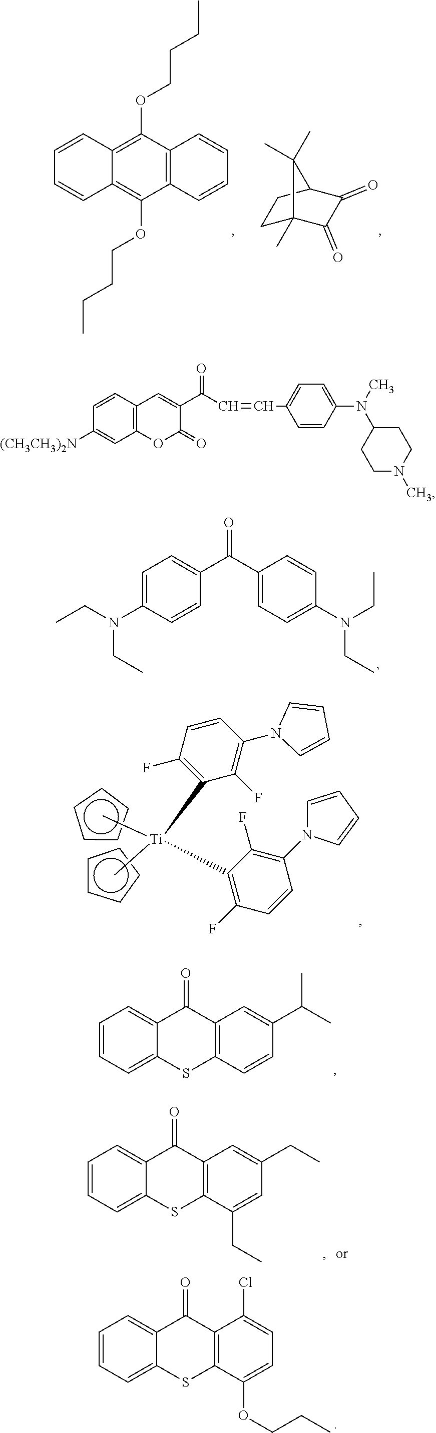

In some embodiments, the sensitizer is selected from the group consisting of:

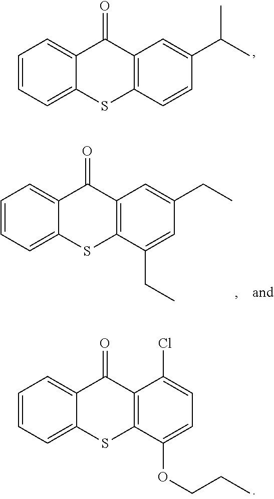

In some embodiments, the sensitizer is 2-Isopropylthioxanthone (ITX).

The sensitizer can be present (e.g., combined) in a mixture provided herein at a concentration of at least 0.1 parts per million (ppm) (e.g., 0.00001% by weight), 1 ppm (e.g., 0.0001% by weight), 10 ppm (e.g., 0.001% by weight), 100 ppm (e.g., 0.01% by weight), 1,000 ppm (e.g., 0.1% by weight), 10,000 ppm (e.g., 1% by weight), 50,000 ppm (e.g., 5% by weight), 100,000 ppm (e.g., 10% by weight), 150,000 ppm (e.g., 15% by weight), 200,000 ppm (e.g., 20% by weight), or more. The sensitizer can be present (e.g., combined) in a mixture provided herein at a concentration of at most 200,000 ppm (e.g., 20% by weight), 150,000 ppm (e.g., 15% by weight), 100,000 ppm (e.g., 10% by weight), 50,000 ppm (e.g., 5% by weight), 10,000 ppm (e.g., 1% by weight), 1,000 ppm (e.g., 0.1% by weight), 100 ppm (e.g., 0.01% by weight), 10 ppm (e.g., 0.001% by weight), 1 ppm (e.g., 0.0001% by weight), 0.1 ppm (e.g., 0.00001% by weight), or less. The sensitizer can be present (e.g., combined) in a mixture provided herein at a concentration within a range defined by any two of the preceding values. The sensitizer can be present (e.g., combined) in a mixture provided herein at a concentration from about 0.1 ppm (e.g., 0.00001% by weight) to about 200,000 ppm (e.g., 20% by weight). The sensitizer can be present (e.g., combined) in a mixture provided herein at a concentration from about 1 ppm (e.g., 0.00001% by weight) to about 20,000 ppm (e.g., 2% by weight).

The sensitizer and the polymer precursor can be present (e.g., combined) in a mixture provided herein at a weight ratio of at least 0.1 parts per million (ppm) (e.g., 0.00001% by weight), 1 ppm (e.g., 0.0001% by weight), 10 ppm (e.g., 0.001% by weight), 100 ppm (e.g., 0.01% by weight), 1,000 ppm (e.g., 0.1% by weight), 10,000 ppm (e.g., 1% by weight), 50,000 ppm (e.g., 5% by weight), 100,000 ppm (e.g., 10% by weight), 150,000 ppm (e.g., 15% by weight), 200,000 ppm (e.g., 20% by weight), or more. The sensitizer and the polymer precursor can be present (e.g., combined) in a mixture provided herein at a weight ratio of at most 200,000 ppm (e.g., 20% by weight), 150,000 ppm (e.g., 15% by weight), 100,000 ppm (e.g., 10% by weight), 50,000 ppm (e.g., 5% by weight), 10,000 ppm (e.g., 1% by weight), 1,000 ppm (e.g., 0.10% by weight), 100 ppm (e.g., 0.010% by weight), 10 ppm (e.g., 0.0010% by weight), 1 ppm (e.g., 0.0001% by weight), 0.1 ppm (e.g., 0.00001% by weight), or less. The sensitizer and the polymer precursor can be present (e.g., combined) in a mixture provided herein at a weight ratio from 0.1 ppm to 200,000 ppm (e.g., 20% by weight). The sensitizer and the polymer precursor can be present (e.g., combined) in a mixture provided herein at a weight ratio from 1 ppm to 20,000 ppm (e.g., 2% by weight). The sensitizer and the polymer precursor can be present (e.g., combined) in a mixture provided herein at a weight ratio of 0.1 parts per million (ppm) (e.g., 0.00001% by weight), 1 ppm (e.g., 0.0001% by weight), 10 ppm (e.g., 0.001% by weight), 100 ppm (e.g., 0.01% by weight), 1,000 ppm (e.g., 0.1% by weight), 10,000 ppm (e.g., 1% by weight), 50,000 ppm (e.g., 5% by weight), 100,000 ppm (e.g., 10% by weight), 150,000 ppm (e.g., 15% by weight), 200,000 ppm (e.g., 20% by weight), or a range between any two of the foregoing values (inclusive).

### Polymer Precursors:

Mixtures used in the present methods described herein may comprise at least one polymer precursor. The at least one polymer precursor may comprise a monomer. The at least one polymer precursor may comprise at least one olefin. The at least one olefin may be a cyclic olefin. The at least one olefin may be a norbornane-based olefin. Monomers may be, for example, norbornene, dicyclopentadiene, tricyclopentadiene, cyclooctene, cyclooctadiene, and alkyl norbornenes such as octylnorbornene. The cyclic olefin may be dicyclopentadiene or tricyclopentadiene. Higher molecular weight monomers include, for example, end-functionalized or side-chain functionalized polymers or oligomers or crosslinkers containing a metathesis-active end-group.

The polymer precursor may be selected from the group consisting of a dicyclopentadiene, norbornene, aliphatic olefin, cyclooctene, cyclooctadiene, tricyclopentadiene, polybutadiene, an ethylene propylene diene monomer (EPDM) rubber, a polypropylene, a polyethylene, a cyclic olefin polymer (e.g., a cyclic olefin copolymer), and a diimide.

The dicyclopentadiene may be a poly(dicyclopentadiene). The poly(dicyclopentadiene) may be selected from the group consisting of a linear poly(dicyclopentadiene), a branched (e.g., hyperbranched) poly(dicyclopentadiene), a crosslinked poly(dicyclopentadiene), an oligomeric poly(dicyclopentadiene), or a polymeric poly(dicyclopentadiene).

The norbornene may be selected from the group consisting of an alkyl norbornene (e.g., ethylidene norbornene), a norbornene diimide, and a multifunctional norbornene crosslinker (e.g. di-norbornene, tri-norbornene).

Olefinic precursors may be used in tandem with the alkynes (e.g., employed as part of the feedstock mixtures or in sequential processing of the product polymers). Strained ring systems may be beneficial for ROMP reactions. The olefinic precursor may be substituted or unsubstituted cyclooctatetraenes (e.g., cyclooctatetraene).

A polymer precursor provided herein may comprise a ring systems (e.g., strained ring systems). Such cyclic olefins may be optionally substituted, optionally heteroatom-containing, mono-unsaturated, di-unsaturated, or poly-unsaturated C₅ to C₂₄ hydrocarbons that may be mono-, di-, or poly-cyclic. The cyclic olefin may be a strained or unstrained cyclic olefin.

A cyclic polymer precursor provided herein may be represented by the structure of formula (A)

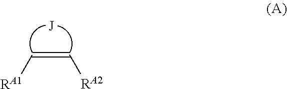

wherein:
   R^{A1} and R^{A2} is selected independently from the group consisting of hydrogen, hydrocarbyl (e.g., C₁-C₂₀ alkyl, C₅-C₂₀ aryl, C₅-C₃₀ aralkyl, or C₅-C₃₀ alkaryl), substituted hydrocarbyl (e.g., substituted C₁-C₂₀ alkyl, C₅-C₂₀ aryl, C₅-C₃₀ aralkyl, or C₅-C₃₀ alkaryl), heteroatom-containing hydrocarbyl (e.g., C₁-C₂₀ heteroalkyl, C₅-C₂₀ heteroaryl, heteroatom-containing C₅-C₃₀ aralkyl, or heteroatom-containing C₅-C₃₀ alkaryl), and substituted heteroatom-containing hydrocarbyl (e.g., substituted C₁-C₂₀ heteroalkyl, C₅-C₂₀ heteroaryl, heteroatom-containing C₅-C₃₀ aralkyl, or heteroatom-containing C₅-C₃₀ alkaryl).
   J is a saturated or unsaturated hydrocarbylene, substituted hydrocarbylene, heteroatom-containing hydrocarbylene, or substituted heteroatom-containing hydrocarbylene linkage.

Mono-unsaturated cyclic olefins encompassed by structure (A) may be represented by the structure (B):

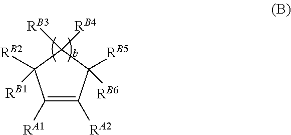

wherein:
   b is an integer the range of 1 to 10 (e.g., 1 to 5),
   R^{A1} and R^{A2} are as defined above for structure (A), and R^{B1}, R^{B2}, R^{B3}, R^{B4}, R^{B5}, and R^{B6} are independently selected from the group consisting of hydrogen, hydrocarbyl, substituted hydrocarbyl, heteroatom-containing hydrocarbyl, substituted heteroatom-containing hydrocarbyl and —(Z*)ₙ-Fn where n, Z* and Fn are as defined hereinabove, and wherein if any of the R^{B1} through R^{B6} moieties is substituted hydrocarbyl or substituted heteroatom-containing hydrocarbyl, the substituents may include one or more —(Z*)ₙ-Fn groups. Accordingly, R^{B1}, R^{B2}, R^{B3}, R^{B4}, R^{B5}, and R^{B6} may be, for example, hydrogen, hydroxyl, C₁-C₂₀ alkyl, C₅-C₂₀ aryl, C₁-C₂₀ alkoxy, C₅-C₂₀ aryloxy, C₂-C₂₀ alkoxycarbonyl, C₅-C₂₀ aryloxycarbonyl, amino, amido, nitro, etc.

Furthermore, any of the R^{B1}, R^{B2}, R^{B3}, R^{B4}, R^{B5}, and R^{B6} moieties can be linked to any of the other R^{B1}, R^{B2}, R^{B3}, R^{B4}, R^{B5}, and R^{B6} moieties to provide a substituted or unsubstituted alicyclic group containing 4 to 30 ring carbon atoms or a substituted or unsubstituted aryl group containing 6 to 18 ring carbon atoms or combinations thereof and the linkage may include heteroatoms or functional groups, e.g. the linkage may include without limitation an ether, ester, thioether, amino, alkylamino, imino, or anhydride moiety. The alicyclic group can be monocyclic, bicyclic, or polycyclic. The cyclic group can contain monounsaturation or multiunsaturation. The rings may contain monosubstitution or multisubstitution, wherein the substituents may be independently selected from hydrogen, hydrocarbyl, substituted hydrocarbyl, heteroatom-containing hydrocarbyl, substituted heteroatom-containing hydrocarbyl, —(Z*)ₙ-Fn where n is zero or 1, Z* and Fn are as defined hereinabove, and functional groups (Fn) provided above.

Examples of mono-unsaturated, monocyclic olefins encompassed by structure (B) include, without limitation, cyclopentene, cyclohexene, cycloheptene, cyclooctene, cyclononene, cyclodecene, cycloundecene, cyclododecene, tricyclodecene, tetracyclodecene, octacyclodecene, and cycloeicosene, and substituted versions thereof such as 1-methylcyclopentene, 1-ethylcyclopentene, 1-isopropylcyclohexene, 1-chloropentene, 1-fluorocyclopentene, 4-methylcyclopentene, 4-methoxy-cyclopentene, 4-ethoxy-cyclopentene, cyclopent-3-ene-thiol, cyclopent-3-ene, 4-methylsulfanyl-cyclopentene, 3-methylcyclohexene, 1-methylcyclooctene, 1,5-dimethylcyclooctene, etc.

Monocyclic diene reactants encompassed by structure (A) may be generally represented by the structure (C):

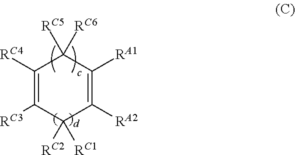

wherein:
   c and d are independently integers in the range of 1 to about 8 (e.g., 2 to 4, such as 2 (such that the reactant is a cyclooctadiene)),
   R^{A1} and R^{A2} are as defined above for structure (A), and
   R^{C1}, R^{C2}, R^{C3}, R^{C4}, R^{C5}, and R^{C6} are defined as for R^{B1} through R^{B6}.

In this case, it may be preferred that R^{C3} and R^{C4} be non-hydrogen substituents, in which case the second olefinic moiety is tetrasubstituted. Examples of monocyclic diene reactants include, without limitation, 1,3-cyclopentadiene, 1,3-cyclohexadiene, 1,4-cyclohexadiene, 5-ethyl-1,3-cyclohexadiene, 1,3-cycloheptadiene, cyclohexadiene, 1,5-cyclooctadiene, 1,3-cyclooctadiene, and substituted analogs thereof. Triene reactants may be analogous to the diene structure (C), and can contain at least one methylene linkage between any two olefinic segments.

Bicyclic and polycyclic olefins encompassed by structure (A) may be generally represented by the structure (D):

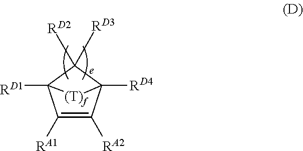

wherein:
   R^{A1} and R^{A2} are as defined above for structure (A),
   R^{D1}, R^{D2}, R^{D3}, and R^{D4} are as defined for R^{B1} through R^{B6},
   e is an integer in the range of 1 to 8 (e.g., 2 to 4)
   f is 1 or 2;
   T is lower alkylene or alkenylene (generally substituted or unsubstituted methyl or ethyl),
   CHR^{G1}, C(R^{G1})₂, O, S, N—R^{G1}, P—R^{G1}, OP—R^{G1}, Si(R^{G1})₂, B—R^{G1}, or As—R^{G1} where R^{G1} is alkyl, alkenyl, cycloalkyl, cycloalkenyl, aryl, alkaryl, aralkyl, or alkoxy.

Furthermore, any of the R^{D1}, R^{D2}, R^{D3}, and R^{D4} moieties can be linked to any of the other R^{D1}, R^{D2}, R^{D3} and R^{D4} moieties to provide a substituted or unsubstituted alicyclic group containing 4 to 30 ring carbon atoms or a substituted or unsubstituted aryl group containing 6 to 18 ring carbon atoms or combinations thereof and the linkage may include heteroatoms or functional groups, e.g. the linkage may include without limitation an ether, ester, thioether, amino, alkylamino, imino, or anhydride moiety. The cyclic group can be monocyclic, bicyclic, or polycyclic. The cyclic group can contain mono-unsaturation or multi-unsaturation. The ring may contain mono-substitution or multi-substitution, wherein the substituents are independently selected from hydrogen, hydrocarbyl, substituted hydrocarbyl, heteroatom-containing hydrocarbyl, substituted heteroatom-containing hydrocarbyl, —(Z*)ₙ-Fn where n is zero or 1, Z* and Fn are as defined hereinabove, and functional groups (Fn) provided above.

Cyclic olefins encompassed by structure (D) may be in the norbornene family. A norbornene may include at least one norbornene or substituted norbornene moiety, including without limitation norbornene, substituted norbornene(s), norbornadiene, substituted norbornadiene(s), polycyclic norbornenes, and substituted polycyclic norbornene(s).

Norbornenes may be generally represented by the structure (E):

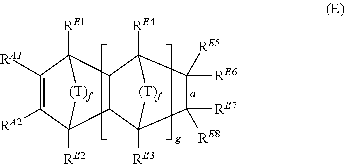

wherein:
   R^{A1} and R^{A2} are as defined above for structure (A),
   T is as defined above for structure (D),
   R^{E1}, R^{E2}, R^{E3}, R^{E4}, R^{E5}, R^{E6}, R^{E7}, and R^{E8} are as defined for R^{B1} through R^{B6}, and
   “a” represents a single bond or a double bond,
   f is 1 or 2,
   “g” is an integer from 0 to 5, and when “a” is a double bond one of R^{E5}, R^{E6} and one of R^{E7}, R^{E8} is not present.

Furthermore, any of the R^{E5}, R^{E6}, R^{E7}, and R^{E8} moieties can be linked to any of the other R^{E5}, R^{E6}, R^{E7}, and R^{E8} moieties to provide a substituted or unsubstituted alicyclic group containing 4 to 30 ring carbon atoms or a substituted or unsubstituted aryl group containing 6 to 18 ring carbon atoms or combinations thereof and the linkage may include heteroatoms or functional groups, e.g. the linkage may include without limitation an ether, ester, thioether, amino, alkylamino, imino, or anhydride moiety. The cyclic group can be monocyclic, bicyclic, or polycyclic. The cyclic group can contain monounsaturation or multiunsaturation. The ring may contain monosubstitution or multisubstitution, wherein the substituents are independently selected from hydrogen, hydrocarbyl, substituted hydrocarbyl, heteroatom-containing hydrocarbyl, substituted heteroatom-containing hydrocarbyl, —(Z*)ₙ-Fn where n is zero or 1, Z* and Fn are as defined hereinabove, and functional groups (Fn) provided above.

Cyclic olefins possessing at least one norbornene moiety may have the structure (F):

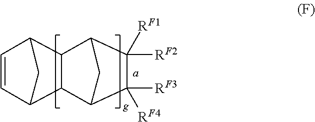

Wherein:
   R^{F1}, R^{F2}, R^{F3}, and R^{F4}, are as defined for R^{B1} through R^{B6}, and
   “a” represents a single bond or a double bond,
   g is an integer from 0 to 5, and when “a” is a double bond one of R^{F1}, R^{F2} and one of R^{F3}, R^{F4} is not present.

Furthermore, any of the R^{F1}, R^{F2}, R^{F3}, and R^{F4} moieties can be linked to any of the other R^{F1}, R^{F2}, R^{F3}, and R^{F4} moieties to provide a substituted or unsubstituted alicyclic group containing 4 to 30 ring carbon atoms or a substituted or unsubstituted aryl group containing 6 to 18 ring carbon atoms or combinations thereof and the linkage may include heteroatoms or functional groups, e.g. the linkage may include without limitation an ether, ester, thioether, amino, alkylamino, imino, or anhydride moiety. The alicyclic group can be monocyclic, bicyclic, or polycyclic. The cyclic group can contain monounsaturation or multiunsaturation. The rings may contain monosubstitution or multisubstitution, wherein the substituents are independently selected from hydrogen, hydrocarbyl, substituted hydrocarbyl, heteroatom-containing hydrocarbyl, substituted heteroatom-containing hydrocarbyl, —(Z*)ₙ-Fn where n is zero or 1, Z* and Fn are as defined hereinabove, and functional groups (Fn) provided above.

In some embodiments, the polymer precursor is:

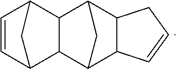 [SMILES: C1=CC2C(C1)C1CC2C2C3C=CC(C3)C12]

A route for the preparation of hydrocarbyl substituted and functionally substituted norbornenes may employ the Diels-Alder cycloaddition reaction. For example, cyclopentadiene or substituted cyclopentadiene may be reacted with a suitable dienophile at elevated temperatures to form the substituted norbornene adduct, which is generally shown by the following reaction

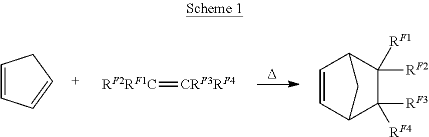

wherein:
   R^{F1} to R^{F4} are as previously defined for structure (F).

Other norbornene adducts can be prepared by the thermal pyrolysis of dicyclopentadiene in the presence of a suitable dienophile. The reaction may proceed by the initial pyrolysis of dicyclopentadiene to cyclopentadiene followed by the Diels-Alder cycloaddition of cyclopentadiene and the dienophile to give the adduct shown below in and Scheme 2:

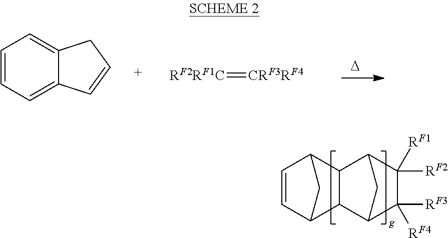

wherein:
   “g” is an integer from 0 to 5, and
   R^{F1} to R^{F4} are as previously defined for structure (F).

Norbornadiene and higher Diels-Alder adducts thereof similarly can be prepared by the thermal reaction of cyclopentadiene and dicyclopentadiene in the presence of an acetylenic reactant as shown below in Scheme 3:

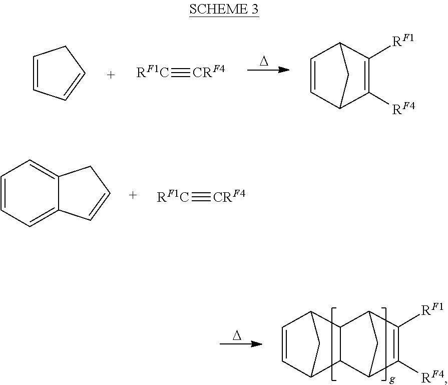

wherein:
   “g” is an integer from 0 to 5, R^{F1} and R^{F4} are as previously defined for structure (F)

Examples of bicyclic and polycyclic olefins may include, without limitation, dicyclopentadiene (DCPD); trimer and other higher order oligomers of cyclopentadiene including without limitation tricyclopentadiene (cyclopentadiene trimer), cyclopentadiene tetramer, and cyclopentadiene pentamer; ethylidenenorbornene; dicyclohexadiene; norbornene; 5-methyl-2-norbornene; 5-ethyl-2-norbornene; 5-isobutyl-2-norbornene; 5,6-dimethyl-2-norbornene; 5-phenylnorbornene; 5-benzylnorbornene; 5-acetylnorbornene; 5-methoxycarbonylnorbornene; 5-ethyoxycarbonyl-1-norbornene; 5-methyl-5-methoxy-carbonylnorbornene; 5-cyanonorbornene; 5,5,6-trimethyl-2-norbornene; cyclo-hexenylnorbornene; endo, exo-5,6-dimethoxynorbornene; endo, endo-5,6-dimethoxynorbornene; endo, exo-5,6-dimethoxycarbonylnorbornene; endo,endo-5,6-dimethoxycarbonylnorbornene; 2,3-dimethoxynorbornene; norbornadiene; tricycloundecene; tetracyclododecene; 8-methyltetracyclododecene; 8-ethyltetracyclododecene; 8-methoxycarbonyltetracyclododecene; 8-methyl-8-tetracyclododecene; 8-cyanotetracyclododecene; pentacyclopentadecene; pentacyclohexadecene; and the like, and their structural isomers, stereoisomers, and mixtures thereof. Additional examples of bicyclic and polycyclic olefins include, without limitation, C₂-C₁₂ hydrocarbyl substituted norbornenes such as 5-butyl-2-norbornene, 5-hexyl-2-norbornene, 5-octyl-2-norbornene, 5-decyl-2-norbornene, 5-dodecyl-2-norbornene, 5-vinyl-2-norbornene, 5-ethylidene-2-norbornene, 5-isopropenyl-2-norbornene, 5-propenyl-2-norbornene, and 5-butenyl-2-norbornene, and the like.

Cyclic olefins may include C₅ to C₂₄ unsaturated hydrocarbons (e.g., C₅ to C₂₄ cyclic hydrocarbons that contain one or more (typically 2 to 12) heteroatoms such as O, N, S, or P). For example, crown ether cyclic olefins may include numerous O heteroatoms throughout the cycle, and these are within the scope of the disclosure. Cyclic olefins provided herein may be C₅ to C₂₄ hydrocarbons that contain one or more (typically 2 or 3) olefins. For example, the cyclic olefin may be mono-, di-, or tri-unsaturated. Examples of cyclic olefins include without limitation cyclooctene, cyclododecene, and (c,t,t)-1,5,9-cyclododecatriene.

The cyclic olefins may also comprise multiple (typically 2 or 3) rings. For example, the cyclic olefin may be mono-, di-, or tri-cyclic. The rings may be fused. Examples of cyclic olefins that comprise multiple rings include, for example, norbornene, dicyclopentadiene, tricyclopentadiene, and 5-ethylidene-2-norbornene.

The cyclic olefin may be substituted, for example, a C₅ to C₂₄ cyclic hydrocarbon wherein one or more (typically 2, 3, 4, or 5) of the hydrogens are replaced with non-hydrogen substituents. For example, a cyclic olefin functionalized with an alcohol group may be used to prepare a telechelic polymer comprising pendent alcohol groups. Functional groups on the cyclic olefin may be protected in cases where the functional group interferes with the metathesis catalyst, and any of the protecting groups commonly used in the art may be employed. Acceptable protecting groups may be found, for example, in Greene et al., Protective Groups in Organic Synthesis, 3rd Ed. (New York: Wiley, 1999). A non-limiting list of protecting groups includes: (for alcohols) acetyl, benzoyl, benzyl, β-Methoxyethoxymethyl ether (MEM), Dimethoxytrityl, [bis-(4-methoxyphenyl)phenylmethyl](DMT), methoxymethyl ether (MOM), methoxytrityl [(4-methoxyphenyl)diphenylmethyl, MMT), p-methoxybenzyl ether (PMB), methylthiomethyl ether, pivaloyl (Piv), tetrahydropyranyl (THP), tetrahydrofuran (THF), trityl (triphenylmethyl, Tr), silyl ethers (most popular ones include trimethylsilyl (TMS), tert-butyldimethylsilyl (TBDMS), tri-iso-propylsilyloxymethyl (TOM), and triisopropylsilyl (TIPS) ethers, (for amines) tert-butyloxycarbonyl glycine, carbobenzyloxy (Cbz) group, p-methoxybenzyl carbonyl (Moz or MeOZ) group, tert-butyloxycarbonyl (BOC) group, 9-fluorenylmethyloxycarbonyl (FMOC) group, acetyl (Ac) group, benzoyl (Bz) group, benzyl (Bn), carbamate group, p-methoxybenzyl (PMB), 3,4-dimethoxybenzyl (DMPM), p-methoxyphenyl (PMP) group, tosyl (Ts) group, (for carbonyls) acetals and ketals, acylals, dithianes, (for carboxylic acids) methyl esters, benzyl esters, tert-butyl esters, esters of 2,6-disubstituted phenols (e.g. 2,6-dimethylphenol, 2,6-diisopropylphenol, 2,6-di-tert-butylphenol), silyl esters, orthoesters, oxazoline, (for phosphate) 2-cyanoethyl, and methyl. In the specific case of arginine (Arg) side chains, protection is important because of the propensity of the basic quanidinium group to produce side reactions. In cases described herein, effective protective groups include 2,2,5,7,8-pentamethylchroman (Pmc), 2,2,4,6,7-pentamethyldihydrobenzofurane (Pbf) and 1,2-dimethylindole-3-sulfonyl (MIS) groups.

Examples of functionalized cyclic olefins include without limitation 2-hydroxymethyl-5-norbornene, 2-[(2-hydroxyethyl)carboxylate]-5-norbornene, cydecanol, 5-n-hexyl-2-norbornene, 5-n-butyl-2-norbornene.

Cyclic olefins incorporating any combination of the abovementioned features (e.g., heteroatoms, substituents, multiple olefins, multiple rings) may be suitable for the methods disclosed herein.

The cyclic olefins provided herein may be strained or unstrained. Ring strain may be one factor in determining the reactivity of a molecule towards ring-opening olefin metathesis reactions. Highly strained cyclic olefins, such as certain bicyclic compounds, may readily undergo ring opening reactions with olefin metathesis catalysts. Less strained cyclic olefins, such as certain unsubstituted hydrocarbon monocyclic olefins, may be less reactive. In some cases, ring opening reactions of relatively unstrained cyclic olefins may become possible when performed in the presence of the olefinic compounds disclosed herein.

A plurality of cyclic olefins may be used herein. For example, two cyclic olefins selected from the cyclic olefins described hereinabove may be employed in order to form metathesis products that incorporate both cyclic olefins (e.g., a second cyclic olefin may be a cyclic alkenol (e.g., a C₅-C₂₄ cyclic hydrocarbon wherein at least one of the hydrogen substituents is replaced with an alcohol or protected alcohol moiety to yield a functionalized cyclic olefin).

The use of a plurality of cyclic olefins (e.g., wherein at least one of the cyclic olefins is functionalized), may provide for further control over the positioning of functional groups within the product(s). For example, the density of cross-linking points can be controlled in polymers and macromonomers prepared using the methods disclosed herein. Control over the quantity and density of substituents and functional groups may provide control over the physical properties (e.g., melting point, tensile strength, glass transition temperature, etc.) of the product(s). Control over these and other properties is possible for reactions using only a single cyclic olefin, but it will be appreciated that the use of a plurality of cyclic olefins further enhances the range of possible metathesis products and polymers formed.

Cyclic olefins provided herein may include, for example, dicyclopentadiene; tricyclopentadiene; dicyclohexadiene; norbornene; 5-methyl-2-norbornene; 5-ethyl-2-norbornene; 5-isobutyl-2-norbornene; 5,6-dimethyl-2-norbornene; 5-phenylnorbornene; 5-benzylnorbornene; 5-acetylnorbornene; 5-methoxycarbonylnorbornene; 5-ethoxycarbonyl-1-norbornene; 5-methyl-5-methoxy-carbonylnorbornene; 5-cyanonorbornene; 5,5,6-trimethyl-2-norbornene; cyclo-hexenylnorbornene; endo, exo-5,6-dimethoxynorbornene; endo, endo-5,6-dimethoxynorbornene; endo, exo-5-6-dimethoxycarbonylnorbornene; endo, endo-5,6-dimethoxycarbonylnorbornene; 2,3-dimethoxynorbornene; norbornadiene; tricycloundecene; tetracyclododecene; 8-methyltetracyclododecene; 8-ethyl-tetracyclododecene; 8-methoxycarbonyltetracyclododecene; 8-methyl-8-tetracyclo-dodecene; 8-cyanotetracyclododecene; pentacyclopentadecene; pentacyclohexadecene; higher order oligomers of cyclopentadiene such as cyclopentadiene tetramer, cyclopentadiene pentamer, and the like; and C₂-C₁₂ hydrocarbyl substituted norbornenes such as 5-butyl-2-norbornene; 5-hexyl-2-norbornene; 5-octyl-2-norbornene; 5-decyl-2-norbornene; 5-dodecyl-2-norbornene; 5-vinyl-2-norbornene; 5-ethylidene-2-norbornene; 5-isopropenyl-2-norbornene; 5-propenyl-2-norbornene; and 5-butenyl-2-norbornene, and the like. Even more preferred cyclic olefins include dicyclopentadiene, tricyclopentadiene, and higher order oligomers of cyclopentadiene, such as cyclopentadiene tetramer, cyclopentadiene pentamer, and the like, tetracyclododecene, norbornene, and C₂-C₁₂ hydrocarbyl substituted norbornenes, such as 5-butyl-2-norbornene, 5-hexyl-2-norbornene, 5-octyl-2-norbornene, 5-decyl-2-norbornene, 5-dodecyl-2-norbornene, 5-vinyl-2-norbornene, 5-ethylidene-2-norbornene, 5-isopropenyl-2-norbornene, 5-propenyl-2-norbornene, 5-butenyl-2-norbornene, and the like.

In certain embodiments, each of these Structures A-F may further comprise pendant substituents that are capable of crosslinking with one another or added crosslinking agents. For example, R^{A1}, R^{A2}, R^{B1}, R^{B2}, R^{B3}, R^{B4}, R^{B5}, R^{B6}, R^{C1}, R^{C2}, R^{C3}, R^{C4}, R^{C5}, R^{C6}, R^{D1}, R^{D2}, R^{D3}, R^{D4}, R^{E1}, R^{E2}, R^{E3}, R^{E4}, R^{E5}, R^{E6}, R^{E7}, R^{E8}, R^{F1}, R^{F2}, R^{F3}, and R^{F4} may each independently represent pendant hydrocarbyl chains containing olefinic or acetylenic bonds capable of crosslinking with themselves or other unsaturated moieties under metathesis conditions. Within Structures A-F, at least one pair of substituents, R^{B1} and R^{B2}, R^{B3} and R^{B4}, and R^{B5} and R^{B6}, R^{C1} and R^{C2}, R^{C5} and R^{C6}, R^{D2} and R^{D3}, R^{E5} and R^{E6}, R^{E7} and R^{E8}, R^{F1} and R^{F2}, and R^{F3} and R^{F4}, can together form an optionally substituted exocyclic double bond, for example /═CH(C₁₋₆-Fn).

When considering alternative olefinic precursors in the present methods, more preferred precursors may be those which, which when incorporated into polyacetylene polymers or copolymers, modify the electrical or physical character of the resulting polymer. One general class of such precursors are substituted annulenes and annulynes, for example [18]annulene-1,4;7,10;13,16-trisulfide. When co-polymerized with acetylene, this precursor can form a block co-polymer as shown here:

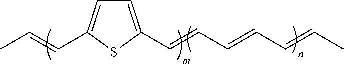

Substituted analogs of these trisulfides, as described below can also be used to provide corresponding substituted poly(thienylvinylene)-containing polymers or copolymers. For example, the 2,3,8,9,14,15-hexaoctyl derivative of [18]annulene-1,4;7,10;13,16-trisulfide is described in Horie, et al., “Poly(thienylvinylene) prepared by ring-opening metathesis polymerization: Performance as a donor in bulk heterojunction organic photovoltaic devices,” Polymer 51 (2010) 1541-1547, which is incorporated by reference herein:

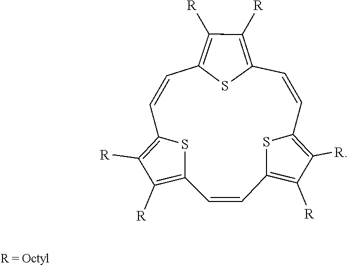

In certain embodiments, the unsaturated organic precursor comprises a purely hydrocarbon compound having a structure:

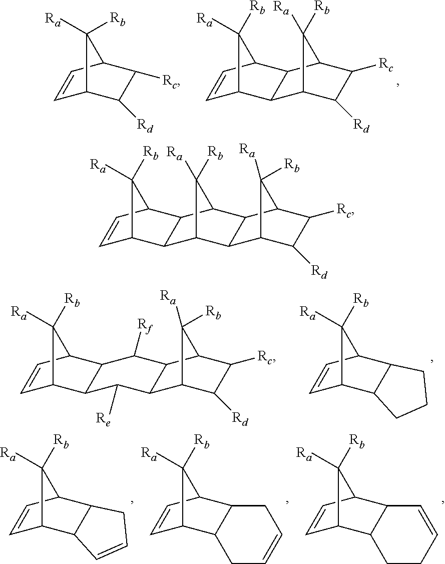

or a mixture thereof,
wherein
   Rₐ, R_{b}, R_{c}, R_{d}, Rₑ, and R_{f} are independently H or alkyl (such as C₁₋₂₀ alkyl, more such as C₁₋₁₀ alkyl).

The unsaturated organic precursor may comprise a hydrocarbon compound having a dicyclopentadiene structure, for example:

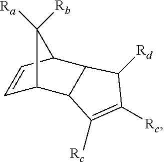

wherein:
   Rₐ, R_{b}, R_{c}, R_{d}, Rₑ, and R_{f} are independently H or alkyl (such as C₁₋₂₀ alkyl, such as C₁₋₁₀ alkyl). One such polymer resulting from such precursors comprises units having a structure:

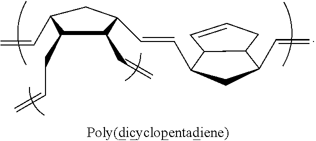

These hydrocarbon precursors may be employed (e.g., when the final polymerized product or article derived therefrom is to be subject to aggressive chemical conditions). For example, patterned products or article derived therefrom prepared from dicyclopentadiene structures may be effective in resisting aqueous HF (e.g., attractive for use as etching masks in semi-conductor or other electronic processing).

In other embodiments, the unsaturated polymerizable material matrix may include mono-, di-, or polyfunctionalized cyclic or alicyclic alkenes or alkynes (e.g., which include functional groups, including for example, alcohols, amines, amides, carboxylic acids and esters, phosphines, phosphonates, sulfonates or the like). Optionally substituted bicyclo [2.2.1]hept-5-ene-2,3,dicarboxylic acid diesters, 7-oxa-bicyclo [2.2.1]hept-5-ene-2,3,dicarboxylic acid diesters, 4-oxa-tricyclo[5.2.1.0^{2,6}]dec-8-ene-3,5-diones, 4,10-dioxa-tricyclo[5.2.1.0^{2,6}]dec-8-ene-3,5-diones, 4-aza-tricyclo[5.2.1.0^{2,6}]dec-8-ene-3,5-diones, 10-oxa-4-aza-tricyclo[5.2.1.0^{2,6}]dec-8-ene-3,5-diones, or simple di-substituted alkenes, including bisphosphines may be used. In certain embodiments, these functionalized alkenes include those having structures such as:

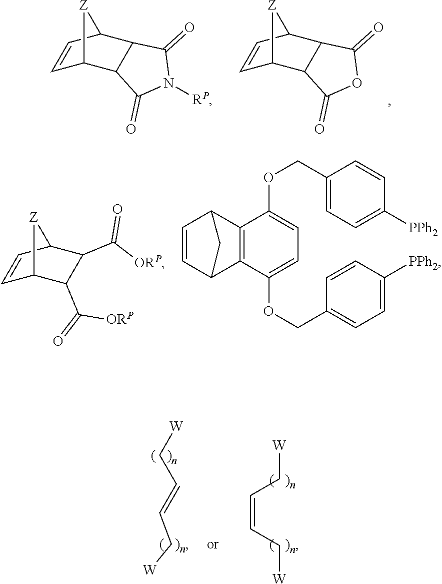

wherein:
   Z is —O— or C(R^{a})(R^{b});
   R is independently H; or C₁₋₆ alkyl optionally substituted at the terminus with —N(R^{a})(R^{b}), —O—R^{a}, —C(O)O—R^{a}, —OC(O)—(C₁₋₆ alkyl), or —OC(O)—(C₆₋₁₀ aryl); or an optionally protected sequence of 3 to 10 amino acids (such as including R-G-D or arginine-glycine-aspartic acid);
   W is independently —N(R^{a})(R^{b}), —O—R^{a}, or —C(O)O—R^{a}, —P(O)(OR^{a})₂, —SO₂(OR^{a}), or SO₃⁻;
Rₐ and R_{b} are independently H or C₁₋₆ alkyl;
the C₆₋₁₀ aryl is optionally substituted with 1, 2, 3, 4, or 5 optionally protected hydroxyl groups (the protected hydroxyl groups such as being benzyl); and
   n is independently 1, 2, 3, 4, 5, or 6.

Non-limiting examples of such functionalized materials include:

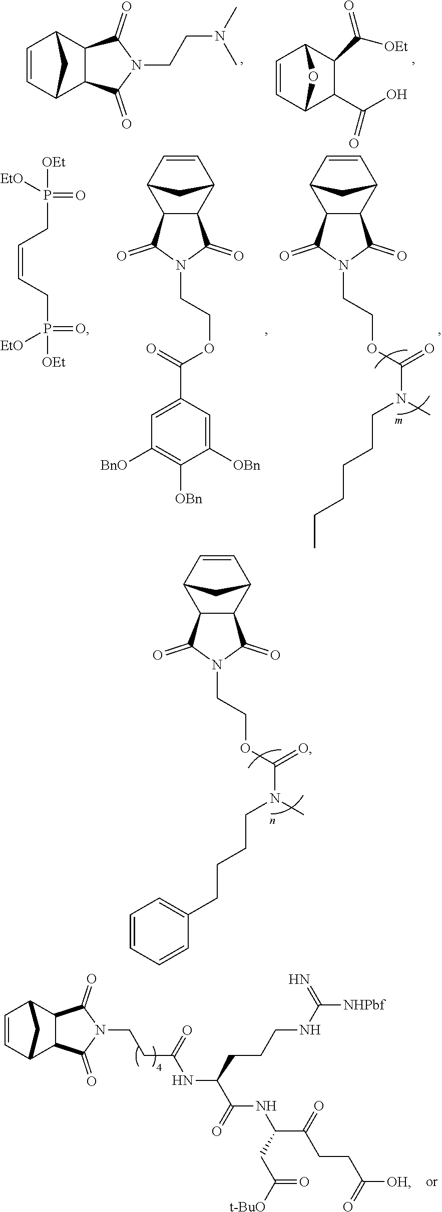

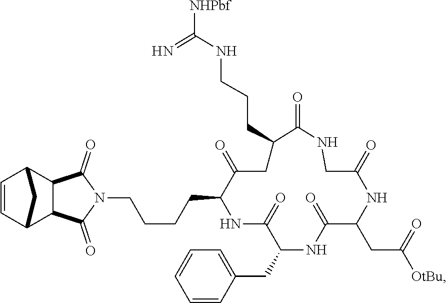

where Bn is benzyl, tBu is tert-butyl, and Pbf is 2,2,4,6,7-pentamethyldihydrobenzofuran. Other protecting groups may also be employed.

Incorporation of such functional groups may provide further functionalization of the pre-polymerized or polymerized compositions (e.g., expanding the utility options available for such compositions). Such functional groups can be used as linking points for the additional of other materials, including, for example, natural or synthetic amino acid sequences. In certain embodiments, R^{P} can be further functionalized to include:

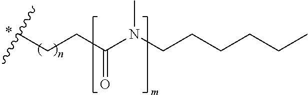

Polymerized products (either 2-dimensional optionally patterned coatings or optionally patterned 3-dimensional structures) prepared from the pre-polymerized compositions may be useful as scaffolds for drug delivery or tissue regeneration. Films or articles comprising pendant optionally protected sequence of 3 to 10 amino acids (such as including R-G-D or arginine-glycine-aspartic acid) are known to be useful in tissue regeneration applications and the present inventive compositions and methods provide convenient routes to these materials.

Catalytic organometallic materials may be incorporated into such matrices. Photosensitive compositions provided herein may comprise an acid-activated ruthenium metathesis catalyst admixed or dissolved within a polymerizable material matrix comprising at least one unsaturated organic precursor and at least one unsaturated tethered organometallic precursor, or ligand capable of coordinating to form an organometallic precursor (e.g., vinyl bipyridine, bisphosphines, and carbene precursors) each organic and organometallic precursor having at least one alkene or one alkyne bond.

An unsaturated tethered organometallic precursor may be an organometallic complex having a pendant alkene or alkyne group capable of being incorporated into the polymerized matrix.

In some embodiments, the organometallic moiety comprises a Group 3 to Group 12 transition metal, such as Fe, Co, Ni, Ti, Al, Cu, Zn, Ru, Rh, Ag, Ir, Pt, Au, or Hg. In preferred embodiments, the organometallic moiety comprises Fe, Co, Ni, Ru, Rh, Ag, Ir, Pt, or Au. The organometallic moieties may be attached by or contain monodentate, bidentate, or polydentate ligands, for example cyclopentadienyls, imidazoline (or their carbene precursors), phosphines, polyamines, polycarboxylates, nitrogen macrocycles (e.g., porphyrins or corroles), provided these ligands contain the pendant alkene or alkyne group capable of being incorporated into the polymerized matrix. Non-limiting examples of this concept include:

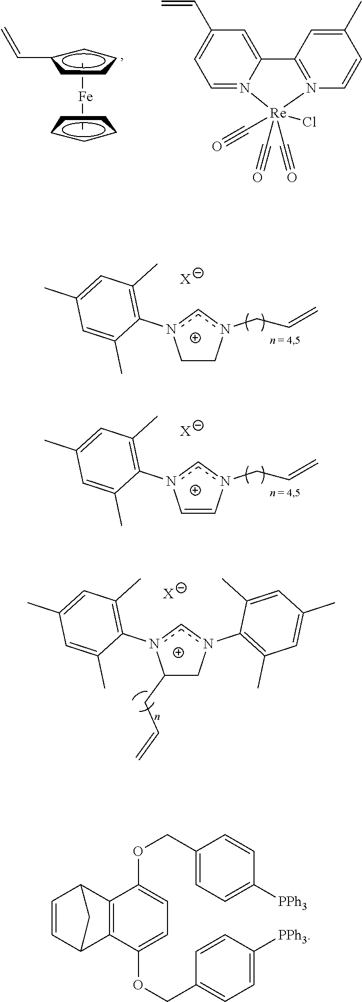

Representative chemistry of the polymerized product into which such an organometallic was incorporated is illustrated in U.S. patent application Ser. No. 14/505,824.

In certain embodiments, the organometallic moiety may catalyze the oxidation or reduction of an organic substrate under oxidizing or reducing conditions. Such oxidation reactions include, but are not limited to, oxidations of alkenes or alkynes to form alcohols, aldehydes, carboxylic acids or esters, ethers, or ketones, or the addition of hydrogen-halides or silanes across unsaturates. Such oxidation reactions include, but are not limited to, reduction of alkenes to alkanes and reduction of alkynes to alkenes or alkanes. Certain of these organometallic moieties may be used as pendant metathesis or cross-coupling catalysts or for splitting water.

In some embodiments, the polymer precursor is a compound having a structure of Formula (II):

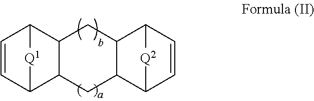

wherein:
   Q¹ and Q² are each independently optionally substituted alkylene; and
   a and b are each independently 0, 1, or 2.

In some embodiments, Q¹ and Q² are each independently C₁-C₆ alkylene. In some embodiments, Q¹ and Q² are each independently methylene or ethylene. In some embodiments, Q¹ and Q² are each methylene. In some embodiments, a and b are each independently 0 or 1. In some embodiments, a is 1 and b is 0. In some embodiments, a and b are each 1.

In some embodiments, the polymer precursor is a compound selected from the group consisting of:

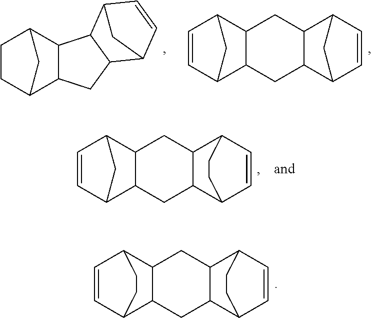

In some embodiments, the polymer precursor is a compound having a structure of Formula (III):

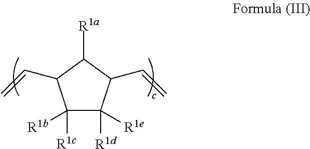

wherein:
   R^{1a} is hydrogen or optionally substituted alkyl;
   R^{1b}, R^{1c}, R^{1d}, and R^{1e} are each independently hydrogen, optionally substituted alkyl, R^{1c} and R^{1d} are taken together with the atoms to which they are attached to form an optionally substituted cycloalkyl, R^{1b} and R^{1c} are taken together with the atoms to which they are attached to form an optionally substituted alkenyl, or R^{1d} and R^{1e} are taken together with the atoms to which they are attached to form an optionally substituted alkenyl; and
c is an integer from 1-20.

In some embodiments, R^{1a} is hydrogen. In some embodiments, R^{1b} is hydrogen. In some embodiments, R^{1c} is hydrogen. In some embodiments, R^{1d} is hydrogen. In some embodiments, R^{1e} is hydrogen.

In some embodiments, R^{1b} and R^{1c} are taken together with the atoms to which they are attached to form an optionally substituted alkenyl. In some embodiments, R^{1d} and R^{1e} are taken together with the atoms to which they are attached to form an optionally substituted alkenyl.

In some embodiments, R^{1b} and R^{1c} are taken together with the atoms to which they are attached to form an optionally substituted C₂-C₆ alkenyl. In some embodiments, R^{1d} and R^{1e} are taken together with the atoms to which they are attached to form an optionally substituted C₂-C₆ alkenyl. In some embodiments, the optionally substituted C₂-C₆ alkenyl is substituted with alkyl (e.g., C₁-C₆ alkyl). In some embodiments, the optionally substituted C₂-C₆ alkenyl is —CH═CH—C₁-C₆ alkyl. In some embodiments, the optionally substituted C₂-C₆ alkenyl is —CH═CH—CH₃. In some embodiments, R^{1b} and R^{1c} are hydrogen and R^{1e} and R^{1e} are taken together with the atoms to which they are attached to form an optionally substituted C₂-C₆ alkenyl (e.g., —CH═CH—CH₃). In some embodiments, R^{1d} and R^{1e} are hydrogen and R^{1b} and R^{1c} are taken together with the atoms to which they are attached to form an optionally substituted C₂-C₆ alkenyl (e.g., —CH═CH—CH₃). In some embodiments, R^{a}, R^{1b} and R^{1c} are hydrogen and R^{1e} and R^{1e} are taken together with the atoms to which they are attached to form an optionally substituted C₂-C₆ alkenyl (e.g., —CH═CH—CH₃). In some embodiments, R^{a}, R^{1d} and R^{1e} are hydrogen and R^{1b} and R^{1c} are taken together with the atoms to which they are attached to form an optionally substituted C₂-C₆ alkenyl (e.g., —CH═CH—CH₃).

In some embodiments, R^{1c} and R^{1d} are taken together with the atoms to which they are attached to form an optionally substituted cycloalkyl.

In some embodiments, R^{1a} is hydrogen and R^{c} and R^{d} are taken together with the atoms to which they are attached to form an optionally substituted cycloalkyl. In some embodiments, the optionally substituted cycloalkyl is an optionally substituted C₃-C₆ cycloalkyl. In some embodiments, the optionally substituted C₃-C₆ cycloalkyl comprises at least one double bond. In some embodiments, the optionally substituted C₃-C₆ cycloalkyl is a cyclopentene.

In some embodiments, R^{1a}, R^{1b}, R^{1c}, R^{1d}, and R^{1e} are each hydrogen.

In some embodiments, n is 1-10. In some embodiments, n is 1-5. In some embodiments, n is 1.

In some embodiments, the polymer precursor is a compound selected from the group consisting of:

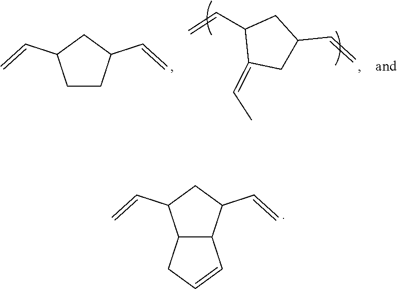

In some embodiments, the polymer precursor is a compound having a structure of Formula (IV):

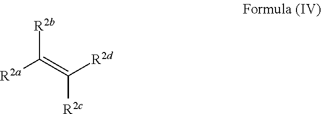

wherein:
   R^{2a}, R^{2b}, R^{2c}, and R^{2d} are each independently hydrogen, optionally substituted alkyl, or R^{2a} and R^{2c} are taken together with the atoms to which they are attached to form an optionally substituted cycloalkyl.

In some embodiments, R^{2a} and R^{2d} are each independently optionally substituted alkyl and R^{2b} and R^{2c} are each hydrogen. In some embodiments, R^{2a} and R^{2d} are each independently optionally substituted alkyl comprising one or more optionally substituted unsaturated bond. In some embodiments, R^{2a} and R^{2d} are each independently C₁-C₂₀ alkyl and R^{2b} and R^{2c} are each hydrogen. In some embodiments, R^{2a} and R^{2d} are each independently C₁-C₁₀ alkyl and R^{2b} and R^{2c} are each hydrogen. In some embodiments, R^{2a} and R^{2d} are each independently C₁-C₆ alkyl and R^{2b} and R^{2c} are each hydrogen.

In some embodiments, R^{2a} and R^{2c} are taken together with the atoms to which they are attached to form an optionally substituted cycloalkyl and R^{2b} and R^{2d} are each hydrogen. In some embodiments, the optionally substituted cycloalkyl comprises one or more optionally substituted unsaturated bond. In some embodiments, R^{2a} and R^{2c} are taken together with the atoms to which they are attached to form an C₄-C₂₀ cycloalkyl and R^{2b} and R^{2d} are each hydrogen. In some embodiments, R^{2a} and R^{2c} are taken together with the atoms to which they are attached to form an C₄-C₁₂ cycloalkyl and R^{2b} and R^{2d} are each hydrogen. In some embodiments, R^{2a} and R^{2c} are taken together with the atoms to which they are attached to form an C₄-C₈ cycloalkyl and R^{2b} and R^{2d} are each hydrogen.

In some embodiments, the at least one polymer precursor is a compound selected from the group consisting of;

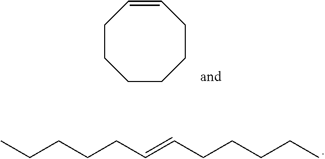

In some embodiments, the polymer precursor is a compound having a structure of Formula (V):

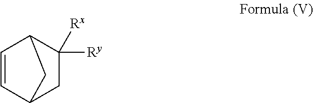

wherein:
   R^{x} and R^{y} are each independently hydrogen, optionally substituted alkyl (e.g., optionally substituted with one or more group, each group independently selected from the group consisting of hydroxyl, optionally substituted alkyl, optionally substituted heteroalkyl (e.g., amide), and optionally substituted alkoxy), or R^{x} and R^{y} are taken together with the atoms to which they are attached to form an optionally substituted alkenyl.

In some embodiments, R^{x} and R^{y} are each hydrogen.

In some embodiments, R^{x} and R^{y} are each independently hydrogen or optionally substituted alkyl. In some embodiments, R^{x} and R^{y} are each independently hydrogen or unsubstituted alkyl. In some embodiments, R^{x} is hydrogen and R^{y} is C₁-C₂₀ alkyl. In some embodiments, R^{x} is hydrogen and R^{y} is C₁-C₁₀ alkyl. In some embodiments, R^{x} is hydrogen and R^{y} is C₁-C₅ alkyl.

In some embodiments, R^{x} and R^{y} are each independently hydrogen or alkyl substituted with one or more group, each group independently selected from the group consisting of hydroxyl, optionally substituted alkyl, optionally substituted heteroalkyl (e.g., amide), and optionally substituted alkoxy. In some embodiments, R^{x} is hydrogen and R^{y} is alkyl substituted with one or more group, each group independently selected from the group consisting of hydroxyl, optionally substituted alkyl, optionally substituted heteroalkyl (e.g., amide), and optionally substituted alkoxy. In some embodiments, R^{x} is hydrogen and R^{y} is alkyl substituted with hydroxyl. In some embodiments, the optionally substituted alkyl, optionally substituted heteroalkyl (e.g., amide), or optionally substituted alkoxy is a linker (e.g., a polymer).

In some embodiments, the polymer precursor is a compound having a structure of Formula (V-A):

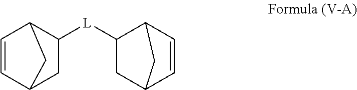

wherein:
   L is a linker (e.g., a polymer).

In some embodiments, the polymer precursor is a compound selected from the group consisting of:

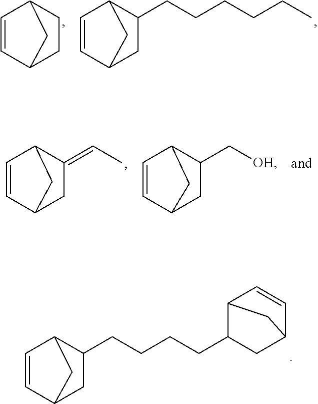

In some embodiments, the polymer precursor is a compound having a structure of Formula (VI):

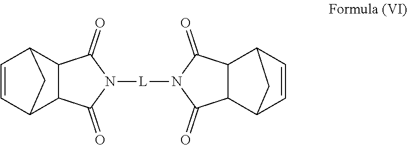

wherein:
   L is a linker (e.g., a polymer).

In some embodiments, L is a polymer. In some embodiments, L is optionally substituted alkylene (e.g., C₁-C₂₀ alkylene), optionally substituted alkoxy (e.g., PEG), optionally substituted siloxane (e.g., PDMS), or optionally substituted heteroalkyl (e.g., polyamide). In some embodiments, L is optionally C₁-C₂₀ alkylene. In some embodiments, L is optionally C₁-C₁₀ alkylene. In some embodiments, L is optionally C₁-C₅ alkylene.

In some embodiments, the polymer precursor is a compound selected from the group consisting of:

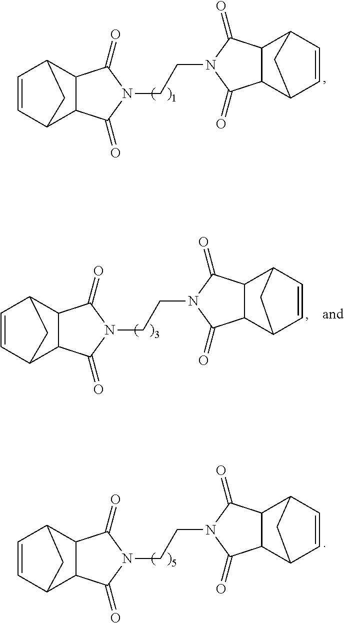

In some embodiments, the polymer precursor is a compound having a structure of Formula (VII):

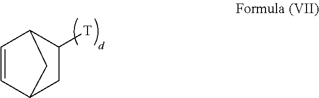

wherein:
   T is a (central) point of attachment (e.g., optionally substituted alkyl (e.g., alkyl substituted with one or more group, each group independently selected from the group consisting of alkyl and alkoxy substituted with oxo), optionally substituted heteroalkyl (e.g., polyamide or polyester), optionally substituted alkoxy (e.g., PEG) or wherein the (central) point of attachment comprises one or more silicon (Si) (e.g., optionally substituted siloxane (e.g., PDMS))); and
   d is an integer from 1-10.

In some embodiments, T (e.g., the central point of attachment) is a carbon atom.

In some embodiments, T is optionally substituted alkyl. In some embodiments, T is alkyl substituted with one or more group, each group independently selected from the group consisting of alkyl and alkoxy substituted with oxo. In some embodiments, T is alkyl substituted alkyl and alkoxy substituted with oxo. In some embodiments, T is optionally substituted heteroalkyl. In some embodiments, the optionally substituted heteroalkyl is a polyamide or a polyester. In some embodiments, the heteroalkyl is substituted with alkyl (e.g., C₁-C₆ alkyl). In some embodiments, the heteroalkyl is substituted with methyl. In some embodiments, T is optionally substituted alkoxy (e.g., PEG). In some embodiments, T is alkoxy substituted with alkyl (e.g., C₁-C₆ alkyl) and oxo.

In some embodiments, T (e.g., the central point of attachment) is a silicon atom. In some embodiments, T comprises one or more silicon atom (Si). In some embodiments, T comprises 1-15 silicon atom(s). In some embodiments, T comprises 1-10 silicon atom(s). In some embodiments, T comprises 10 silicon atoms. In some embodiments, T comprises one or more silicon atom (Si) coupled to one or more oxygen atom (O). In some embodiments, T comprises one or more silicon atom (Si) coupled to one or more oxygen atom (O) and one or more alkyl (e.g., C₁-C₆alkyl). In some embodiments, T comprises one or more silicon atom (Si) coupled to one or more oxygen atom (O) and one or more isopropyl. In some embodiments, T is optionally substituted siloxane (e.g., PDMS).

In some embodiments, the polymer precursor is:

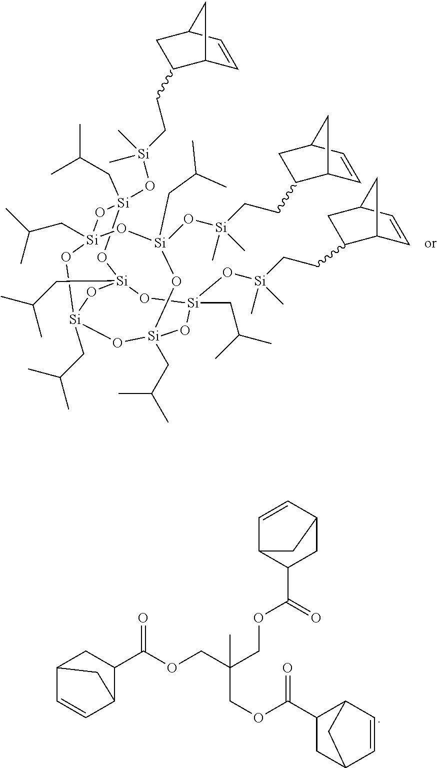 [SMILES: CC(C)C[Si]1(O[Si](C)(C)CCC2CC3C=CC2C3)O[Si]2(CC(C)C)O[Si](CC(C)C)(O[Si](C)(C)CCC3CC4C=CC3C4)O[Si]3(CC(C)C)O[Si](CC(C)C)(O[Si](C)(C)CCC4CC5C=CC4C5)O[Si](CC(C)C)(O1)O[Si](CC(C)C)(O2)O3 ; CC(COC(=O)C1CC2C=CC1C2)(COC(=O)C1CC2C=CC1C2)COC(=O)C1CC2C=CC1C2]

In some embodiments, a mixture described herein comprises any polymer precursor described in any of International Publication Number WO 2014/055720, U.S. Pat. No. 9,207,532, European Patent Number 2,903,996, International Publication Number WO 2015/065649, U.S. Patent Publication Number 2015/118188, European Patent Publication Number 3,063,592, International Publication Number WO 2018/045132, U.S. Patent Publication Number 2018/067393, U.S. Patent Publication Number 2020/183276, European Patent Publication Number 3,507,007, International Publication Number WO 2020/006345, Photolithographic Olefin Metathesis Polymerization, J. Am. Chem. Soc. 2013, 135, 16817-16820, Visible-Light-Controlled Ruthenium-Catalyzed Olefin Metathesis, J. Am. Chem. Soc. 2019, 141, 17, 6791-6796, A Tandem Approach to Photoactivated Olefin Metathesis: Combining a Photoacid Generator with an Acid Activated Catalyst, J. Am. Chem. Soc. 2009, 131, 6, 2038-2039, Metal-Free Ring-Opening Metathesis Polymerization, J. Am. Chem. Soc. 2015, 137, 1400-1403, JOURNAL OF POLYMER SCIENCE, PART A: POLYMER CHEMISTRY 2019, 57, 1791-17, each of which is incorporated herein by reference, in their entirety, in particular for the compounds provided therein.

The polymer precursor can be present (e.g., combined) in a mixture provided herein at a concentration of at least 0.1% by weight, 1% by weight, 10% by weight, 20% by weight, 30% by weight, 40% by weight, 50% by weight, 60% by weight, 70% by weight, 80% by weight, 90% by weight, 99% by weight, 99.9% by weight, 99.99% by weight, 99.999% by weight, 99.9999% by weight, or more. The polymer precursor can be present (e.g., combined) in a mixture provided herein at a concentration of at most 99.9999% by weight, 99.999% by weight, 99.99% by weight, 99.9% by weight, 99% by weight, 90% by weight, 80% by weight, 70% by weight, 60% by weight, 50% by weight, 40% by weight, 30% by weight, 20% by weight, 10% by weight, 1% by weight, 0.1% by weight, or less. The polymer precursor can be present (e.g., combined) in a mixture provided herein at a concentration within a range defined by any two of the preceding values. The polymer precursor can be present (e.g., combined) in a mixture provided herein at a concentration from 0.1% to 99.9999%. The polymer precursor can be present (e.g., combined) in a mixture provided herein at a concentration from 50% to 99.9%.

### Additives:

A mixture provided herein may comprise one or more additives. The additive may modify at least one property, feature, or characteristic of the 3D object. Many types of additives may be used to modify the performance of the composition, such as, for example (i) liquid properties (e.g., viscosity, stability, activity, cure speed, absorbance, surface energy, odor, etc.) and (ii) final cure polymer properties (e.g., modulus, toughness, impact strength, color, UV-stability, ductility, glass transition temperature, weather resistance, etc). These additives may include, for example, fillers, fibers, polymers, surfactants, inorganic particles, cells, viruses, biomaterials, rubbers, impact modifiers, graphite and graphene, colorants, dyes, pigments, carbon fiber, glass fiber, textiles, lignin, cellulose, wood, metal particles, or any combination thereof.

The additive may modify the modulus, toughness, impact strength, color, UV-stability, ductility, glass transition temperature, weather resistance, flammability or surface energy of the 3D object. The additive may modify at least one property, feature, or characteristic of the photopolymer. The additive may modify the photomodulus coefficient, green strength, pot life, shelf life, printing accuracy, critical exposure, penetration depth, print speed or optimal print environment or temperature of the photopolymer (e.g., 3D object).

An additive such as a stabilizer may be included to improve the dark stability of the compositions described herein. The stabilizer may include, for example, organic or inorganic Lewis or Bronsted bases, antioxidants, antiozonants, surfactants, oxygen scavengers, ligands, quenchers, light-absorbers, hindered-amine light stabilizers (HALS), amines, phosphines, phosphites, or any combination thereof.

The additive may be selected from the group consisting of an antioxidant (e.g., a primary antioxidant or a secondary antioxidant), a filler, an optical brightener, an ultraviolet (UV) absorber, a pigment, a dye, a photoredox agent, an oxygen scavenger, a flame retardant, an impact modifier, a particle, a filler, a fiber, a nanoparticle, a plasticizer, a solvent, an oil, a wax, a vulcanizing agent, a crosslinker (e.g., a secondary crosslinker (e.g., a thiol or a peroxide)), hindered amine light stabilizer (HALS), a polymerization inhibitor (e.g. a phosphine, phosphite, amine, pyridine, bipyridine, phenanthroline, chelating agent, thiol, vinyl ether), a shelf-life stabilizer, a chain-transfer agent, and a sizing agent (e.g. functionality to connect organic and inorganic phases).

In some embodiments, the additive is a coumarin (e.g., a derivative thereof), an alpha hydroxy ketone, or a phosphine oxide.

In some embodiments, the additive is a compound selected from the group consisting of:

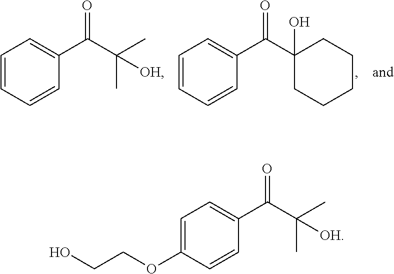

In some embodiments, the additive is a compound selected from the group consisting of:

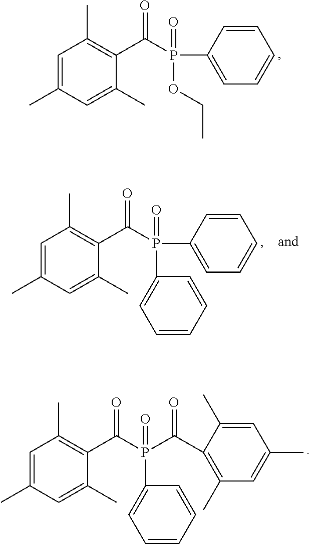

In some embodiments, the additive is a compound selected from the group consisting of:

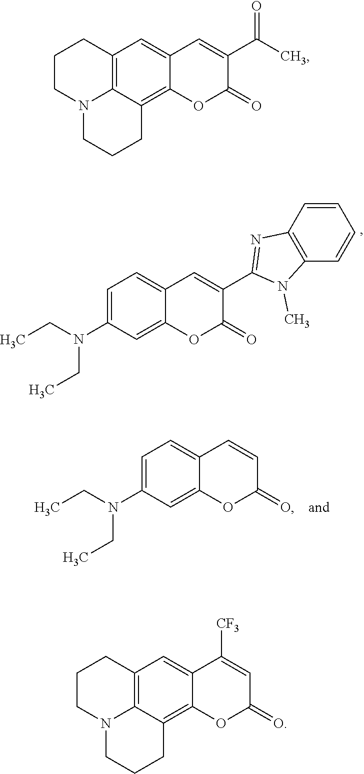 [SMILES: CC(=O)c1cc2cc3c4c(c2oc1=O)CCCN4CCC3 ; CCN(CC)c1ccc2cc(-c3nc4ccccc4n3C)c(=O)oc2c1 ; CCN(CC)c1ccc2ccc(=O)oc2c1 ; "and" ; O=c1cc(C(F)(F)F)c2cc3c4c(c2o1)CCCN4CCC3]

The additive can be present (e.g., combined) in a mixture provided herein at a concentration of at least 0.1 parts per million (ppm) (e.g., 0.00001% by weight), 1 ppm (e.g., 0.0001% by weight), 10 ppm (e.g., 0.001% by weight), 100 ppm (e.g., 0.01% by weight), 1,000 ppm (e.g., 0.1% by weight), 10,000 ppm (e.g., 1% by weight), 100,000 ppm (e.g., 10% by weight), 200,000 ppm (e.g., 20% by weight), or more. The additive can be present (e.g., combined) in a mixture provided herein at a concentration of at most 200,000 ppm (e.g., 20% by weight), 100,000 ppm (e.g., 10% by weight), 10,000 ppm (e.g., 1% by weight), 1,000 ppm (e.g., 0.10% by weight), 100 ppm (e.g., 0.010% by weight), 10 ppm (e.g., 0.0010% by weight), 1 ppm (e.g., 0.0001% by weight), 0.1 ppm (e.g., 0.00001% by weight), or less. The additive can be present (e.g., combined) in a mixture provided herein at a concentration within a range defined any two of the preceding values. The additive can be present (e.g., combined) in a mixture provided herein at a concentration from about 0.1 ppm (e.g., 0.00001% by weight) to about 200,000 ppm (e.g., 20% by weight). The additive may be present in the mixture at a concentration from about 1,000 ppm (e.g., 0.1% by weight) to about 10,000 ppm (e.g., 1% by weight).

In some embodiments, a mixture described herein comprises any compound or composition (e.g., catalyst, initiator, polymer precursor, etc.) described in any of International Publication Number WO 2014/055720, U.S. Pat. No. 9,207,532, European Patent Number 2,903,996, International Publication Number WO 2015/065649, U.S. Patent Publication Number 2015/118188, European Patent Publication Number 3,063,592, International Publication Number WO 2018/045132, U.S. Patent Publication Number 2018/067393, U.S. Patent Publication Number 2020/183276, European Patent Publication Number 3,507,007, International Publication Number WO 2020/006345, Photolithographic Olefin Metathesis Polymerization, J. Am. Chem. Soc. 2013, 135, 16817-16820, Visible-Light-Controlled Ruthenium-Catalyzed Olefin Metathesis, J. Am. Chem. Soc. 2019, 141, 17, 6791-6796, A Tandem Approach to Photoactivated Olefin Metathesis: Combining a Photoacid Generator with an Acid Activated Catalyst, J. Am. Chem. Soc. 2009, 131, 6, 2038-2039, Metal-Free Ring-Opening Metathesis Polymerization, J. Am. Chem. Soc. 2015, 137, 1400-1403, JOURNAL OF POLYMER SCIENCE, PART A: POLYMER CHEMISTRY 2019, 57, 1791-17, each of which is incorporated herein by reference, in its entirety, in particular for the compounds provided therein.

### Computer Systems

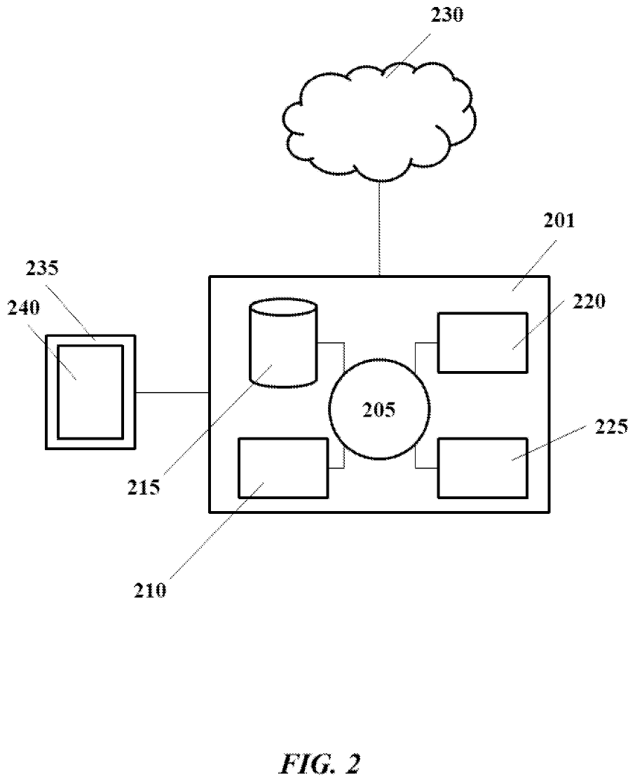

The present disclosure provides computer systems that are programmed to implement methods of the disclosure. FIG. 2 shows a computer system 201 that is programmed or otherwise configured to process a three-dimensional (3D) object, such as, for example, a dental product or an orthodontic product. The computer system 201 can regulate various aspects of the methods and compositions of the present disclosure, such as, for example, reactivity, viscosity, latent catalyst loading, PAG loading, PAH loading, sensitizer loading, stabilizer loading, solvent loading, additive loading, oxygen concentration, exposure doses, irradiances. The computer system 201 can be an electronic device of a user or a computer system that is remotely located with respect to the electronic device. The electronic device can be a mobile electronic device.

The computer system 201 includes a central processing unit (CPU, also “processor” and “computer processor” herein) 205, which can be a single core or multi core processor, or a plurality of processors for parallel processing. The computer system 201 also includes memory or memory location 210 (e.g., random-access memory, read-only memory, flash memory), electronic storage unit 215 (e.g., hard disk), communication interface 220 (e.g., network adapter) for communicating with one or more other systems, and peripheral devices 225, such as cache, other memory, data storage and/or electronic display adapters. The memory 210, storage unit 215, interface 220 and peripheral devices 225 are in communication with the CPU 205 through a communication bus (solid lines), such as a motherboard. The storage unit 215 can be a data storage unit (or data repository) for storing data. The computer system 201 can be operatively coupled to a computer network (“network”) 230 with the aid of the communication interface 220. The network 230 can be the Internet, an internet and/or extranet, or an intranet and/or extranet that is in communication with the Internet. The network 230 in some cases is a telecommunication and/or data network. The network 230 can include one or more computer servers, which can enable distributed computing, such as cloud computing. The network 230, in some cases with the aid of the computer system 201, can implement a peer-to-peer network, which may enable devices coupled to the computer system 201 to behave as a client or a server.

The CPU 205 can execute a sequence of machine-readable instructions, which can be embodied in a program or software. The instructions may be stored in a memory location, such as the memory 210. The instructions can be directed to the CPU 205, which can subsequently program or otherwise configure the CPU 205 to implement methods of the present disclosure. Examples of operations performed by the CPU 205 can include fetch, decode, execute, and writeback.

The CPU 205 can be part of a circuit, such as an integrated circuit. One or more other components of the system 201 can be included in the circuit. In some cases, the circuit is an application specific integrated circuit (ASIC).

The storage unit 215 can store files, such as drivers, libraries and saved programs. The storage unit 215 can store user data, e.g., user preferences and user programs. The computer system 201 in some cases can include one or more additional data storage units that are external to the computer system 201, such as located on a remote server that is in communication with the computer system 201 through an intranet or the Internet.

The computer system 201 can communicate with one or more remote computer systems through the network 230. For instance, the computer system 201 can communicate with a remote computer system of a user (e.g., mobile electronic device). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 201 via the network 230.

Methods as described herein can be implemented by way of machine (e.g., computer processor) executable code stored on an electronic storage location of the computer system 201, such as, for example, on the memory 210 or electronic storage unit 215. The machine executable or machine-readable code can be provided in the form of software. During use, the code can be executed by the processor 205. In some cases, the code can be retrieved from the storage unit 215 and stored on the memory 210 for ready access by the processor 205. In some situations, the electronic storage unit 215 can be precluded, and machine-executable instructions are stored on memory 210.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 201, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 201 can include or be in communication with an electronic display 235 that comprises a user interface (UI) 240 for providing, for example, information related to compositions of and methods for processing photopolymers. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 205. The algorithm can, for example, provide the design of a three-dimensional (3D) object (e.g., a dental product or an orthodontic product), instruct the printing of a 3D object (e.g., a dental product or an orthodontic product), modify a printing path for a 3D object (e.g., a dental product or an orthodontic product), or a combination thereof.

### EXAMPLES

The compositions described herein can be prepared in a number of ways based on the teachings contained herein and synthetic procedures known in the art. In the description of the synthetic methods described below, it is to be understood that all proposed reaction conditions, including choice of solvent, reaction atmosphere, reaction temperature, duration of the experiment and workup procedures, can be chosen to be the conditions standard for that reaction, unless otherwise indicated. It is understood by one skilled in the art of organic synthesis that the functionality present on various portions of the molecule should be compatible with the reagents and reactions proposed. Substituents not compatible with the reaction conditions will be apparent to one skilled in the art, and alternate methods are therefore indicated. The starting materials for the examples are either commercially available or are readily prepared by standard methods from known materials.

Abbreviations: DSC: differential scanning calorimetry, DMA: dynamic mechanical analysis; FEP: fluorinated ethylene propylene; HDT: heat deflection temperature; IR: infrared; PEG: polyethylene glycol.

As used herein, “Sensitizer 1” is a compound having the structure:

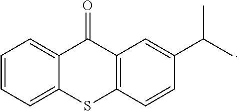 [SMILES: CC(C)c1ccc2sc3ccccc3c(=O)c2c1]

As used herein, “Polymer Precursor 1” refers to a mixture of about 94 weight percent dicyclopentadiene and 6 weight percent tricyclopentadiene.

As used herein, “Catalyst 1” refers to a latent ruthenium catalyst having the structure:

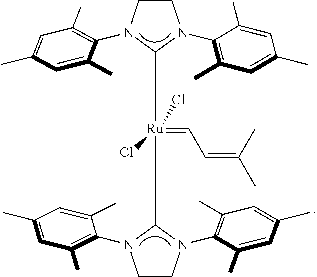

### Example 1. Curing of Olefin Metathesis Photopolymers with Infrared Radiation

30 mL mixtures of initiator, sensitizer, polymer precursor, and latent ruthenium catalyst for photopolymerization based on olefin metathesis were prepared. The contents of the mixture are summarized in Table 1 below. A 3D printer equipped with a ultraviolet or visible light source was used to disperse and photopolymerize the mixture. Polymerization was performed by the printer by irradiating the samples with light at a wavelength of 385 nm.

TABLE 1

| | | | Exemplary | |
|---|---|---|---|---|
| | Material | | Amount | |
| Material | Type | Amount | Added | |
| Bis(4-tert- | Initiator | 1.75 g/g*-145.7 mg | 145.7 | mg |
| butylphenyl)iodonium | | | | |
| triflate | | | | |
| Sensitizer 1 | Sensitizer | 1.75 mg/g*-145.7 mg | 145.6 | mg |
| Polymer Precursor 1 | Monomer | 83.257 g | 83.2 | g |
| | mixture | | | |
| Catalyst 1 | Latent | 1.0 mg/g-83.257 mg | 83.2 | mg |
| | catalyst | | | |

*“/g”: per gram of Polymer Precursor 1.

Curing by the IR oven was performed at 160° C. for 45 min in an IR oven having near-infrared and far infrared heaters. The O₂ level in the oven was at about 0.2%.

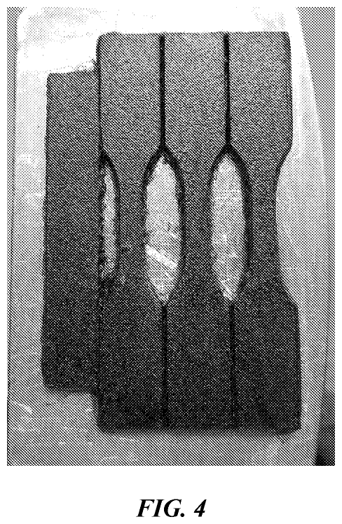

Curing processes were tested in a combination IR-resistive heating oven at 160° C. to create two sets of cured olefin metathesis photopolymer samples: one set created by leaving the samples on the printer's metal build head and the other set by removing the samples and attaching them to a glass substrate. Exemplary cured samples are depicted in FIG. 4.

From the results of the DSC tests, the sets of samples started to have transitions around 170° C., compared with about 160° C. for the standard vacuum oven process. The sets of samples had an HDT at 1.82 MPa pressure measured between 14° and 150° C., compared with 145° C. for the vacuum oven process. From tensile tests, samples had a Young's Modulus measured in the range of 1.7-1.8 GPa, an ultimate tensile strength (UTS) measured in the range of 48-53 MPa, and a failure strain of about 20%. These exemplary IR-oven processes were able to cure the polymer to the same degree as vacuum oven processes at 160° C. in similar time.

### Example 2. Curing of Olefin Metathesis Photopolymers with Microwave Radiation

22 mL or 25 mL mixtures of initiator, sensitizer, polymer precursor, and latent ruthenium catalyst for photopolymerization based on olefin metathesis were prepared. The contents were shear mixed for about 4 minutes. The contents of the mixture are summarized in Table 1 below. A 3D printer equipped with a ultraviolet or visible light source was used to disperse and photopolymerize the mixture. Polymerization was performed by the printer by irradiating the samples with light at a wavelength of 385 nm.

TABLE 2

| | | | Exemplary | |
|---|---|---|---|---|
| | Material | | Amount | |
| Material | Type | Amount | Added | |
| Bis(4-tert- | Initiator | 1.75 g/g*-157.5 mg | 157.1 | mg |
| butylphenyl)iodonium | | | | |
| triflate | | | | |
| Sensitizer 1 | Sensitizer | 1.75 mg/g*-157.5 mg | 157.1 | mg |
| Polymer Precursor 1 | Monomer | 90 g | 90.2 | g |
| | mixture | | | |
| Catalyst 1 | Latent | 1.0 mg/g-90 mg | 90.1 | mg |
| | catalyst | | | |

*“/g”: per gram of Polymer Precursor 1.

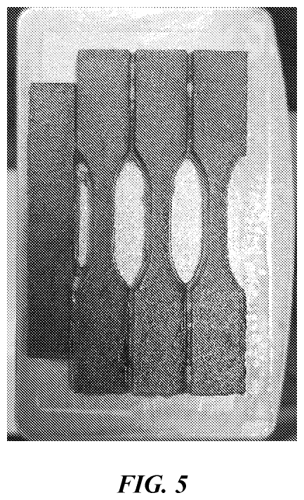

Sets of cured olefin metathesis photopolymer samples were prepared in a 2.45 GHz microwave oven with three different microwave processes at 160° C. under nitrogen gas—one on the printer's build head immersed in polyethylene glycol (PEG); one on a glass substrate immersed in silicone oil; and one on a glass and ceramic substrate, not immersed in any liquid medium. Exemplary cured samples are depicted in FIG. 5.

From the results of the DSC tests, all the samples started to have transitions around 160° C., the temperature they were brought to during the process. All samples had an HDT at 1.82 MPa pressure measured around 145° C. From tensile tests, all samples had a Young's Modulus measured in the range of 1.7-2.0 GPa, a ultimate tensile strength (UTS) measured in the range of 50-58 MPa, and a failure strain of >20%. The microwave processes were able to cure the polymers to the same degree as vacuum oven processes at 160° C. in similar or less time.

### Example 3. Microwave Curing of Photopolymer Parts in Water

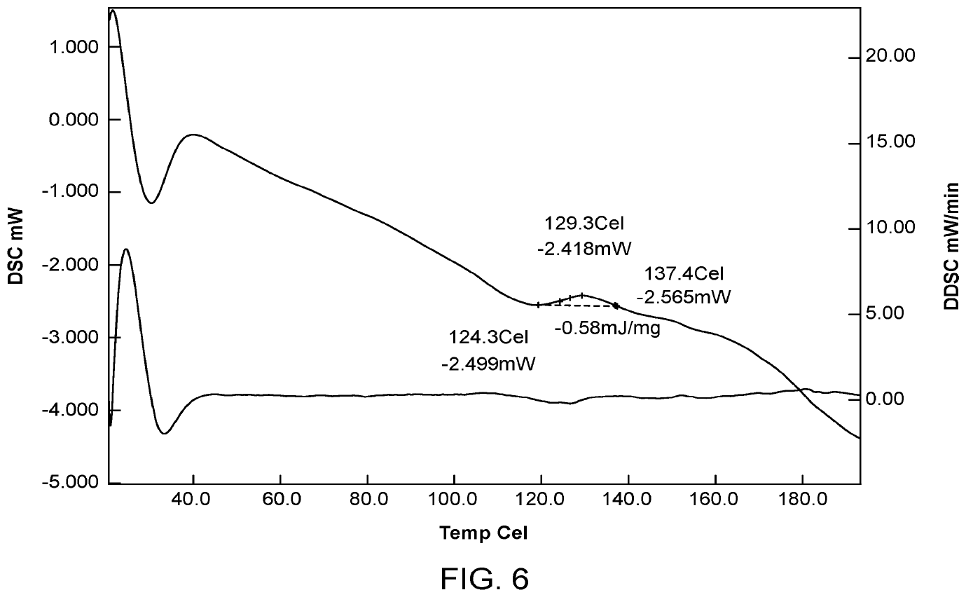

Specimens of photopolymers based on olefin metathesis were printed using the Asiga Pico 2HD UV385. The cleaned specimens were adhered to a rectangular glass substrate with double-sided Kapton tape. A second rectangular glass substrate was placed on top of the photopolymer specimens. A round glass container was filled with tap water, enough to fully submerge the specimens and the glass substrates. The specimens and substrate were placed into the glass container filled with water and a glass and silicone lid was placed loosely on top to prevent the water from completely evaporating out of the container during the curing time. The specimens were microwaved in a Toshiba Inverter Microwave Oven for sixty (60) minutes. After the specimens were microwaved in the microwave, they were removed from the water in the container and dried. A sample was taken from one of the specimens and its degree of cure was checked using differential scanning calorimetry (DSC). The output is shown in FIG. 6. The sample showed traits of under-curing, where there is an exotherm peak at 129° C.

### Example 4. Microwave Curing of Photopolymer Parts in Glycerol and Water Mixture

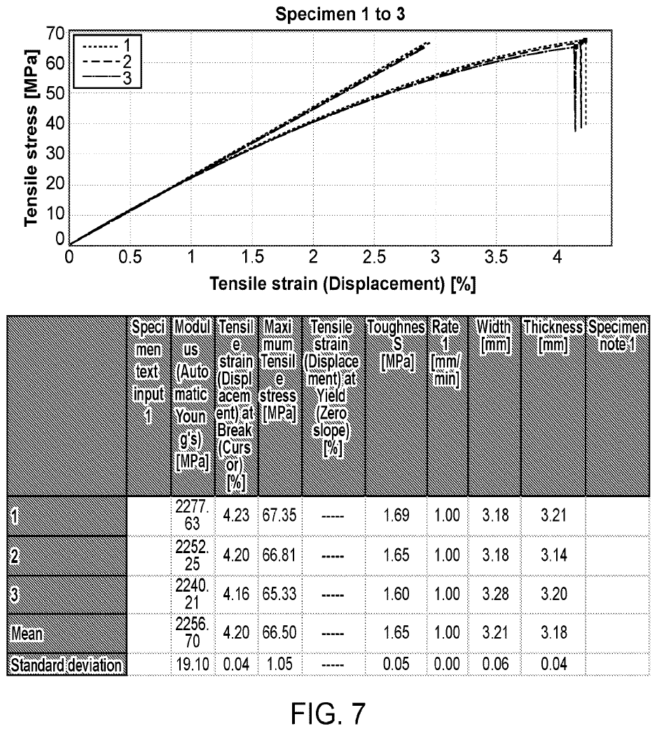

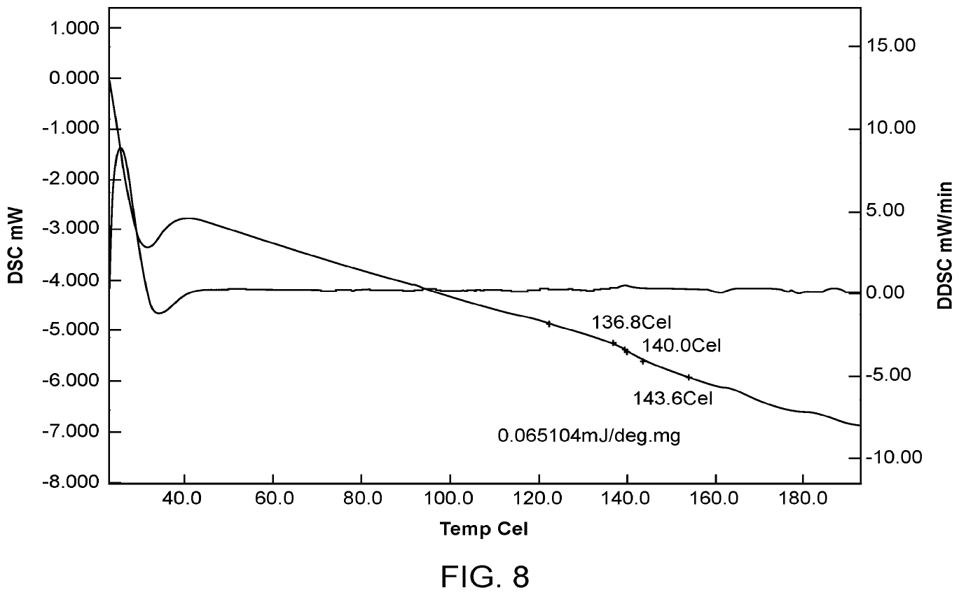

Tensile specimens of photopolymers based on olefin metathesis were printed using the Asiga Pico 2HD UV385. The cleaned specimens were adhered to a rectangular glass substrate with double-sided Kapton tape. A second rectangular glass substrate was placed on top of the photopolymer specimens. A mixture composed of 80% vegetable glycerol and 20% tap water by volume was made. The two ingredients were added together and stirred until the mixture became homogeneous. A round glass container was filled with the glycerol and water mixture, enough to fully submerge the specimens and the glass substrates. The specimens and substrate were placed into the glass container filled with the glycerol and water mixture and a glass and silicone lid was placed loosely on top to prevent the water from completely evaporating out of the container during the curing time. The specimens were microwaved in a Toshiba Inverter Microwave Oven for thirty-five (35) minutes. At this time, the temperature of the liquid mixture was measured to be 210° C. by an infrared thermometer. After the specimens were microwaved in the microwave, they were removed from the container, rinsed in tap water, then dried. The tensile specimens were tested on an Instron uniaxial tensile testing machine. The results are shown in FIG. 7, which show that the tensile samples failed in a brittle manner. A sample was taken from one of the tensile specimens and its degree of cure was checked using differential scanning calorimetry (DSC), The output is shown in FIG. 8. The sample showed traits of complete curing, with a glass transition point at 140° C.

### Example 5. Microwave Curing of Photopolymer Parts in 80% Glycerol and 20% Water Mixture, Containing 3% by Weight Vitamin C

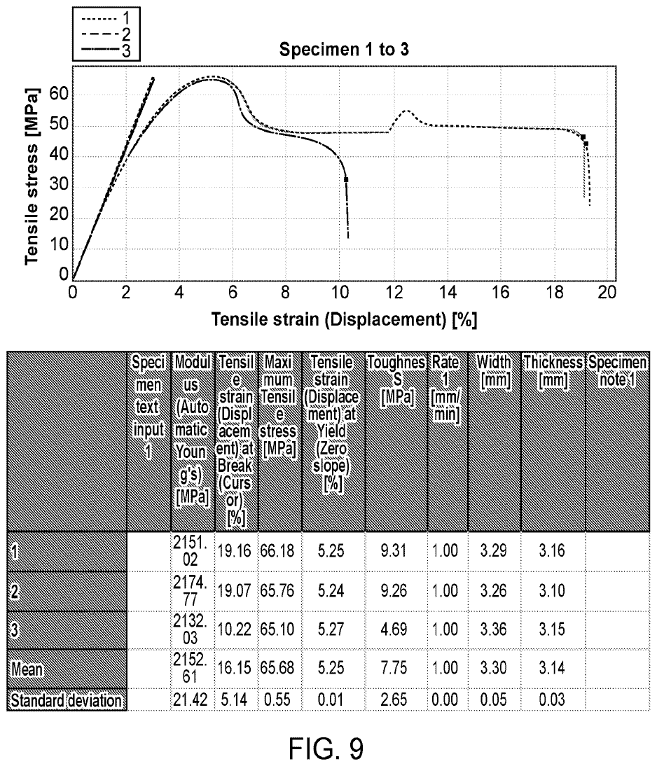

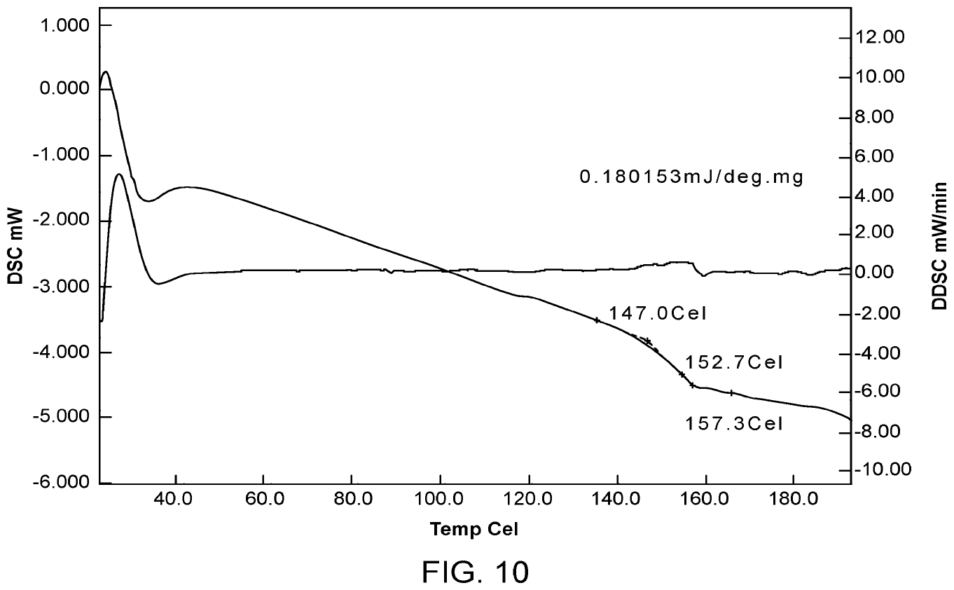

Tensile specimens of photopolymers based on olefin metathesis were printed using the Asiga Pico 2HD UV385. The cleaned specimens were adhered to a rectangular glass substrate with double-sided Kapton tape. A second rectangular glass substrate was placed on top of the photopolymer specimens. A mixture composed of 80% vegetable glycerol, 20% tap water by volume, plus 3% weight of ascorbic acid by total volume of liquid, was made. The ascorbic acid was mixed into the tap water until it was dissolved, then the vegetable glycerol was added and stirred until the mixture became homogeneous. A round glass container was filled with the glycerol, water, and ascorbic acid mixture, enough to fully submerge the specimens and the glass substrates. The total volume of the mixture was 250 g. The specimens and substrate were placed into the glass container filled with the glycerol, water, and ascorbic acid mixture and a glass and silicone lid was placed loosely on top to prevent the water from completely evaporating out of the container during the curing time. The specimens were microwaved in a Toshiba Inverter Microwave Oven for seven (7) minutes. At this time, the temperature of the liquid mixture was measured to be 212° C. by an infrared thermometer. After the specimens were microwaved in the microwave, they were removed from the container, rinsed in tap water, then dried. The tensile specimens were tested on an Instron uniaxial tensile testing machine. The results are shown in FIG. 9, which show that the tensile samples failed in a ductile manner, with plastic deformation and necking present in the specimens. A sample was taken from one of the tensile specimens and its degree of cure was checked using differential scanning calorimetry (DSC). The output is shown in FIG. 10. The sample showed traits of complete curing, with a glass transition point at 153° C.

### OTHER EMBODIMENTS

While preferred embodiments of the present disclosure have been shown and described herein, it will be obvious to those skilled in the art that such embodiments are provided by way of example only. It is not intended that the present disclosure be limited by the specific examples provided within the specification. While the present disclosure has been described with reference to the aforementioned specification, the descriptions and illustrations of the embodiments herein are not meant to be construed in a limiting sense. Numerous variations, changes, and substitutions will now occur to those skilled in the art without departing from the present disclosure. Furthermore, it shall be understood that all aspects of the present disclosure are not limited to the specific depictions, configurations or relative proportions set forth herein which depend upon a variety of conditions and variables. It should be understood that various alternatives to the embodiments of the present disclosure described herein may be employed in practicing the invention. It is therefore contemplated that the present disclosure shall also cover any such alternatives, modifications, variations or equivalents. It is intended that the following claims define the scope of the present disclosure and that methods and structures within the scope of these claims and their equivalents be covered thereby.

What is claimed is:

1. A method for preparing a cured composition, comprising:
(a) providing a mixture comprising:
(i) a latent ruthenium (Ru) complex;
(ii) an initiator; and
(iii) at least one polymer precursor;
(b) exposing the mixture to electromagnetic radiation above a threshold energy to activate the initiator,
wherein upon activation by the electromagnetic radiation above the threshold energy, the initiator reacts with the latent Ru complex to generate an activated Ru complex, and
wherein the activated Ru complex reacts with the at least one polymer precursor to induce polymerization of the at least one polymer precursor to generate a plurality of curable photopolymers;
(c) placing the plurality of curable photopolymers in a heat-transfer medium; and
(d) exposing the plurality of curable photopolymers placed in the heat-transfer medium to electromagnetic radiation below the threshold energy,
thereby preparing the cured composition.

2. The method of claim 1, wherein the electromagnetic radiation below the threshold energy is microwave radiation.

3. The method of claim 1, wherein the electromagnetic radiation below the threshold energy is infrared radiation.

4. The method of any one of claims 1-3, wherein the heat-transfer medium is a liquid medium.

5. The method of any one of claims 1-4, wherein the heat-transfer medium comprises a liquid component selected from the group consisting of water, an alcohol, a glycol, a polyglycol, and glycerol, and combinations thereof.

6. The method of any one of claims 1-5, wherein the heat-transfer medium is a solution comprising glycerol and water.

7. The method of any one of claims 1-6, wherein the heat-transfer medium is a solution comprising about 50 to 80 percent by volume of a first liquid component, based on a total volume of the solution, and about 20 to about 50 percent by volume of a second liquid component, based on a total volume of the solution.

8. The method of any one of claims 1-7, wherein the heat-transfer medium is a solution comprising about 80 percent by volume of glycerol based on a total volume of the solution, and about 20 percent by volume of water, based on a total volume of the solution.

9. The method of any one of claims 1-8, wherein the heat-transfer medium comprises one or more additives.

10. The method of any one of claims 1-9, wherein the one or more additives is selected from the group consisting of a colorant, a dye, a pigment, a brightener, a stabilizer, a plasticizer, and a surface modifier.

11. The method of any one of claims 1-10, wherein the heat-transfer medium comprises at least one antioxidant.

12. The method of claim 11, wherein the heat-transfer medium comprises about 1 weight percent to about 5 percent of the at least one antioxidant based on the total weight of the heat-transfer medium.

13. The method of claim 11 or 12, wherein the at least one antioxidant is at least one naturally occurring antioxidant.

14. The method of any one of claims 11-13, wherein the at least one antioxidant is at least one food-grade antioxidant.

15. The method of any one of claims 11-14, wherein the at least one antioxidant is ascorbic acid.

16. The method of any one of claims 1-15, wherein the heat-transfer medium comprises about 1 weight percent to about 5 percent of ascorbic acid based on the total weight of the heat-transfer medium.

17. The method of any one of claims 1-16, wherein the heat-transfer medium comprises about 3 weight percent ascorbic acid based on the total weight of the heat-transfer medium.

18. The method of any one of claims 1-17, wherein the electromagnetic radiation below the threshold energy raises the temperature of the heat-transfer medium to about 50° C. to about 250° C.

19. The method of any one of claims 1-18, wherein the electromagnetic radiation below the threshold energy raises the temperature of the heat-transfer medium to about 95° C. to about 210° C.

20. The method of any one of claims 1-19, wherein the electromagnetic radiation below the threshold energy raises the temperature of the heat-transfer medium to the glass transition temperature (T_{g}) of the plurality of curable photopolymers at the time the plurality of curable photopolymers is placed in the heat-transfer medium.

21. The method of any one of claims 1-20, wherein the electromagnetic radiation above said threshold energy is visible light or ultraviolet light.

22. The method of any one of claims 1-21, wherein the wavelength of the electromagnetic radiation above said threshold energy is from 200-800 nm.

23. The method of any one of claims 1-22, wherein the mixture further comprises a sensitizer that sensitizes the initiator upon exposing the mixture to the electromagnetic radiation above said threshold energy, thereby activating the initiator.

24. The method of any one of claims 1-23, wherein the at least one polymer precursor comprises at least one olefin.

25. The method of any one of claims 1-24, wherein the plurality of curable photopolymers comprises a cyclic olefin polymer.

26. The method of any one of claims 1-25, wherein the plurality of curable photopolymers placed in the heat-transfer medium is exposed to the electromagnetic radiation below said threshold energy for about 1 week, about 5 days, about 4 days, about 3 days, about 2 days, about 1 day, about 20 hours, about 15 hours, about 10 hours, about 5 hours, about 4 hours, about 3 hours, about 2 hours, or about 1 hour.

27. A method of reducing oxidative decomposition of a plurality of curable photopolymers while curing the plurality of curable photopolymers with electromagnetic below a threshold energy, comprising:
(a) providing a mixture comprising:
(i) a latent ruthenium (Ru) complex;
(ii) an initiator; and
(iii) at least one polymer precursor;
(b) exposing the mixture to electromagnetic radiation above the threshold energy to activate the initiator,
wherein upon activation by the electromagnetic radiation above the threshold energy, the initiator reacts with the latent Ru complex to generate an activated Ru complex, and
wherein the activated Ru complex reacts with the at least one polymer precursor to induce polymerization of the at least one polymer precursor to generate the plurality of curable photopolymers; and
(c) placing the plurality of curable photopolymers in a heat-transfer medium comprising a solvent and at least one antioxidant; and
(d) exposing the plurality of curable photopolymers placed in the heat-transfer mixture to the electromagnetic below the threshold energy.

28. The method of claim 27, wherein the electromagnetic radiation below the threshold energy is microwave radiation.

29. The method of claim 27, wherein the electromagnetic radiation below the threshold energy is infrared radiation.

30. The method of any one of claims 27-29, wherein the heat-transfer medium is a liquid medium.

31. The method of any one of claims 27-29, wherein the heat-transfer medium comprises a liquid component selected from the group consisting of water, an alcohol, a glycol, a polyglycol, glycerol, and combinations thereof.

32. The method of any one of claims 27-31, wherein the heat-transfer medium is a solution comprising glycerol and water.

33. The method of any one of claims 27-32, wherein the heat-transfer medium is a solution comprising about 50 to 80 percent by volume of a first liquid component, based on a total volume of the solution, and about 20 to about 50 percent by volume of a second liquid component, based on a total volume of the solution.

34. The method of any one of claims 27-33, wherein the heat-transfer medium is a solution comprising about 80 percent by volume of glycerol based on a total volume of the solution, and about 20 percent by volume of water, based on a total volume of the solution.

35. The method of any one of claims 27-34, wherein the heat-transfer medium comprises one or more additives.

36. The method of any one of claims 27-35, wherein the one or more additives is selected from the group consisting of a colorant, a dye, a pigment, a brightener, a stabilizer, a plasticizer, and a surface modifier.

37. The method of any one of claims 27-36, wherein the heat-transfer medium comprises about 1 weight percent to about 5 percent of the at least one antioxidant based on the total weight of the heat-transfer medium.

38. The method of any one of claims 27-37, wherein the at least one antioxidant is at least one naturally occurring antioxidant.

39. The method of any one of claims 27-38, wherein the at least one antioxidant is at least one food-grade antioxidant.

40. The method of any one of claims 27-39, wherein the at least one antioxidant is ascorbic acid.

41. The method of any one of claims 27-40, wherein the heat-transfer medium comprises about 1 weight percent to about 5 percent of ascorbic acid based on the total weight of the heat-transfer medium.

42. The method of any one of claims 27-41, wherein the heat-transfer medium comprises about 3 weight percent ascorbic acid based on the total weight of the heat-transfer medium.

43. The method of any one of claims 27-42, wherein the electromagnetic radiation below the threshold energy raises the temperature of the heat-transfer medium to about 50° C. to about 250° C.

44. The method of any one of claims 27-43, wherein the electromagnetic radiation below the threshold energy raises the temperature of the heat-transfer medium to about 95° C. to about 210° C.

45. The method of any one of claims 27-44, wherein the electromagnetic radiation below the threshold energy raises the temperature of the heat-transfer medium to the glass transition temperature (T_{g}) of the plurality of curable photopolymers at the time the plurality of curable photopolymers is placed in the heat-transfer medium.

46. The method of any one of claims 27-45, wherein the electromagnetic radiation above said threshold energy is visible light or ultraviolet light.

47. The method of any one of claims 27-46, wherein the wavelength of the electromagnetic radiation above said threshold energy is from 200-800 nm.

48. The method of any one of claims 27-47, wherein the mixture further comprises a sensitizer that sensitizes the initiator upon exposing the mixture to the electromagnetic radiation above said threshold energy, thereby activating the initiator.

49. The method of any one of claims 27-48, wherein the at least one polymer precursor comprises at least one olefin.

50. The method of any one of claims 27-49, wherein the plurality of curable photopolymers comprises a cyclic olefin polymer.

51. The method of any one of claims 27-50, wherein the plurality of curable photopolymers placed in the heat-transfer medium is exposed to the electromagnetic radiation below said threshold energy for about 1 week, about 5 days, about 4 days, about 3 days, about 2 days, about 1 day, about 20 hours, about 15 hours, about 10 hours, about 5 hours, about 4 hours, about 3 hours, about 2 hours, or about 1 hour.

52. A method for preparing a cured composition, comprising:
(a) providing a mixture comprising:
(i) a latent ruthenium (Ru) complex;
(ii) an initiator; and
(iii) at least one polymer precursor;
(b) exposing the mixture to electromagnetic radiation above a threshold energy to activate the initiator,
wherein upon activation by the electromagnetic radiation above the threshold energy, the initiator reacts with the latent Ru complex to generate an activated Ru complex, and
wherein the activated Ru complex reacts with the at least one polymer precursor to induce polymerization of the at least one polymer precursor to generate a plurality of curable photopolymers; and
(c) means for reducing oxidative decomposition of a plurality of curable photopolymers while curing the plurality of curable photopolymers with microwave or infrared radiation,
thereby preparing the cured composition.
